(19) United States
(12) Patent Application Publication
(10) Pub. No.: US 2025/0260565 A1
(43) Pub. Date: Aug. 14, 2025

(54) Methods and Systems for Privacy-Preserving Location Verification

(71) Applicant: Maher A Abdelsamie, Staten Island, NY (US)

(72) Inventor: Maher A Abdelsamie, Staten Island, NY (US)

(21) Appl. No.: 19/054,707

(22) Filed: Feb. 14, 2025

Related U.S. Application Data
(60) Provisional application No. 63/682,435, filed on Aug. 13, 2024.
(60) Provisional application No. 63/681,315, filed on Aug. 9, 2024.
(60) Provisional application No. 63/678,622, filed on Aug. 2, 2024.
(60) Provisional application No. 63/655,175, filed on Jun. 3, 2024.
(60) Provisional application No. 63/553,154, filed on Feb. 14, 2024.

(51) Int. Cl. H04L 9/08; H04L 9/00; H04L 9/32; H04W 12/63; H04W 12/75

(52) U.S. Cl. CPC H04L 9/0866; H04L 9/0872; H04L 9/3221; H04L 9/3231; H04L 9/50; H04W 12/63; H04W 12/75

(57) ABSTRACT

A computer-implemented method and system for privacy-preserving location verification in distributed networks comprises initializing a multi-modal biometric authentication system on a user device, generating cryptographic keys using a distributed key generation protocol, binding the cryptographic keys to biometric templates using a fuzzy vault scheme, constructing and broadcasting encrypted location beacons, and generating zero-knowledge proofs of location claims. The system includes user devices equipped with biometric sensors and verifier devices configured to validate location claims and maintain consensus in a blockchain network. The method implements real-time liveness detection for multiple biometric input types, executes fault-tolerant consensus algorithms with privacy preservation, and maintains a dual-scoring mechanism comprising device trust scores and user reputation scores. The system enables secure location verification while preserving user privacy through cryptographic protocols and biometric authentication in decentralized environments.

### CROSS-REFERENCE TO RELATED APPLICATION

This application claims priority from U.S. Provisional patent application Ser. No. 63/553,154 filed on Feb. 14, 2024, entitled “SECURE METHODS AND SYSTEMS”, U.S. Provisional patent application Ser. No. 63/655,175 filed on Jun. 3, 2024, entitled “SECURE METHODS AND SYSTEMS”, U.S. Provisional patent application Ser. No. 63/678,622 filed on Aug. 2, 2024, entitled “SECURE METHODS AND SYSTEMS”, U.S. Provisional patent application Ser. No. 63/681,315 filed on Aug. 9, 2024, entitled “SECURE METHODS AND SYSTEMS”, and U.S. Provisional patent application Ser. No. 63/682,435 filed on Aug. 13, 2024, entitled “SECURE METHODS AND SYSTEMS”. Each of the above-stated applications is hereby incorporated herein by reference in its entirety.

### TECHNICAL FIELD

The present invention relates to computer-implemented systems and methods for secure location verification. More particularly, the invention relates to privacy-preserving techniques for verifying physical presence at geographical locations using cryptographic protocols and biometric authentication in decentralized environments.

### BACKGROUND

Location verification systems are increasingly important in distributed computing environments where proving physical presence at specific geographical locations is required. Contemporary systems typically rely on centralized architectures for validating location claims, which present several technical challenges regarding privacy preservation, data security, and system reliability.

Existing location verification approaches commonly employ Global Positioning System (GPS) coordinates or cellular network triangulation. These methods, while functional, are susceptible to various technical vulnerabilities including GPS spoofing, replay attacks, and man-in-the-middle attacks. Furthermore, centralized verification systems create single points of failure and raise technical concerns regarding data privacy and system scalability. Current solutions often store location data and verification credentials in centralized databases, making them vulnerable to unauthorized access and manipulation. The technical challenge of securely managing and verifying location claims while preserving user privacy remains largely unresolved in distributed environments.

Prior solutions have attempted to address these technical problems through various approaches. For example, some systems implement basic cryptographic protocols for securing location data transmission. However, these solutions typically fail to provide comprehensive protection against sophisticated attack vectors while maintaining system scalability and user privacy. Furthermore, current solutions lack robust mechanisms for verifying the authenticity of location claims in a decentralized manner. The technical challenge of achieving consensus on location verification in distributed networks while maintaining system efficiency and scalability remains unresolved. Another significant technical problem relates to the secure storage and verification of location proofs. Existing systems typically lack efficient methods for generating and validating location proofs while preserving user privacy and ensuring data integrity across distributed networks.

The need exists for a technical solution that addresses these challenges through a comprehensive approach to secure location verification in distributed environments.

### SUMMARY

According to a first aspect of the invention, a method for secure location verification in a distributed network comprises: initializing, by a processor of a user device, a biometric authentication system comprising multiple biometric input types; generating, by the processor, cryptographic keys using a distributed key generation protocol in cooperation with one or more verifier devices; binding the cryptographic keys to biometric templates using a fuzzy vault scheme; constructing and broadcasting encrypted location beacons; generating zero-knowledge proofs of location claims; participating in a decentralized validation system with the one or more verifier devices; and maintaining a dual-scoring mechanism comprising a device trust score and a user reputation score.

According to a second aspect of the invention, a system for secure location verification comprises: one or more user devices, each comprising: a processor; a communications interface; one or more biometric sensors; a secure storage component; and a memory storing instructions that, when executed by the processor, cause the system to perform operations comprising: implementing a multi-modal biometric authentication system; executing a distributed key generation protocol; broadcasting encrypted location beacons; and participating in a decentralized validation system; and one or more verifier devices configured to validate location claims and maintain consensus in a blockchain network.

According to a third aspect of the invention, a user device for secure location verification comprises: a processor; a communications interface; one or more biometric sensors; a secure storage component; and a memory storing instructions that, when executed by the processor, cause the user device to: capture multiple types of biometric data; generate and manage cryptographic keys; broadcast encrypted location beacons; and participate in a decentralized validation system.

In some embodiments, initializing the biometric authentication system comprises: capturing multiple types of biometric data including at least two of: electrocardiogram (ECG) data, photoplethysmography (PPG) data, fingerprint data, facial recognition data, voice recognition data, bioimpedance data, skin temperature data, galvanic skin response (GSR) data, iris scan data, and vein pattern recognition (VPR) data; generating biometric templates for each type of captured biometric data; and implementing real-time liveness detection for each biometric input type.

In some embodiments, generating cryptographic keys comprises: initiating a t-out-of-n threshold key generation protocol; establishing secure communication channels with the one or more verifier devices; participating in a distributed random beacon protocol to generate a shared random value; and combining threshold key shares to derive a final public key and master secret key.

In some embodiments, binding the cryptographic keys comprises: encoding a cryptographic key as coefficients of a polynomial; generating genuine points from the polynomial using biometric features; adding chaff points to obscure genuine points; and applying error-correcting codes for handling biometric variations. In some embodiments, constructing and broadcasting encrypted location beacons comprises: generating a temporary identifier for each session; creating a location commitment using cryptographic hash functions; implementing attribute-based encryption of beacon messages; and broadcasting the encrypted beacons over one or more wireless channels. In some embodiments, generating zero-knowledge proofs comprises: creating proofs of location presence without revealing exact coordinates; implementing range proofs for geographic boundaries; generating proofs of successful biometric authentication; and providing proofs of proper key usage.

In further embodiments, the method comprises: implementing an adaptive data collection mechanism based on current context; adjusting data sampling rates dynamically based on user activity and proximity to restricted areas; and synchronizing energy-saving measures across multiple associated devices. In some embodiments, the multi-modal biometric authentication system comprises: pre-capture verification procedures for each biometric modality; continuous post-capture verification; and real-time anomaly detection using supervised and unsupervised learning models. In some embodiments, broadcasting encrypted location beacons comprises: generating attribute-based encryption keys; defining access policies based on temporal and spatial attributes; encrypting biometric verification tokens separately from main beacon messages; and implementing spread spectrum modulation techniques. In some embodiments, participating in the decentralized validation system comprises: executing fault-tolerant consensus algorithms with privacy preservation; implementing distributed machine learning approaches; participating in cryptographic trust systems; and executing network governance operations. In some embodiments, the user device further comprises: implementing a secure logging system with tamper-evident mechanisms; executing authenticated data structure operations; and participating in collaborative log consistency checks. In some embodiments, the memory stores further instructions to: implement multi-source location determination; execute location verification protocols; generate and maintain location proofs; and participate in challenge-response protocols.

In further embodiments, the method comprises: implementing cross-modal verification between different biometric modalities; generating confidence scores for each biometric input; executing fusion algorithms with adaptive weighting; and maintaining historical performance metrics for each modality. In some embodiments, participating in the distributed random beacon protocol comprises: contributing entropy from hardware random number generators; combining entropy using verifiable delay functions; preventing last-actor bias; and seeding subsequent key generation steps. In further embodiments, the method comprises: implementing a hybrid storage system for location-based restrictions; executing a secure boot process; and maintaining decentralized storage operations for prohibited locations.

In some embodiments, the real-time anomaly detection comprises: combining supervised learning models trained on known attack patterns; implementing unsupervised learning for novel attack detection; executing online learning algorithms for continuous adaptation; and maintaining historical behavioral patterns. In some embodiments, the attribute-based encryption comprises: temporal attributes including current date and time periods; spatial attributes including geographic regions and proximity data; device-specific attributes including device type and operating system; and user-specific attributes including role and clearance level. In some embodiments, generating and maintaining location proofs comprises: implementing privacy-preserving proof generation; executing collaborative proof verification; maintaining proof data structures; and participating in blockchain-based verification systems.

Various embodiments of the present invention are provided in the following detailed description and appended drawings. Without departing from the present invention, several details of the present invention may be capable of modifications in various respects, and the present invention is capable of various embodiments. Accordingly, the description and appended drawings of the present invention are provided as illustrations only, and they do not limit or define the scope of the invention being defined by the appended claims.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following detailed description, which is to be read in association with the accompanying drawings, wherein:

FIG. 1 is a block diagram illustrating an exemplary system architecture for implementing location verification in accordance with one or more embodiments. This system may provide the foundation for the processes described in FIG. 2 and FIG. 3;

FIG. 2 shows a simplified flowchart illustrating a first method for location verification in accordance with one or more embodiments;

FIG. 3 shows a simplified flowchart illustrating an alternative or extended method for decentralized location verification and reputation management in accordance with one or more embodiments;

FIG. 4 is a diagram of example components of one or more devices of FIG. 1; and

FIG. 5 shows a simplified flowchart illustrating a method for secure data encryption and decryption using a time-based adaptive key generation technique in accordance with one or more embodiments.

The headings used herein are not meant to be used to limit the scope of the claims or description. The headings used herein are for organizational purposes only. To facilitate understanding, like reference numerals have been used, where possible, to designate like elements common to the figures.

### DETAILED DESCRIPTION

The presently disclosed subject matter is described with specificity to meet statutory requirements. However, the description itself is not intended to limit the scope of this patent. Moreover, although the term “step” may be used herein to connote different aspects of methods employed, the term should not be interpreted as implying any particular order among or between various steps herein disclosed unless and except when the order of individual steps is explicitly described.

Reference throughout this specification to “one embodiment” or “an embodiment” means that a particular feature, structure, or characteristic described in connection with the embodiment is included in at least one embodiment of the disclosed subject matter. Thus, appearances of the phrases “in one embodiment” or “in an embodiment” in various places throughout this specification are not necessarily referring to the same embodiment.

As used in this specification and the appended claims, the singular forms “a,” “an,” and “the” include or otherwise refer to singular as well as plural referents, unless the content clearly dictates otherwise. As used in this specification and the appended claims, the term “or” is generally employed to include “and/or” unless the content clearly dictates otherwise.

The present invention relates to computer-implemented systems and methods for secure location verification in distributed networks.

As used herein, the term “blockchain” may refer to a distributed decentralized public ledger that maintains a continuously growing list of data records hardened against tampering and revision, called blocks that may be linked together to form a chain. A blockchain network may be comprised of one or more computing devices. A blockchain network may be configured to process and keep records of transactions as part of the block in the blockchain network. A block is added to the blockchain network when it is completed, and then the record of the transaction would be updated. Blockchain transactions may be created and stored in chronological order or may be created and stored in any other order that may be suitable for use by the blockchain network. In some configurations, blockchain recorded transactions may include information such as a currency amount and destination address. These pieces of information record the amount of currency attributed to a specific address. In some cases, blockchain transactions may contain additional or other pieces of information such as a timestamp, a source address, etc. A blockchain may include a secure transaction ledger database, where the transactions may be financial and others not financial. The secure transaction ledger database may be shared by parties participating in an established, distributed network of computing devices. In some embodiments, a blockchain may record any type of data as a form of transaction that occurs in the network (e.g., transfer of information or exchange) in a distributed database that maintains a continuously growing list of data records hardened against tampering and revision, even by participating parties or operators who share the database, thereby reducing or eliminating the need for trusted and/or centralized third parties. Blockchain transactions may be confirmed and validated by the blockchain network through verification techniques (consensus mechanisms) such as proof of work, proof of stake, and/or any other suitable consensus mechanisms.

As used herein, the term “activities” may refer to a broad spectrum of actions and/or transactions, each potentially encompassing or involving a product and/or service, and being of both financial and non-financial nature. Furthermore, the phrases “user activities” or “user transactions” are to be interpreted as encompassing any and all activities or transactions conducted by a user 102, irrespective of their financial or non-financial nature.

As used herein, the term “module” may be hardware or software programmed to perform one or more processes and provides an output using a received input. Based on the present disclosure, the processes, output, and input performed by different modules will be apparent to one skilled in the art.

As used herein, the term “Biometrics” and “biometric information” refers to measurable biological characteristics of a user of the users 102, a partner of the partners 104, a verifier of the verifiers 108, and/or an advertisement service provider of the advertisement service providers 126 such as facial characteristics, voice characteristics, fingerprint characteristics, eye characteristics, Electrocardiogram (ECG), Photoplethysmography (PPG), Skin Temperature, Galvanic Skin Response (GSR), Vein Pattern Recognition (VPR), and the like. The biometric information is obtained from one or more biometric sensors that may acquire, detect, scan or read the biometric characteristics of users 102, partners 104, verifiers 108, and advertisement service providers 126.

As used herein, the term “cryptocurrency” may refer to a digital currency in which the generation of units of currency and the verification of transfer of funds may be regulated by encryption techniques.

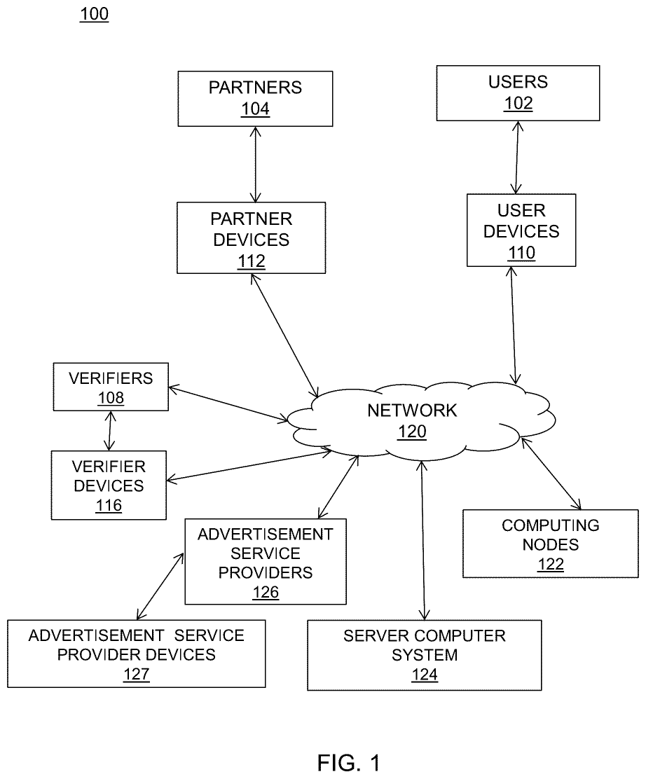

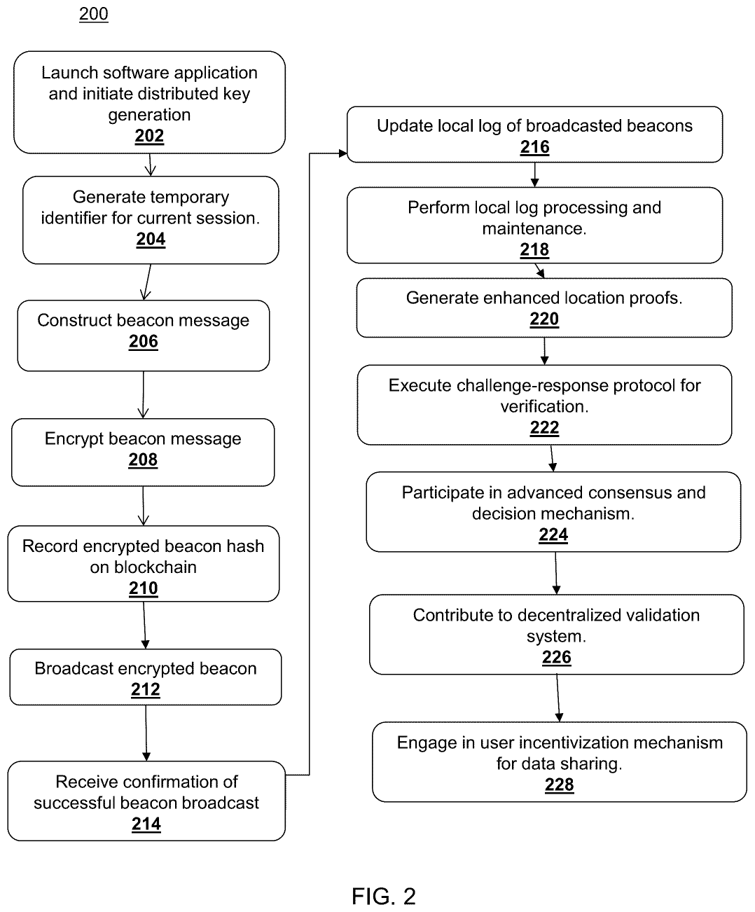

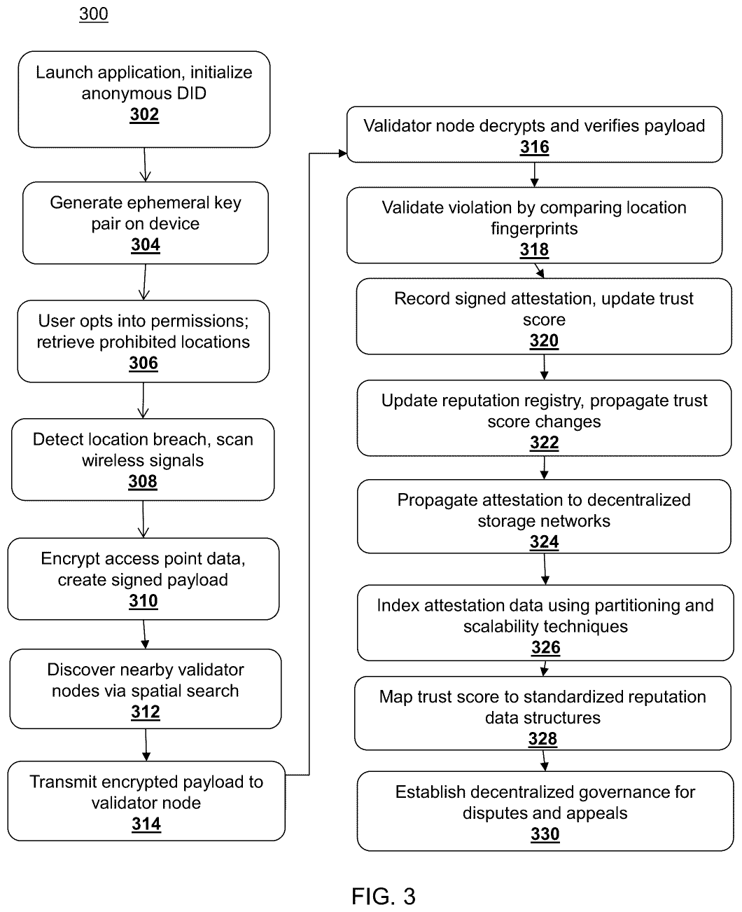

FIG. 1 is a schematic block illustrating an exemplary system architecture for implementing location verification in accordance with one or more embodiments. This system may provide the foundation for the processes described in FIG. 2 and FIG. 3. More specifically, FIG. 1 illustrates a system (100) comprising a plurality of interconnected participants including users (102), partners (104), verifiers (108), and advertisement service providers (126).

System 100 includes a server computer system 124 that may communicate with a plurality of users 102, partners 104, verifiers 108, and/or advertisement service providers 126 through user devices 110, partner devices 112, verifier devices 116, and/or advertisement service provider devices 127 respectively over a network 120. The server computer system 124 may also communicate with computing nodes 122 over the network 120.

The user devices 110, partner devices 112, verifier devices 116, and/or advertisement service provider devices 127 may be communicatively connected to the server computer system 124 via a network 120.

A user from the users 102 may be an individual. A partner from the partners 104 may be an individual, or an entity such as a business, a non-profit organization, a governmental agency, and/or any other entities.

In system 100, a user of the users 102 may register through a software application installed on a user device 110 by providing multiple types of biometric data, including but not limited to fingerprint data, facial recognition data, voice recognition data, electrocardiogram (ECG) data, photoplethysmography (PPG) data, bioimpedance data, accelerometer and gyroscope data, skin temperature data, Galvanic Skin Response (GSR) data, iris scan data, and vein pattern recognition (VPR) data. In some embodiments, the user 102 may be subject to continuous verification through real-time biometric authentication and location validation, wherein the user's presence and activities may be verified through a combination of biometric data, device correlation, and proximity detection. A user of the users 102 may operate one or more user devices 110, and one or more devices associated with the user 102 (e.g., including but not limited to paired devices, wearable devices, or portable devices).

In system 100, a partner of the partners 104 may provide infrastructure support, including but not limited to hosting verifier devices 116, maintaining network connectivity, and facilitating secure communication channels between users 102 and verifiers 108. In some embodiments, the partner 104 may also participate in the validation of location-based activities. A partner of the partners 104 may operate one or more partner devices 112, and one or more devices associated with the partners 104.

In system 100, a verifier of the verifiers 108 may operate verifier devices 116 to validate user activities, process biometric authentication requests, and/or participate in one or more distributed consensus mechanisms. In some embodiments, the verifier 108 may execute verification protocols to assess the authenticity of user claims, and validate location data. In some embodiments, the verifier 108 may also participate in the community governance system by reviewing disputed claims and contributing to decentralized decision-making processes.

In system 100, an advertisement service provider from the advertisement service providers 126 may utilize the verified user data to deliver targeted advertisements while maintaining user privacy through the system's encryption and secure processing capabilities. In some embodiments, the advertisement service provider 126 may create and manage one or more advertising campaigns based on verified location data, and/or user engagement metrics. The advertisement service provider 126 may also participate in the reward distribution system by offering incentives for verified user engagement with advertising content.

In some embodiments, an advertisement service provider from the advertisement service providers 126 may operate one or more advertisement service provider devices 127 to provide an advertisement service for users 102, partners 104, verifiers 108, and/or unregistered third-party entities (e.g., individuals, universities, companies, organizations, governmental entities, etc.). An advertisement service provider from the advertisement service providers 126 may operate one or more advertisement service provider devices 127.

In system 100, a dual-scoring mechanism may be implemented wherein a device trust score and a user reputation score may be maintained independently but in some embodiments with mutual influence. The device trust score may be calculated based on technical verification factors including but not limited to biometric authentication success rates, hardware security measurements, and device correlation metrics, while the user reputation score may be derived from behavioral factors including location compliance, community participation, and verified interactions. In some embodiments, the relationship between these scores may be established through a weighted influence system, wherein significant changes in one score may affect the other based on predefined thresholds and validation rules executed by the one or more verifier devices 116.

Network 120 may include one or more wireless and/or wired networks. For example, network 120 may include any network capable of communicating data between devices including but not limited to a public land mobile network (PLMN), a private network, the Internet, an ad hoc network, a local area network (LAN), a cloud computing network, a wide area network (WAN), a metropolitan area network (MAN), a cellular network, an intranet, a telephone network, a fiber optic-based network or the like, and/or a combination of these or other types of networks. In some embodiments, network 120 may include a short-range wireless network that may be one of a Bluetooth wireless, Bluetooth low energy, and/or near-field communication (“NFC”) network.

In embodiments where a blockchain may be utilized one or more of user devices 110, partner devices 112, verifier devices 116, and/or computing nodes 122 may provide processing power for updating and verifying a distributed ledger that may be shared between a group of computing nodes 122, user devices 110, partner devices 112, and/or verifier devices 116. The distributed ledger may be collectively updated and verified based on transactions made between the server computer system 124, computing nodes 122, user devices 110, partner devices 112, and/or verifier devices 116.

In some embodiments, the server computer system 124 may authenticate the one or more users 102, and/or a partner of the partners 104 (e.g., an employee of a partner) prior to storing transactions data (e.g., real time, and/or offline transactions data) in the storage component 402 and/or memory 404 of the server computer system 124 of the server computer system 124.

The users 102, partners 104, verifiers 108, and advertisement service providers 126 may communicate with the server computer system 124 using user devices 110, partner devices 112, verifier devices 116, and advertisement service provider devices 127 respectively. Device 400 may correspond to a device from the user devices 110, partner devices 112, and verifier devices 116, advertisement service provider devices 127, server computer system 124, and/or computing nodes 122. In some implementations, a device from the user devices 110, partner devices 112, and verifier devices 116, server computer system 124, computing nodes 122, and/or advertisement service provider devices 127 may include one or more devices 400 and/or one or more components of device 400 (e.g., communications infrastructure 410, memory 404, input component 414, output component 412, a storage component 402, communications interface 408).

A device from the user devices 110, partner devices 112, verifier devices 116, server computer system 124, computing nodes 122, and/or advertisement service provider devices 127 may be a computing and/or communication device (e.g., mobile phone, workstation, cell phone, personal computer, gaming device, smartphone, tablet computer, laptop computer, smartwatch, server computer, or any other type of computing apparatus capable of communicating with the server computer system 124).

The users 102, partners 104, verifiers 108, and/or advertisement service providers 126 may communicate with the server computer system 124 through a user interface using user devices 110, partners devices 112, verifier devices 116, and advertisement service providers devices 127, respectively. In some embodiments, the server computer system 124 may include a web server hosting one or more websites that may be accessible by partners 104, users 102, verifiers 108, and advertisement service providers 126 over a network 120 (e.g., the Internet).

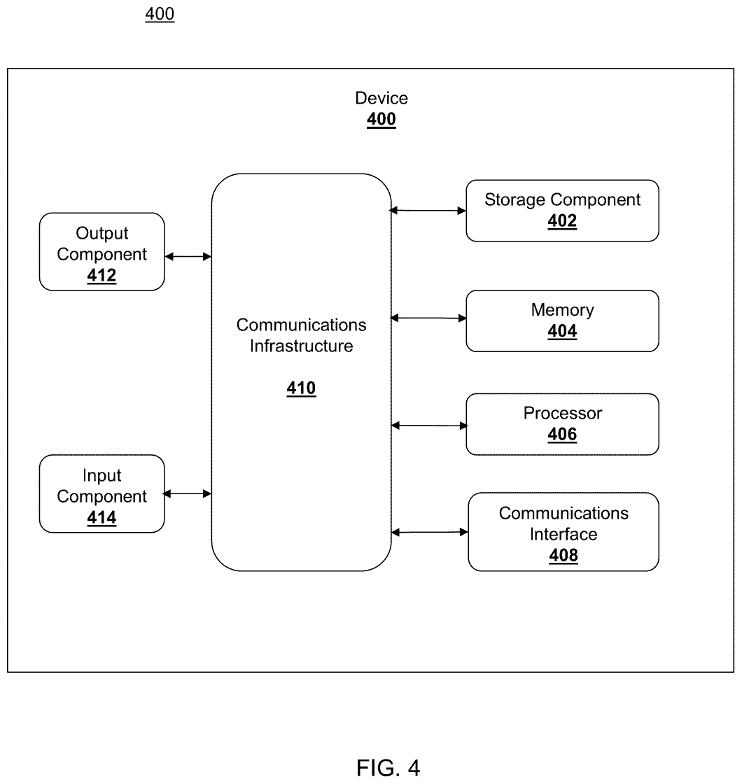

The server computer system 124 may correspond to the device 400 with a processor 406 and differently arranged components, additional components, different components, fewer components than those shown in FIG. 4. (e.g., communications infrastructure 410, memory 404, input component 414, output component 412, a storage component 402, communications interface 408), where a computer program or multiple computer programs may be stored on the memory 404 and/or storage component 402 and having executable instructions for performing the functions of the server computer system 124 described herein.

In some embodiments, the server computer system 124 may be configured to use a blockchain for the storage of data used herein. A blockchain may be operated by a plurality of computing nodes 122, a plurality of advertisement service provider devices 127, a plurality of user devices 110, a plurality of partner devices 112, and/or a plurality of verifier devices 116 comprising a blockchain network. In some embodiments, the computing nodes 122 may comprise systems associated with users 102, partners 104, and/or verifiers 108. A blockchain may be comprised of a plurality of blocks, where each block in the blockchain may include one or more data values and a block header. The blocks of the blockchain may be secured from tampering and revision. The block header of each block in the blockchain may include at least a block reference value, a timestamp, and a data reference value. The block reference value may be a reference to the prior block added to the blockchain and the data reference value may be a reference to the one or more data values included in the respective block. In an exemplary embodiment, one or more hashing algorithms (e.g., cryptographic hashing algorithms, cryptographic hash function) may be applied to the block reference value and data reference value. The application of one or more hashing algorithms to the block reference value and data reference value may generate hash values, such that it would be necessary to regenerate the reference value if the corresponding data is modified. This may make the blockchain immutable as the propagation of any modification through the rest of the blocks in the blockchain would be necessary. Each node (e.g., each one of a plurality of computing nodes 122, a plurality of advertisement service provider devices 127, a plurality of user devices 110, a plurality of partner devices 112, and/or a plurality of verifier devices 116) in a blockchain network may store an entire copy, or a portion thereof, of a blockchain. As such, tampering with the blockchain may be near impossible as any modification would have to be performed on the blockchain in every node in the blockchain network prior to the addition of a new block to the blockchain. As such, the blocks of the blockchain may be secured from tampering and revision.

The data values included in each block in the blockchain may include data stored for use by the server computer system 124, a plurality of computing nodes 122, a plurality of user devices 110, a plurality of partner devices 112, a plurality of verifier devices 116, a plurality of advertisement service provider devices 127, and/or other entities or systems. For instance, in some cases, a blockchain may be used to store activity data (e.g., an activity of a user of users 102, a partner of the partners 104, a verifier of the verifiers 108, an advertisement service provider of the advertisement service providers 126), each activity may comprise transfer or exchange of information. In such cases, each data value may include, but is not limited to, identification data (e.g., account identifiers, biometric data/information, blockchain identifiers, public keys, or data acquired by imaging devices, including images, videos, and/or live video streams for identification purposes) associated with one or more users 102, partners 104, verifiers 108, and/or advertisement service providers 126.

The data value may further comprise activity data related to activities such as the transfer or exchange of information between the server computer system 124 and a plurality of users 102, partners 104, verifiers 108, advertisement service providers 126, and/or other entities or systems. In certain implementations, a single blockchain may be utilized to record all activities of the users 102, partners 104, verifiers 108, and/or advertisement service providers 126. Alternatively, separate blockchains may be maintained for each account associated with the users 102, partners 104, verifiers 108, and/or advertisement service providers 126.

In embodiments where a blockchain may be a permissioned blockchain (access-controlled), processor 406 of the server computer system 124, a plurality of computing nodes 122, a plurality of user devices 110, a plurality of partner devices 112, a plurality of verifier devices 116, and/or a plurality of advertisement service provider devices 127 may be configured to execute the one or more sets of computer-readable instructions (software instructions) stored on storage component 402 and/or memory 404 in a trusted execution environment (a secure area of a processor).

In embodiments where a blockchain may be utilized, the blockchain may be a permissioned blockchain, public blockchain, or private blockchain. In embodiments where a blockchain may be a permissioned blockchain, the blockchain can only be accessed by participants who are allowed to access the blockchain, where the access may be controlled (e.g., verifying or validating transactions, and viewing data on the blockchain network may require permission).

In some embodiments, a blockchain may be used to store activity data of the verifiers 108 related to verification activities. Each data value included in a block within the blockchain may include, but is not limited to, identification data (e.g., account identifiers, biometric data/information, blockchain identifiers, public keys, or data acquired by imaging devices, such as images, videos, and/or live video streams for identification purposes) of one or more verifiers 108, as well as activity data related to one or more verification activities conducted by a verifier 108. New blocks may be added or appended to the blockchain when data related to a verification activity is updated, added, and/or verified. The blockchain configuration may vary such that a single blockchain may store all verification activities conducted by all verifiers 108, or separate blockchains may store verification activities conducted by each verifier 108, or alternatively, separate blockchains may store verification activities associated with each verifier account and/or partner account.

In some embodiments, the server computer system 124 may be a node in the blockchain network and may be configured to generate new blocks (e.g., to include new data received from user devices 110, partner devices 112, and advertisement service provider devices 127) that are validated by other nodes and added to the blockchain.

FIG. 4 is a diagram of example components of a device 400. Device 400 may correspond to a device from user devices 110, partner devices 112, verifier devices 116, computing nodes 122, and/or advertisement service provider devices 127. In some implementations, a device from the user devices 110, partner devices 112, verifier devices 116, and/or computing nodes 122 may include one or more components of device 400 and/or one or more devices 400. As shown in FIG. 4, device 400 may include a communications interface 408, a memory 404, a processor 406, a storage component 402, an input component 414, an output component 412, and a communications infrastructure 410.

In some implementations, device 400 may correspond to a device from the user devices 110 or any one or more devices associated with the user 102 (e.g., including but not limited to paired devices, wearable devices, or portable devices). In some implementations, a device from the user devices 110 or any one or more devices associated with the user 102 (e.g., including but not limited to paired devices, wearable devices, or portable devices) may comprise one or more devices 400 and/or one or more components of device 400, such as the communications infrastructure 410, memory 404, input component 414, output component 412, storage component 402, or communications interface 408.

By way of non-limiting example, one or more devices associated with the user 102 (e.g., including but not limited to paired devices, wearable devices, or portable devices) may correspond to device 400, comprising a processor 406 and components arranged differently, with fewer components, additional components, or different components than those shown in FIG. 4 (e.g., communications infrastructure 410, memory 404, input component 414, output component 412, storage component 402, communications interface 408). The processor 406 may be configured by software to perform one or more functions described herein.

Communications infrastructure 408 includes a component that permits communication among the components of device 400 such as a bus, network, multi-core message-passing scheme, message queue, etc.

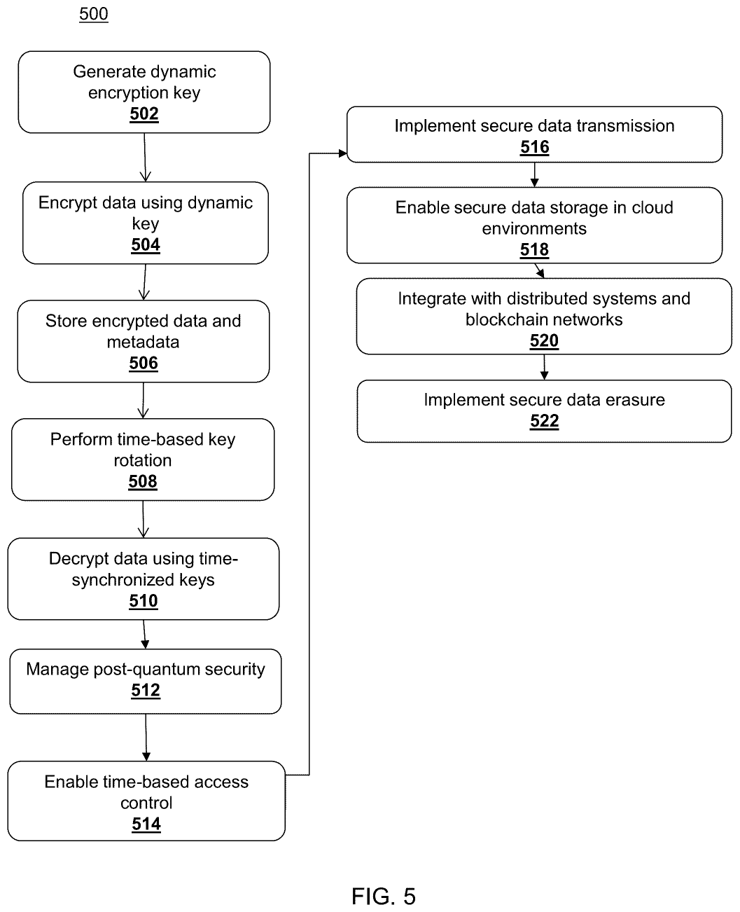

Processor 406 may be implemented in firmware, hardware, or a combination of software and hardware. Processor 406 may be connected to a communications infrastructure 410. Processor 406 may be an application-specific integrated circuit (ASIC), an accelerated processing unit (APU), a microprocessor, a field-programmable gate array (FPGA), a central processing unit (CPU), a microcontroller, a graphics processing unit (GPU), a digital signal processor (DSP), a general-purpose or special-purpose processor device specifically configured to perform the functions of the processor 406 discussed herein, or another type of processing component. In some implementations, processor 406 may include one or more processors capable of being programmed to perform a specific function. Processor 406 as described herein may be a single processor, a plurality of processors, or combinations thereof. Processor 406 may have one or more processor “cores.”. Processor 406 may be configured to execute computer-readable instructions (software instructions) stored on storage component 402 and/or memory 404. In some embodiments, the processor 406 executing software instructions stored on storage component 402 and/or memory 404 may be configured to perform one or more steps described with reference to FIG. 2, FIG. 3, and FIG. 5 herein. In some embodiments, a computer-readable medium may comprise non-volatile and/or volatile memory and have stored upon it a set of software instructions that, when executed by the processor 406, cause the processor 406 to perform one or more processes described herein.

The processor 406 may be configured to perform the functions of the server computer system 124 discussed herein as will be apparent to persons having skill in the relevant art. In some embodiments, the processor 406 may comprise one or more modules specifically configured to perform one or more functions of the processor 406. As used herein, the term “module” may be hardware or software programmed to perform one or more processes and provides an output using a received input. Based on the present disclosure, the processes, output, and input performed by different modules will be apparent to persons having skill in the relevant art.

In embodiments where a blockchain may be a permissioned blockchain, processor 406 may be configured to execute one or more sets of computer-readable instructions (software instructions) stored on storage component 402 and/or memory 404 in a trusted execution environment (a secure area of a processor).

Memory 404 may include read-only memory (ROM), a random-access memory (RAM), a static or dynamic storage device such as static memory (SRAM), magnetic memory, an optical memory, and/or a flash memory that stores information and/or instructions for use by processor 406. The memory 404 may be configured to store algorithms for use by one or more modules, communication protocols and standards, other algorithms, encryption keys, program code for modules and application programs of the server computer system 124, blockchain data, communications data for blockchain computing nodes 122, user devices 110, partner devices 112, verifier devices 116, and/or advertisement service provider devices 127, data formatting standards and protocols, and/or other data that may be suitable for use by the server computer system 124 in the performance of the functions disclosed herein as will be apparent to persons having skill in the relevant art.

The memory 404 may also be configured to store data comprises algorithms for use by one or more modules, blockchain data, communication data for blockchain computing nodes 122, identification data (e.g., account identifiers, biometric data, blockchain identifier, public keys, data acquired by the imaging device comprising images, videos, and/or live video streams for identification purposes) of users 102, partners 104, verifiers 108, and/or advertisement service providers 126, hashing algorithms for validating and/or generating blockchain blocks, etc.

Storage component 402 stores software and/or information relating to the use and operation of device 400. For example, storage component 402 may include a hard disk. The hard disk may be a solid-state disk, a magnetic disk, a magneto-optic disk, and/or an optical disk. The storage component 402 may also include flash memory, a magnetic tape, a digital versatile disc (DVD), a cartridge, a compact disc (CD), and/or a floppy disk. The storage component 402 may also include another type of non-transitory computer-readable medium, along with a corresponding drive. The storage component 402 may also include a removable memory chip (e.g., EEPROM, PROM, etc.), and other removable storage units as will be apparent to persons having skill in the relevant art.

Input component 414 includes a component that permits device 400 to receive information, such as a keyboard, a touch screen device, a keypad, a mouse, a switch, a microphone, a button, an optical scanner, and the like. The input component 414 may also include a Radio Frequency Identification (RFID) reader, a card reader, a scale, a barcode scanner, and the like. The input component 414 may also include a sensor for sensing information such as an accelerometer, a gyroscope, an actuator, Global Positioning System (GPS) component, Assisted Global Positioning System (AGPS) component, and the like. The input component 414 may also include one or more biometric devices. The bio-metrics devices or biometric sensors may include fingerprint reader, vein reader, facial recognition device, hand geometry device, iris recognition, retina, and odour/scent recognition device, voice recognition biometric data device, one or more imaging devices (e.g., an infrared imaging device, any other imaging devices), wherein the one or more imaging devices may comprise Complementary Metal Oxide Semiconductor (CMOS) sensor and/or Charge Coupled Device (CCD) sensor, and/or the like.

In some embodiments, the input component 414 may include one or more sensors or devices to acquire data. The one or more sensors or devices may include but not limited to one or more sensors or devices for sensing information such as temperature measurement devices, emissions sensor, energy measurement devices, speed measurement devices (e.g., RADAR, LIDAR), other RADAR sensors, thermometers, nano-plasmonic sensors, chemical sensors, proximity sensor, IR sensor (Infrared Sensor), optical particle sensors, pressure sensor, humidity sensors, ionization particle sensors, light sensor, mass spectrometers, ultrasonic sensor, carbon dioxide sensors, smoke, barometers, gas and alcohol sensor, oxygen sensors, touch sensor, color sensor, nitrogen sensors, Geiger counters, tilt sensor, flow, RF radiation detectors, and level sensor or combinations thereof, and/or any other sensor required for performing one or more functions of the device 400 described herein.

In some embodiments, device 400 may include a power management component that manages and monitors power consumption of the device components. In some embodiments, the power management component may include but not limited to a battery, power control circuitry, and/or monitoring systems that may provide battery level data and power state information to other device components. In some embodiments, the power management component may communicate with other components through the communications infrastructure 410 to enable power-aware operations and battery level monitoring.

In some embodiments, the input component 414 may include one or more sensors or devices to acquire data, where the data may be electrocardiogram (ECG) data that may be acquired via one or more electrodes; photoplethysmography (PPG) data that may be acquired through one or more LED-based sensors; bioimpedance data that may be measured using low-voltage electrical currents; accelerometer and gyroscope data that may be used for gait analysis; skin temperature data that may be acquired by infrared sensors; Galvanic Skin Response (GSR) data that may be acquired by electrodermal activity sensors; iris scan data that may be acquired by near-infrared cameras; and vein pattern recognition (VPR) data that may be captured using near-infrared sensors or ultrasound sensors to analyze unique blood vessel patterns.

In some embodiments, the input component 414 (e.g., a sensor for sensing information such as an accelerometer, a gyroscope, an actuator, global positioning system (GPS) component, Assisted Global Positioning System (AGPS) component, temperature measurement devices, speed measurement devices, etc.) may be anti-tampering or tamper-resistant. In some embodiments, the input component 414 may comprise a module node that acquires data (e.g., sensor data) from the input component 414 (e.g, sensor) and encrypts the data before sending it to be stored in the database 312 of the server computer system 124.

In some embodiments, the input component 414 may be a separate component from device 400 and may be operably and/or communicatively coupled to device 400. In some embodiments, the input component 414 may be physically attached to (or manufactured into) device 400.

Output component 412 includes a component that provides output information from device 400 including but not limited to one or more light-emitting diodes (LEDs), a speaker, and/or a display. In some embodiments, the output component 412 may be a separate component from device 400 and be operably and/or communicatively coupled to device 400.

Communications interface 408 includes a component that enables device 400 to communicate with other devices, such as via a wireless connection, a wired connection, or a combination of wireless and wired connections. The component is a transceiver-like component including but not limited to a separate receiver and transmitter or a transceiver. The communications interface may be configured to allow or enable data and software to be transferred between the device 400 and external devices. For example, communications interface 408 may include a network interface (e.g., an Ethernet card), a cellular network interface, an optical interface, a communications port, a coaxial interface, an infrared interface, a radio frequency (RF) interface, a Wi-Fi interface, a PCMCIA slot and card, a universal serial bus (USB) interface, or the like. Communications interface 408 may transfer data and software in the form of signals, which may be optical, electromagnetic, electronic, or other signals as will be apparent to persons having skill in the relevant art.

In some embodiments, the communications interface 408 may comprise one or more of a mobile data network transceiver, a Wi-Fi transceiver, an NFC transceiver, a Bluetooth transceiver, a network adapter, and/or the like. In some embodiments, the communications interface 408 may be configured to allow or enable the processor 406 to communicate with one or more computing nodes 122, user devices 110, partner devices 112, advertisement service provider devices 127, and/or verifier devices 116 over a network 120.

In some embodiments, the communications interface 408 may comprise a subscriber identity module (SIM) of one or more wireless or mobile carriers or wireless service providers that enables the device 400 to communicate with wireless or mobile carriers or wireless service providers and access and use their services. The one or more subscriber identity modules (SIMs) may comprise International Mobile Subscriber Identity (IMSI).

In embodiments where a blockchain may be utilized, the communications interface 408 may be configured to enables device 400 to communicate with other devices and to receive data signals electronically transmitted by the server computer system 124, computing nodes 122, user devices 110, partner devices 112, advertisement service provider devices 127, and/or verifier devices 116 in a blockchain network. In embodiments where a blockchain may be utilized, the communications interface 408 may be configured to enables device 400 to communicate with other devices and to transmit data signals electronically to the server computer system 124, computing nodes 122, user devices 110, partner devices 112, advertisement service provider devices 127, and/or verifier devices 116 in a blockchain network.

In some embodiments, the components or devices of the communications interface 408 may be a separate component from device 400 and be operably and/or communicatively coupled to device 400.

One or more processes described herein may be performed by device 400. The processes may be performed by device 400 based on processor 406 executing software instructions that may be stored by a non-transitory computer-readable medium such as storage component 402 and/or memory 404. As defined herein the computer-readable medium is a non-transitory memory device, where a memory device includes memory space spread across multiple physical storage devices or memory space within a single physical storage device. One or more processes described herein may be performed by processor 406 when the software instructions stored in the storage component 402 and/or memory 404 are executed. Alternatively, or additionally, one or more processes described herein may be performed by software instructions in combination with hardwired circuitry. One or more processes described herein may also be performed by hardwired circuitry in place of software instructions. As such, the embodiments and/or implementations described herein are not limited to any specific combination of software and hardware circuitry.

The number of components or arrangements shown in FIG. 4 is provided as an example. In practice, device 400 may include fewer components, additional components, different components, or differently arranged components than those shown in FIG. 4. One or more functions described herein may be performed by one or more components of device 400.

FIG. 2 shows a flowchart 200 illustrating a method for location verification in accordance with one or more embodiments.

At step 202, the processor 406 of the user device 110 may execute instructions to launch a software application, wherein the processor 406 may initiate a distributed key generation process through the communications interface 408 of the user device 110 to establish collaboration with one or more verifier devices 116 in the network (e.g., blockchain network). The process that may be executed by the processor 406 may comprise one or more of the following steps:

A) User Registration and Biometric Template Creation: The processor 406 of the user device 110 may initiate a registration process, prompting the user 102 to provide multiple types of biometric data. The biometric data may be acquired using one or more sensors and/or devices of the input component 414 of the user device 110. This data may include, but is not limited to: fingerprint data captured using sensors (e.g., including but not limited to, capacitive sensors, optical sensors, or any combination thereof); facial recognition data that may be obtained using one or more imaging devices, which may comprise sensors such as Complementary Metal Oxide Semiconductor (CMOS) sensors, Charge Coupled Device (CCD) sensors, or other imaging technologies; voice recognition data recorded using one or more microphones (e.g., including but not limited to, high-fidelity microphone arrays); electrocardiogram (ECG) data collected via electrodes (e.g., including but not limited to, electrodes integrated into the user device's surface or externally connected); photoplethysmography (PPG) data obtained through one or more sensors (e.g., including but not limited to, LED-based sensors); bioimpedance data that may be measured using low-voltage electrical currents that may be applied to the skin via electrodes, which detect changes in electrical resistance caused by variations in tissue composition or hydration levels; accelerometer and gyroscope data for gait analysis; skin temperature data captured using one or more sensors (e.g., including but not limited to, infrared sensors); Galvanic Skin Response (GSR) data obtained using one or more sensors (e.g., including but not limited to, sensors that may apply low-voltage electrical currents or other methods to detect skin conductance); iris scan data that may be captured using one or more imaging devices (e.g., including but not limited to, near-infrared imaging devices); and vein pattern recognition (VPR) data that may be acquired using one or more imaging devices or sensors (e.g., including but not limited to, near-infrared sensors or ultrasound sensors), where the data may be used for analyzing unique blood vessel patterns.

In one or more embodiments, the processor 406 of the user device 110 may implement an adaptive data collection mechanism based on the current context, which may optimize energy consumption while maintaining reliable functionality. This implementation may comprise one or more steps from the following steps: i) Analyzing sensor data received from one or more sensors and/or devices of the input component 414 of the one or more user devices 110 and/or any one or more devices associated with the user 102 (e.g., including but not limited to paired devices, wearable devices, or portable devices); in some embodiments, the analysis may be performed by the processor 406 of the user device 110, utilizing one or more algorithms or processing techniques tailored to the type of data and the operational context; the analysis perfumed by the processor 406 of the user device 110 may determine the current context, which may include, but is not limited to, the user's activity level (e.g., stationary, walking, running) and proximity to one or more predetermined geographical locations (e.g., restricted areas and/or prohibited areas); ii) Adjusting by the processor 406 of the user device 110, the data sampling rate dynamically for the user device 110 and/or any one or more devices associated with the user 102 (e.g., including but not limited to paired devices, wearable devices, or portable devices); the adjustment is based on the determined context and may aim to balance energy efficiency and operational accuracy; and iii) Communicating the adjusted sampling rate, through the communications interface 408 of the user device 110, to any one or more devices associated with the user 102 (e.g., including but not limited to paired devices, wearable devices, or portable devices); this may ensure synchronized energy-saving measures across multiple devices. This adjustment of the data sampling rate may include, but is not limited to: Setting a low sampling rate (e.g., every 5 minutes) when the user 102 is stationary and/or far from one or more geographical locations (e.g., restricted areas and/or prohibited areas), which may conserve battery power; Setting a medium sampling rate (e.g., every 1 minute) when the user is moving and/or near one or more geographical locations (e.g., restricted areas and/or prohibited areas), which may balance energy efficiency and operational accuracy; Setting a high sampling rate (e.g., every 30 seconds) when the user is in and/or very near to one or more geographical locations (e.g., restricted areas and/or prohibited areas), which may ensure the highest level of accuracy and security.

The implementation of the adaptive data collection mechanism may help achieve accurate location verification and biometric authentication while addressing the technical problem of energy efficiency in battery-powered devices, enabling continuous and long-term operation under varying environmental and user conditions. As used herein, the term “data sampling rate” may refer to the frequency at which the one or more user devices 110 may collect and process sensor data for location verification, biometric authentication and/or any other purposes. The implementation of the adaptive data collection mechanism described herein may yield multiple technical benefits, including but not limited to energy efficiency, enhanced processing efficiency, improved device longevity, context-aware accuracy, optimized network bandwidth usage, reduced sensor wear, enhanced system scalability, and/or improved user experience.

In one or more embodiments, the processor 406 of the user device 110 may perform multi-device data correlation. This correlation may comprise one or more steps from the following steps: a) Receiving, by the user device 110, sensor data from any one or more devices associated with the user 102 (e.g., paired devices, wearable devices, or portable devices) via the communications interface 408. The received sensor data may include, but is not limited to, biometric data, location data, accelerometer data, and/or gyroscope data; b) Analyzing, by the processor 406 of the user device 110 (e.g., analyzing using one or more algorithms), the received sensor data from any one or more devices associated with the user 102 (e.g., paired devices, wearable devices, or portable devices) and the sensor data received from one or more sensors and/or devices of the input component 414 of the user device 110 to determine one or more correlation scores, including at least: i) A movement correlation score based on accelerometer and gyroscope data; ii) A location correlation score based on location data, representing the calculated distance between the one or more user devices 110 and the one or more devices associated with the user 102 (e.g., paired devices, wearable devices, or portable devices); c) Comparing, by the processor 406, each correlation score to a respective predetermined threshold; d) If the location correlation score indicates that the distance between the one or more user devices 110 and the one or more devices associated with the user 102 (e.g., paired devices, wearable devices, or portable devices) exceeds a predetermined maximum allowed distance, or if the difference between the location data obtained from one or more sensors and/or devices of the input component 414 of the user device 110 and the location data received from the one or more devices associated with the user 102 (e.g., paired devices, wearable devices, or portable devices) exceeds a predetermined threshold, the processor 406 may: i) Generate an alert, which may be transmitted to one or more verifiers 108 using their associated verifier devices 116 for additional monitoring and/or system-wide security measures; ii) Immediately suspend any ongoing authentication or access processes associated with the user 102 account; iii) Prevent the user 102 and the user device 110 from registering, logging in, or accessing any secured features associated with the user account; iv) Send a task notification to one or more verifiers 108 using their associated verifier devices 116 to facilitate in-person verification; e) If the movement correlation score falls below its predetermined threshold, indicating potential device separation, the processor 406 may: i) Generate an alert, which may be transmitted through the communications interface 408 of the user device 110 to one or more verifiers 108 using their associated verifier devices 116 for additional monitoring and/or system-wide security measures; ii) Increase the frequency of location correlation checks; iii) Prompt the user 102 through the device's display or user interface to perform additional verification using biometric authentication. This may involve utilizing the one or more sensors and/or devices of the input component 414 of the user device 110 or the one or more devices associated with the user 102 (e.g., paired devices, wearable devices, or portable devices), with verification results may be processed locally or transmitted to verifier devices 116; f) Logging all correlation results and any actions taken in the secure storage component 402 and/or memory 404 of the user device 110 for audit purposes, with the logged data may be analyzed by one or more verifiers 108 using their associated verifier devices 116.

In one or more embodiments, the processor 406 of the user device 110 may perform proximity verification with one or more devices associated with the user 102 (e.g., paired devices, wearable devices, or portable devices). This verification may comprise one or more steps from the following steps: a) Emitting or transmitting, through the communications interface 408 of the user device 110, a signal at a predetermined power level; b) Receiving, through the communications interface 408 of the user device 110, a measured signal strength from the one or more devices associated with the user 102 (e.g., paired devices, wearable devices, or portable devices); c) Determining, by the processor 406 (e.g., using one or more algorithms), a first estimated distance between the user device 110 and the one or more devices associated with the user 102 (e.g., paired devices, wearable devices, or portable devices) based on the received signal strength; d) Receiving, by the user device 110, location data from one or more devices associated with the user 102 (e.g., paired devices, wearable devices, or portable devices) via the communications interface 408 and obtaining, by the processor 406 of the user device 110, location data from the one or more sensors and/or devices of the input component 414 of the user device 110; e) Determining, by the processor 406 (e.g., using one or more algorithms), a second estimated distance between the user device 110 and the one or more devices associated with the user 102 (e.g., paired devices, wearable devices, or portable devices) based on the received and obtained location data; f) Comparing, by the processor 406, the first estimated distance and the second estimated distance; g) If either the first or second estimated distance exceeds a predetermined maximum allowed distance, or the difference between the first and second estimated distances exceeds a predetermined threshold (e.g., exceeds a predetermined threshold or exceeds a predetermined maximum allowed distance that indicates potential device separation), the processor 406 may: i) Generate an alert, which may be transmitted through the communications interface 408 of the user device 110 to one or more verifiers 108 using their associated verifier devices 116 for additional monitoring and/or system-wide security measures; ii) suspend any ongoing authentication or access processes associated with the user 102 account; iii) Prevent the user 102 and the user device 110 from registering, logging in, or accessing any secured features associated with the user account; iv) Prompt the user 102 through the device's display or user interface to perform additional verification using biometric authentication. This may involve utilizing the one or more sensors and/or devices of the input component 414 of the user device 110 or the one or more devices associated with the user 102 (e.g., paired devices, wearable devices, or portable devices), with verification results processed locally or transmitted to verifier devices 116; v) Send a task notification to one or more verifiers 108 using their associated verifier devices 116 to facilitate in-person verification; and/or vi) Increase the frequency of location proximity verification; h) Logging all proximity verification results and any actions taken in the secure storage component 402 and/or memory 404 of the user device 110 for audit purposes, with the logged data analyzed by one or more verifiers 108 using their associated verifier devices 116.

In one or more embodiments, the processes that may comprise processes executed by the one or more processors 406 of the user device 110 and one or more processors 406 of the one or more devices associated with the user 102 (e.g., paired devices, wearable devices, or portable devices) may be performed by either: (i) the processor 406 of the user device 110, or (ii) one or more processors 406 of the one or more devices associated with the user 102 (e.g., paired devices, wearable devices, or portable devices), or (iii) a combination of processors 406 operating in a distributed consensus manner within a verified device cluster. The allocation of processing tasks between the processors 406 of the verified device cluster may be dynamically determined and redistributed in real-time based on a distributed monitoring and consensus mechanism.

In one or more embodiments, each processor 406 of the user device 110 and the one or more devices associated with the user 102 (e.g., paired devices, wearable devices, or portable devices) may implement/use one or more algorithms (e.g., an adaptive task distribution algorithm) that may operate in a distributed consensus mechanism, wherein: (i) each processor 406 may continuously monitor and store its local device metrics and associated paired device metrics in the secure storage component 402 and/or memory 404 of its local device, wherein the metrics may comprise device-specific performance data and inter-device correlation data; (ii) each processor 406 may broadcast stored metrics at predetermined intervals via its respective communications interface 408 to other devices within its verified device cluster, wherein the verified device cluster may comprise devices that have established mutual trust through successful biometric verification, proximity verification, and/or multi-device correlation checks; (iii) each processor 406 may maintain a synchronized distributed ledger in the secure storage component 402 and/or memory 404 of its local device that records the aggregated metrics from all devices, wherein the synchronization may be achieved through a consensus protocol (e.g., lightweight consensus protocol) that may: (1) validate the authenticity of the broadcasted metrics by cross-referencing them against: (a) current multi-device correlation scores, (b) proximity verification results, and (c) biometric verification status of the user 102, (2) require a minimum threshold of devices to confirm the validity of the metrics based on their own correlation data, (3) reject metrics from devices that fail any of the existing security checks or show significant deviations in correlation scores, and (4) maintain an audit trail of validation results in the distributed ledger; (iv) any processor 406 in the verified device cluster that has maintained valid correlation scores and security status may initiate the task redistribution process based on the synchronized ledger data. The metrics that may be monitored and stored may comprise: (i) movement correlation scores between devices based on accelerometer and gyroscope data, (ii) location correlation scores representing calculated distances between devices, (iii) signal strength-based proximity verification results, (iv) criticality of each biometric processing task, (v) current battery levels of all devices, (vi) available processing capacity, (vii) security requirements of each task, and (viii) historical device correlation patterns stored in the secure storage component 402 and/or memory 404 of its local device. When any processor 406 detects resource constraints on its local device, it may execute a task migration protocol to redistribute ongoing processing tasks to other available devices based on: (i) the results of the multi-device data correlation, including movement and location correlation scores exceeding predetermined thresholds, (ii) proximity verification results confirming the candidate devices are within acceptable physical proximity, and (iii) verification that no security alerts or authentication suspensions are currently active for the candidate devices.

In one or more embodiments, the processor 406 of the user device 110 may apply one or more algorithms, machine learning techniques, trained neural networks by means of deep learning and/or signal processing techniques to clean and normalize biometric data received by the user device 110 from one or more devices associated with the user 102 (e.g., paired devices, wearable devices, or portable devices) via the communications interface 408, and biometric data obtained by the processor 406 from the one or more sensors and/or devices of the input component 414 of the user device 110. The one or more techniques may include, but not limited to noise filtering, normalization to a predefined range, and/or segmentation to extract by the processor 406 of the user device 110 representative portions of the signal, including, but not limited to a single cardiac cycle (ECG) and/or pulse waveform (PPG).

In one or more embodiments, the processor 406 of the user device 110 may generate one or more biometric templates for each data type using one or more algorithms, machine learning techniques, and/or trained neural networks by means of deep learning, including but not limited to minutiae extraction for fingerprints or eigenface methods for facial recognition. For ECG data and/or PPG data, the processor 406 of the user device 110 may extract one or more features (e.g., stable features), including, but not limited to heart rate variability (HRV), PQRST complex characteristics (for ECG), and/or pulse transit time (for PPG), using one or more algorithms, machine learning techniques, and/or trained neural networks by means of deep learning (e.g., signal processing algorithms). These features may then be converted into a binary representation by the processor 406 of the user device 110 through using one or more algorithms, machine learning techniques, and/or trained neural networks by means of deep learning (e.g., quantization algorithms). The generated one or more biometric templates may represent stable and unique characteristics of the biometric inputs and may be securely processed for cryptographic use. Each biometric template may be encrypted by the processor 406 of the user device 110 using one or more algorithms (e.g., encryption algorithms) that implement one or more encryption schemes, including but not limited to a multi-layer encryption scheme combining symmetric encryption (e.g., AES-256) with homomorphic encryption. This encryption configuration may enable the processor 406 of the user device 110 to perform secure template matching without requiring decryption of the stored templates. The encrypted templates may be securely stored by the processor 406 of the user device 110 within the Trusted Execution Environment (TEE) of the user device 110, with each template may be assigned a unique identifier and version number by the processor 406 of the user device 110.

As used herein PQRST complex characteristics in electrocardiogram (ECG) signals may represent the electrical activity pattern of the heart during a complete cardiac cycle. The characteristics may comprise specific wave morphologies and temporal relationships, wherein a P wave may be the initial deflection representing atrial depolarization, followed by the QRS complex that may be a sequence of deflections corresponding to ventricular depolarization, and a T wave that may be the terminal deflection indicating ventricular repolarization. The temporal intervals between these waves, their respective amplitudes, and morphological features may provide diagnostic information regarding cardiac functionality and potential abnormalities.

In one or more embodiments, the processor 406 of the user device 110 may use one or more algorithms (e.g., a hybrid fuzzy vault scheme) to combine the one or more extracted biometric features with a Physical Unclonable Function (PUF) response derived from specific hardware characteristics of the user device 110. The PUF response serves as a unique hardware-based device identifier that cannot be cloned or replicated. The hybrid scheme may ensure that cryptographic key reconstruction is only possible upon simultaneous verification of both a valid biometric input and the correct hardware device, thereby establishing a two-factor security mechanism.

In one or more embodiments, the processor 406 of the user device 110 may generate a cryptographic hash by processing the biometric features. The processor 406 may concatenate the cryptographic hash with at least one of: a Physical Unclonable Function (PUF) response derived from specific hardware characteristics of the user device 110, a logical device identifier (e.g., device serial number, UUID), and/or a secure random value generated by the processor 406. The concatenated data may then be processed by the processor 406 using a hash function (e.g., SHA-256). The processor 406 of the user device 110 may store the resulting cryptographic hash in the Trusted Execution Environment (TEE) of the user device 110 and register it on a blockchain network as a unique identifier for the user or device 110, along with associated metadata for error correction and validation. The processor 406 of the user device 110 may implement one or more algorithms (e.g., fuzzy extractors) to ensure that natural variations in biometric inputs over time do not prevent accurate verification while maintaining security.

In one or more embodiments, during an authentication process, the processor 406 of the user device 110 may: (i) capture current biometric data, (ii) regenerate the cryptographic hash using the captured biometric data, (iii) use one or more matching algorithms (e.g., fuzzy extractor) to compare the regenerated hash against the stored hash in the TEE. Upon detection of deviations, which may be caused by health or environmental factors, the processor 406 may initiate a re-enrollment procedure to generate a new hash while maintaining historical records on the blockchain.

In one or more embodiments, following the initial data capture, the processor 406 of the user device 110 may perform continuous post-capture verification for each biometric modality. For ECG data, the verification may comprise one or more of: signal morphology analysis, heart rate variability assessment, inter-beat interval consistency checks, respiratory sinus arrhythmia detection, motion artifact detection and compensation, and continuous wavelet transform analysis, wherein each analysis may be performed using one or more algorithms, machine learning techniques, and/or trained neural networks by means of deep learning (e.g., convolutional neural networks, deep belief networks). For PPG data, the processor 406 of the user device 110 may conduct one or more of: waveform analysis, blood flow pattern verification, pulse transit time analysis, frequency spectrum analysis, and artifact detection, wherein each analysis may be performed using one or more algorithms, machine learning techniques, and/or trained neural networks by means of deep learning (e.g., recurrent neural networks, long short-term memory networks). These post-capture verification techniques may ensure that variations in signal quality are accounted for while maintaining the integrity and reliability of the biometric verification system.

B) Initial Biometric Verification: Prior to key generation, the user device 110 and/or the one or more devices associated with the user 102 (e.g., paired devices, wearable devices, or portable devices) may prompt the user 102 to provide one or more biometric inputs selected from a predetermined set of biometric inputs for verification. The one or more user devices 110 and/or the one or more devices associated with the user 102 (e.g., paired devices, wearable devices, or portable devices) may capture the requested biometric data using the one or more sensors and/or devices of the input component 414 of the user device 110 or the one or more devices associated with the user 102 (e.g., paired devices, wearable devices, or portable devices), which may include, but are not limited to: fingerprint data captured using sensors (e.g., including but not limited to, capacitive sensors, optical sensors, or any combination thereof); facial recognition data that may be obtained using one or more imaging devices, which may comprise sensors such as Complementary Metal Oxide Semiconductor (CMOS) sensors, Charge Coupled Device (CCD) sensors, or other imaging technologies; voice recognition data recorded using one or more microphones (e.g., including but not limited to, high-fidelity microphone arrays); electrocardiogram (ECG) data collected via electrodes (e.g., including but not limited to, electrodes integrated into the device's surface or externally connected); photoplethysmography (PPG) data obtained through one or more sensors (e.g., including but not limited to, LED-based sensors); bioimpedance data that may be measured using low-voltage electrical currents applied to the skin via electrodes, which detect changes in electrical resistance caused by variations in tissue composition or hydration levels; accelerometer and gyroscope data for gait analysis; skin temperature data captured using one or more sensors (e.g., including but not limited to, infrared sensors); Galvanic Skin Response (GSR) data obtained using one or more sensors (e.g., including but not limited to, sensors that apply low-voltage electrical currents or other methods to detect skin conductance); iris scan data captured using one or more imaging devices (e.g., including but not limited to, near-infrared imaging devices); and vein pattern recognition (VPR) data acquired using one or more imaging devices or sensors (e.g., including but not limited to, near-infrared sensors or ultrasound sensors), where the data may be used for analyzing unique blood vessel patterns.

In one or more embodiments, the processor 406 of the user device 110 and/or the one or more devices associated with the user 102 (e.g., paired devices, wearable devices, or portable devices) may then perform real-time liveness detection and authenticity verification for each biometric input to prevent potential attacks, including but not limited to spoofing attacks, wherein the processor 406 may: (i) For ECG/PPG biometric inputs: (1) analyze, using one or more algorithms, machine learning techniques, and/or trained neural networks by means of deep learning, signal quality metrics including signal-to-noise ratio and baseline wander, (2) detect, using one or more algorithms, machine learning techniques, and/or trained neural networks by means of deep learning, physiological variations including respiratory sinus arrhythmia and heart rate variability, (3) verify, using one or more algorithms, machine learning techniques, and/or trained neural networks by means of deep learning, natural beat-to-beat variations and physiological rhythm changes, (4) detect and compare, using one or more algorithms, machine learning techniques, and/or trained neural networks by means of deep learning, motion artifacts with accelerometer data for consistency, (5) validate, using one or more algorithms, machine learning techniques, and/or trained neural networks by means of deep learning, the presence of microvariations in waveform characteristics that are difficult to artificially replicate, and (6) cross-reference, using one or more algorithms, machine learning techniques, and/or trained neural networks by means of deep learning, multiple biometric channels for physiological consistency; (ii) For fingerprint biometric inputs: (1) detect, using one or more algorithms, machine learning techniques, and/or trained neural networks by means of deep learning, skin deformation patterns during finger pressure changes, (2) analyze, using one or more algorithms, machine learning techniques, and/or trained neural networks by means of deep learning, sub-dermal blood flow patterns using optical sensors, (3) measure, using one or more algorithms, machine learning techniques, and/or trained neural networks by means of deep learning, electrical conductivity of the finger surface, (4) verify, using one or more algorithms, machine learning techniques, and/or trained neural networks by means of deep learning, natural microsweating patterns, (5) detect, using one or more algorithms, machine learning techniques, and/or trained neural networks by means of deep learning, temperature variations consistent with living tissue, and (6) validate, using one or more algorithms, machine learning techniques, and/or trained neural networks by means of deep learning, three-dimensional depth characteristics of the fingerprint ridges; (iii) For facial biometric inputs: (1) detect, using one or more algorithms, machine learning techniques, and/or trained neural networks by means of deep learning, natural eye blinking patterns and micro-movements, (2) analyze, using one or more algorithms, machine learning techniques, and/or trained neural networks by means of deep learning, realistic skin texture variations and subsurface scattering, (3) verify, using one or more algorithms, machine learning techniques, and/or trained neural networks by means of deep learning, natural head movements using accelerometer data, (4) detect, using one or more algorithms, machine learning techniques, and/or trained neural networks by means of deep learning, facial muscle micro-movements, (5) analyze, using one or more algorithms, machine learning techniques, and/or trained neural networks by means of deep learning, infrared heat signatures consistent with living tissue, and (6) validate, using one or more algorithms, machine learning techniques, and/or trained neural networks by means of deep learning, depth information for three-dimensional face structure; (iv) For cross-modal verification: (1) correlate, using one or more algorithms, machine learning techniques, and/or trained neural networks by means of deep learning, detected movement patterns across different biometric modalities, (2) verify, using one or more algorithms, machine learning techniques, and/or trained neural networks by means of deep learning, temporal consistency between different biometric signals, (3) validate, using one or more algorithms, machine learning techniques, and/or trained neural networks by means of deep learning, physiological relationships between different biometric measurements, (4) analyze, using one or more algorithms, machine learning techniques, and/or trained neural networks by means of deep learning, the mutual information content between different biometric channels, and (5) detect, using one or more algorithms, machine learning techniques, and/or trained neural networks by means of deep learning, anomalies in cross-modal relationships that might indicate spoofing. In one or more embodiments, the processor 406 may implement these verifications using one or more machine learning models trained on both genuine and spoofed biometric samples to detect subtle differences in signal characteristics and physiological patterns that distinguish genuine from fraudulent inputs.

In one or more embodiments, the processor 406 and/or the one or more devices associated with the user 102 (e.g., paired devices, wearable devices, or portable devices) may execute pre-capture verification procedures for each biometric modality. For ECG data, this may include performing, using one or more algorithms, machine learning techniques, and/or trained neural networks by means of deep learning, one or more tasks, including but not limited to: sensor integrity checks, environmental noise assessment, and electrode contact quality evaluation. For PPG data, the processor 406 may perform, using one or more algorithms, one or more tasks, including but not limited to: light sensor calibration, ambient light interference assessment, and skin contact pressure evaluation. For bioimpedance data, the processor 406 may perform, using one or more algorithms, machine learning techniques, and/or trained neural networks by means of deep learning, one or more tasks, including but not limited to: electrode integrity checks, skin hydration assessment, and environmental conductivity evaluation. For vein pattern recognition, the processor 406 may perform, using one or more algorithms, machine learning techniques, and/or trained neural networks by means of deep learning, one or more tasks, including but not limited to: near-infrared sensor calibration, ambient infrared interference assessment, skin surface temperature measurement, and ultrasound sensor calibration.

In one or more embodiments, following data capture, the processor 406 and/or the one or more devices associated with the user 102 (e.g., paired devices, wearable devices, or portable devices) may perform continuous post-capture verification for each biometric modality. For ECG data, the processor 406 may perform, using one or more algorithms, machine learning techniques, and/or trained neural networks by means of deep learning (e.g., convolutional neural networks), one or more tasks, including but not limited to: signal morphology analysis, heart rate variability assessment, inter-beat interval consistency checks, respiratory sinus arrhythmia detection, motion artifact detection and compensation, and/or continuous wavelet transform analysis. For PPG data, the processor 406 may perform, using one or more algorithms, machine learning techniques, and/or trained neural networks by means of deep learning (e.g., recurrent neural networks), one or more tasks, including but not limited to: waveform analysis, blood flow pattern verification, pulse transit time analysis, frequency spectrum analysis, motion and pressure artifact detection, and/or photoplethysmogram imaging verification. In the case of bioimpedance data, the processor 406 may perform, using one or more algorithms, machine learning techniques, and/or trained neural networks by means of deep learning, one or more tasks, including but not limited to: multi-frequency analysis, temporal variability assessment, respiratory cycle correlation, body movement compensation, tissue composition verification, and/or electrode lift-off detection. For vein pattern recognition, the processor 406 may perform, using one or more algorithms, machine learning techniques, and/or trained neural networks by means of deep learning (e.g., 3D convolutional neural networks), one or more tasks, including but not limited to: dynamic vein pattern analysis, multi-spectral imaging verification, blood flow detection, temperature distribution assessment, pressure variation response analysis, and/or contextual consistency verification.

In one or more embodiments, the processor 406 and/or the one or more devices associated with the user 102 (e.g., paired devices, wearable devices, or portable devices) may perform, using one or more algorithms, machine learning techniques, and/or trained neural networks by means of deep learning a real-time anomaly detection. This may comprise combining supervised learning models (e.g., support vector machines, random forests) trained on large datasets of genuine and spoofed biometric data, unsupervised learning models (e.g., autoencoders, isolation forests) for detecting novel attack patterns, and online learning algorithms to continuously adapt to new potential threats and changes in user biometrics over time.

In one or more embodiments, the processor 406 and/or the one or more devices associated with the user 102 (e.g., paired devices, wearable devices, or portable devices) may execute real-time anomaly detection using one or more algorithms, machine learning techniques, and/or trained neural networks by means of deep learning. This process may include, but is not limited to, combining supervised learning models (e.g., support vector machines, random forests) that may be trained on datasets of genuine and spoofed biometric data; unsupervised learning models (e.g., autoencoders, isolation forests) that may be designed to identify novel attack patterns; and/or online learning algorithms that may be capable of continuously adapting to emerging threats and changes in user biometrics over time.

In one or more embodiments, the processor 406 of the user device 110 and/or the one or more devices associated with the user 102 (e.g., paired devices, wearable devices, or portable devices) may process the captured biometric data and convert it into one or more verification templates using one or more algorithms (e.g., the same algorithms employed during the registration phase). The processor 406 may then perform multi-modal biometric matching within the Trusted Execution Environment (TEE) of the user device 110. During this process, the processor 406 may compare the generated one or more verification templates with the stored one or more encrypted templates using one or more algorithms, and/or one or more secure matching techniques, including but not limited to homomorphic encryption schemes. This approach may ensure the confidentiality of the stored templates, as secure computations are performed directly on encrypted data without requiring decryption during the matching process.

In one or more embodiments, the processor 406 of the user device 110 and/or the one or more devices associated with the user 102 (e.g., paired devices, wearable devices, or portable devices) may assign a confidence score to each biometric input through a multi-phase process. In one or more embodiments, the processor 406 may execute a data collection phase, wherein the processor 406 may capture quality metrics in real-time during biometric data acquisition. For ECG/PPG data, this may comprise continuously monitoring by the processor 406 signal-to-noise ratio using wavelet-based analysis, measuring by the processor 406 baseline wander through low-frequency component analysis, and assessing by the processor 406 beat-to-beat interval consistency. For facial recognition, this may comprise analyzing by the processor 406 image clarity through resolution assessment, evaluating by the processor 406 lighting conditions using exposure metrics, and measuring by the processor 406 facial alignment angles. For fingerprint data, this may comprise assessing by the processor 406 ridge clarity through contrast analysis, evaluating by the processor 406 pressure consistency via capacitive measurements, and measuring by the processor 406 surface area coverage.

In one or more embodiments, during the data collection phase, the processor 406 may perform template matching within the Trusted Execution Environment of the user device 110 and/or the one or more devices associated with the user 102 (e.g., paired devices, wearable devices, or portable devices) by: (i) generating verification templates from current biometric inputs using one or more algorithms (e.g., the same one or more algorithms employed during registration); (ii) computing match scores using one or more algorithm-based comparison techniques, including but not limited to homomorphic encryption-based comparison with stored encrypted templates. The comparison process may involve performing secure computations directly on encrypted biometric data without requiring decryption, which may ensure the confidentiality and integrity of the stored templates; and/or (iii) tracking the degree of deviation from stored templates across multiple features.

In one or more embodiments, the processor 406 may execute a real-time analysis phase comprising execution of/use of one or more algorithms, machine learning techniques, and/or trained neural networks by means of deep learning (e.g., liveness detection algorithms) to: (i) monitor physiological consistency in ECG/PPG signals; (ii) detect natural micro-movements in facial recognition; and/or (iii) verify skin deformation patterns in fingerprint scans. The processor 406 may further use one or more algorithms, machine learning techniques, and/or trained neural networks by means of deep learning to perform anomaly detection comprising using: (i) supervised learning models trained on known attack patterns; (ii) unsupervised learning algorithms for novel attack detection; and/or (iii) real-time comparison with historical behavioral patterns.

In one or more embodiments, the processor 406 may perform, using one or more algorithms, machine learning techniques, and/or trained neural networks by means of deep learning a cross-modal verification phase comprising correlation analysis between different biometric modalities by: (i) comparing temporal relationships between signals; (ii) verifying physiological consistency across modalities; and/or (iii) detecting anomalies in cross-modal relationships.

In one or more embodiments, the processor 406 may integrate device-level checks. This may help enhance the security and reliability of the biometric verification process by validating the physical context of the authentication attempt. This integration may be necessary because: (i) multi-device correlation results help verify that all associated devices of the user 102 are behaving consistently, which may prevent relay attacks where an attacker tries to forward legitimate biometric data from a different location; (ii) proximity verification outcomes may help ensure that all associated devices are within acceptable physical proximity of each other, which may prevent scenarios where a compromised device attempts to participate in the authentication process from a remote location; and (iii) movement pattern consistency across devices may help confirm that the user 102 is genuinely present and interacting with all devices simultaneously, which may prevent replay attacks where recorded movement data is used to simulate legitimate device usage. The processor 406 may perform this integration using one or more algorithms, machine learning techniques, and/or trained neural networks by means of deep learning by: (a) comparing the movement correlation scores between devices based on accelerometer and gyroscope data; (b) analyzing the location correlation scores representing calculated distances between devices; (c) evaluating signal strength-based proximity verification results; and (d) cross-referencing these device-level checks against the current multi-device data correlation scores to ensure consistent behavior across the verified device cluster. In one or more embodiments, if any of these device-level checks fail to meet predetermined thresholds, the processor 406 may: (i) reduce the confidence scores for affected biometric modalities; (ii) trigger additional verification requirements; (iii) increase the frequency of proximity and correlation checks; and/or (iv) suspend the authentication process until the inconsistencies are resolved through additional verification steps or request intervention by one or more verifiers 108 using their associated verifier devices 116.

In one or more embodiments, during a score assignment phase, the processor 406 may determine individual component scores for: (i) signal quality on a scale (e.g., 0-100 scale) based on quality metrics; (ii) template match accuracy on a scale (e.g., 0-100 scale) based on degree of match; (iii) liveness detection confidence on a scale (e.g., 0-100 scale) based on physiological consistency; (iv) anomaly detection results on a scale (e.g., 0-100 scale) based on deviation from expected patterns; and/or (v) cross-modal verification on a scale (e.g., 0-100 scale) based on inter-modal consistency.

In one or more embodiments, the processor 406 may apply weighted averaging to component scores using: (i) historical reliability weights for each metric; (ii) current environmental condition adjustments; and (iii) security risk level factors. The processor 406 may generate a final confidence score through: (i) normalization of weighted average to a scale (e.g., 0-100 scale); (ii) application of any penalty factors for detected anomalies; and/or (iii) adjustment based on current security context.

In one or more embodiments, the resulting confidence score may then be used by the processor 406 to dynamically adjust the weighting in one or more multi-modal fusion algorithms, with higher confidence scores leading to greater weight being assigned to that particular biometric modality in the overall authentication decision.

In one or more embodiments, the processor 406 may implement an adaptive scoring mechanism that continuously updates the confidence scores using one or more algorithms, machine learning techniques, and/or trained neural networks by means of deep learning based on: (i) the results of pre-capture verification procedures for each biometric modality, including but not limited to sensor integrity checks, environmental assessments, and calibration results; (ii) the outcomes of post-capture verification analysis, including but not limited to signal morphology analysis, pattern verification, and artifact detection results; (iii) the correlation between different biometric channels as determined by cross-modal verification, including but not limited to temporal relationships and physiological consistency; and/or (iv) the temporal consistency of the biometric signals across multiple capture sessions. The confidence scores may be securely stored within the Trusted Execution Environment of the user device 110 and/or the one or more devices associated with the user 102 (e.g., paired devices, wearable devices, or portable devices) and may be used to maintain a historical record of the reliability of each biometric modality for the specific user 102.

In one or more embodiments, the processor 406 of the user device 110 and/or the one or more devices associated with the user 102 (e.g., paired devices, wearable devices, or portable devices) may execute one or more algorithms (e.g., fusion algorithms) to combine the match scores from different biometric modalities. The processor 406 may execute one or more algorithms with adaptive weighting techniques to determine weighted values for each biometric modality, wherein the adaptive weighting techniques consider: (i) the historical accuracy of each modality as recorded in the Trusted Execution Environment of the user device 110 and/or the one or more devices associated with the user 102; (ii) the current confidence scores derived from real-time anomaly detection using supervised and unsupervised learning models; (iii) the results of multi-device data correlation, including movement and location correlation scores; (iv) the proximity verification status between the user device 110 and associated devices, including signal strength measurements and calculated distances; and (v) the current environmental conditions affecting sensor performance as determined by pre-capture verification procedures. The processor 406 may execute one or more algorithms, machine learning techniques, including but not limited to neural networks and adaptive learning algorithms, to optimize these weighted values based on: (a) the verification results of previous authentication attempts; (b) the historical performance metrics of each biometric modality; (c) the detected error rates and false acceptance/rejection incidents; and (d) the correlation between different authentication factors and successful verifications.

In one or more embodiments, the processor 406 of the user device 110 and/or the one or more devices associated with the user 102 (e.g., paired devices, wearable devices, or portable devices) may execute one or more algorithms (e.g., fusion algorithms) to generate a combined authentication score that represents the aggregate certainty of user identity across all provided biometric inputs. The processor 406 may execute one or more algorithms to evaluate this score against a dynamically adjusted threshold, wherein the threshold is continuously optimized based on: (i) the user's interaction history that may be stored in the Trusted Execution Environment of the user device 110 and/or the one or more devices associated with the user 102; (ii) the security requirements of the requested operation; (iii) the current global threat level that may be assessed by the blockchain network; (iv) the results of multi-device correlation checks; and (v) the outcomes of proximity verification processes. If the combined score exceeds the dynamic threshold, the processor 406 may authenticate the user 102, and the key generation process may proceed. In cases where the combined score falls within a predefined margin of the threshold, the processor 406 may: (i) request additional biometric inputs through the one or more sensors and/or devices of the input component 414 of the user device 110 or the one or more devices associated with the user 102; (ii) execute one or more algorithms to increase the frequency of proximity verification checks; (iii) execute one or more algorithms to initiate additional cross-modal verification procedures; and/or (iv) challenge the user 102 with knowledge-based authentication as a supplementary measure.

C) Initialization of Distributed Key Generation: In one or more embodiments, upon successful biometric authentication, the processor 406 of the user device 110 and/or the one or more devices associated with the user 102 (e.g., paired devices, wearable devices, or portable devices) may execute one or more algorithms to: (i) generate a unique session identifier using a combination including but not limited to a hardware-based true random number generator, a nanosecond-precision timestamp, and/or a hash of the successful biometric verification result; and (ii) establish secure communication channels with a predetermined number of verifier devices 116 in the blockchain network using one or more protocols (e.g., quantum-resistant key exchange protocols such as variants of the Supersingular Isogeny Diffie-Hellman key exchange). The processor 406 may then transmit the session identifier and a cryptographic commitment of the biometric verification result to the one or more verifier devices 116.

D) Collaborative Random Value Generation: The one or more user devices 110 and verifier devices 116 may engage in a distributed random beacon protocol to generate a shared random value. Each device may contribute entropy derived from hardware random number generators, environmental sensor data, and/or network timing variations. The contributed entropy may be combined using a verifiable delay function (VDF) to prevent last-actor bias. The resulting shared random value may seed subsequent key generation steps.

In one or more embodiments, the processor 406 of the user device 110, the one or more devices associated with the user 102 (e.g., paired devices, wearable devices, or portable devices), and/or the one or more verifier devices 116 may execute one or more algorithms/protocols (e.g., random beacon protocols) to generate a shared random value. The processor 406 may: (i) derive entropy from one or more sources including but not limited to hardware random number generators, environmental sensor data, and/or network timing variations; and (ii) combine the contributed entropy using one or more cryptographic functions (e.g., verifiable delay functions (VDF)) to prevent last-actor bias. The processor 406 may use the resulting shared random value to seed subsequent key generation steps.

E) Threshold Key Generation: The user device 110 may initiate a t-out-of-n threshold key generation protocol, where t is the minimum number of parties required to reconstruct the key, and n is the total number of participants. This protocol may employ a combination of Shamir's Secret Sharing and elliptic curve cryptography optimized for mobile/portable devices. Each participant may generate their key share using the shared random value and unique device identifiers. The shares may be exchanged using a secure multi-party computation protocol ensuring no single party can learn the complete key.

F) Biometric Key Binding: The user device 110 may perform a biometric key binding process, securely linking generated cryptographic keys to the user's biometric templates. This process may employ one or more methods (e.g., a fuzzy vault scheme enhanced with error-correcting codes) to account for natural variations in biometric data. The steps may include but not limited to encoding the cryptographic key as coefficients of a polynomial, generating a set of genuine points from the polynomial using the user's biometric features, adding chaff points to obscure genuine points, and/or applying Reed-Solomon error-correcting codes for robustness. The process may ensure that the full key can only be reconstructed when presented with a valid biometric input by storing only the fuzzy vault and error-correcting data, requiring a matching biometric input to identify genuine points and reconstruct the polynomial, and using the reconstructed polynomial to recover the original cryptographic key.

Additionally, the process may incorporate PUF-based authentication by extracting a unique device fingerprint using Physical Unclonable Functions from the user device 110's hardware, combining the PUF response with biometric data to create a hybrid fuzzy vault, and requiring both a matching biometric input and the correct device for key reconstruction.

The user device 110 may implement this biometric key binding process for various biometric modalities, including but not limited to ECG, PPG, and Bioimpedance data. For these modalities, the process may proceed as follows:

In an embodiment, the processor 406 may extract unique features from each biometric modality. For ECG data, this may include waveform characteristics such as QRS complex morphology, T-wave amplitude, and R-R interval variability. For PPG data, the processor 406 may extract pulse wave velocity, peak-to-peak intervals, and waveform area under the curve. In the case of Bioimpedance data, the processor 406 may derive features such as impedance at multiple frequencies, phase angle variations, and tissue composition indicators.

The processor 406 may then combine these features to create a multi-modal biometric template. This combination process may involve feature-level fusion techniques, such as feature concatenation or weighted feature summation, where the weights may be dynamically adjusted based on the quality and reliability of each modality's data.

The user device 110 may use this multi-modal template to generate the genuine points for the fuzzy vault. The processor 406 may map the combined feature vector onto the polynomial used in the fuzzy vault scheme. This mapping process may involve quantization of continuous biometric features and error-correction coding to account for natural variations in the biometric data.

During the verification phase, when the user 102 presents their biometric data for authentication, the user device 110 may process the newly captured ECG, PPG, and Bioimpedance data using the same feature extraction and fusion methods. The processor 406 may then attempt to match this presented biometric data against the fuzzy vault. To reconstruct the key, the processor 406 may identify potential genuine points in the fuzzy vault using the presented biometric data. It may then apply error-correction decoding to compensate for slight variations in the biometric features. If a sufficient number of genuine points are correctly identified, the processor 406 may reconstruct the polynomial and subsequently recover the original cryptographic key.

This multi-modal approach may enhance the security and reliability of the biometric key binding process. The fusion of these modalities may also provide resilience against potential spoofing attacks targeting any single biometric characteristic. The use of error-correcting codes in this process may allow for successful key reconstruction even when there are minor variations in the user 102's biometric signals due to factors such as stress, physical activity, or slight changes in sensor placement. This may ensure a balance between security and usability in the biometric key binding process.

G) Key Finalization and Storage: The user device 110 may combine threshold key shares to derive the final public key (PK) and master secret key (MSK). A user 102 secret key (SK_user) may be generated using one or more algorithms incorporating the master secret key, a hash of the user's biometric templates, and/or device-specific hardware identifiers including but not limited to PUF responses. The keys may be securely stored in the user device 110's TEE, with SK_user may further be encrypted using the biometric key binding scheme. The public key may be registered on the blockchain network along with a zero-knowledge proof of correct key generation and biometric binding.

H) Post-Generation Verification: The processor 406 of the user device 110 may perform a series of cryptographic challenges using one or more generated keys to verify their correctness and the integrity of the generation process. One or more processors 406 of one or more verifier devices 116 may independently validate one or more zero-knowledge proof and cryptographic challenge results. Upon successful verification, the key generation process may be deemed complete, and the user device 110 may be authorized to participate in the secure location verification protocol.

As used herein, the term “the Distributed Key Generation (DKG)” may refer to the process that may be initiated by the software application on a device (e.g., user device 110), in collaboration with the network of verifier devices 116, to jointly generate the public key (PK) and master secret key (MSK) using protocols such as Pedersen's DKG.

In an embodiment, the method may further comprise retrieving, by the processor 406 of the user device 110, prohibited location data, wherein the retrieval may comprise one or more steps from the following steps: a) Establishing, by the processor 406 through the communications interface 408 of the user device 110 secure connections with one or more verifier devices 116 or decentralized storage systems (e.g., IPFS); b) Retrieving, by the processor 406 of the user device 110 metadata of prohibited locations or location-based restrictions from the one or more verifier devices 116 or decentralized storage systems (e.g., IPFS), which may include but not limited to: i) Coordinates of restricted areas; ii) Names or identifiers of prohibited locations; iii) Boundaries and geometries of restricted areas; iv) Associated attributes such as time-based or event-triggered restrictions; c) Executing, by the processor 406 of the user device 110 a secure caching mechanism for efficient access to frequently used location data, which may include but not limited to: i) Encrypting, by the processor 406 of the user device 110 cached data using hardware-backed encryption when available; ii) Utilizing, by the processor 406 of the user device 110 least recently used (LRU) or other one or more efficient caching algorithms; iii) confirming, by the processor 406 of the user device 110 cache coherence with the primary data source; d) Executing, by the processor 406 of the user device 110 a protocol for periodic updates of the prohibited location database, which may include but not limited to: i) Executing, by the processor 406 of the user device 110 a pull-based update mechanism with configurable intervals; ii) Executing, by the processor 406 of the user device 110 a push-based notification processes for critical updates; iii) Verifying, by the processor 406 of the user device 110 the integrity and authenticity of received updates using digital signatures.

In some embodiments, the server computer system 124 may receive one or more requests to register one or more users 102, partners 104, verifiers 108, and/or advertisement service providers 127 with the server computer system 124.

In some embodiments, the server computer system 124 may generate or otherwise retrieve from the storage component 402 and/or memory 404 of the server computer system 124 a registration template for registering one or more users 102, partners 104, verifiers 108, and advertisement service providers 127 with the server computer system 124. The registration template may comprise multiple registration steps, each step may require collecting information from the one or more users 102, partners 104, verifiers 108, and/or advertisement service providers 126 and/or their associated devices.

The server computer system 124 may associate the users 102, partners 104, verifiers 108, and/or advertisement service providers 127 information data with the device identification information of their associated devices (user devices 110, partner devices 112, verifier devices 116, and/or advertisement service provider devices 127).

The server computer system 124 may store in the storage component 402 and/or memory 404 of the server computer system 124, the associated one or more users 102, partners 104, verifiers 108, and/or advertisement service providers 127 information data with the device identification data of their associated devices (user devices 110, partner devices 112, verifier devices 116, and/or advertisement service provider devices 127).

In some embodiments, one or more requests for the one or more users 102, partners 104, verifiers 108, and/or advertisement service providers 126 to create one or more biometric templates (e.g., face templates, electrocardiogram (ECG) templates, photoplethysmography (PPG) templates, skin temperature templates, galvanic skin response (GSR) templates, vein pattern recognition (VPR) templates) may be generated by the server computer system 124 for display on their associated devices (user devices 110, partner devices 112, verifier devices 116, and/or advertisement service provider devices 127) during or after the registration.

In some embodiments, the server computer system 124 may receive data or one or more data records comprising biometric information/data (e.g., face images data, electrocardiogram (ECG) data, photoplethysmography (PPG) data, skin temperature data, galvanic skin response (GSR) data, vein pattern recognition (VPR) data) of one or more users 102, partners 104, verifiers 108, and/or advertisement service providers 126 acquired by the one or more sensors (e.g., CMOS and CCD sensors, LED-based sensors, low-voltage electrical currents sensor, accelerometer and gyroscope, infrared sensors, electrodermal activity sensors, infrared cameras/sensors, and near-infrared sensors or ultrasound sensors) of the one or more user devices 110, partner devices 112, verifier devices 116, and/or advertisement service provider devices 127.

In some embodiments, the server computer system 124 may generate a biometric template (e.g., face template, electrocardiogram (ECG) templates) for each of the users 102, partners 104, verifiers 108, and/or advertisement service providers 126 based on the received biometric information/data (e.g., face image data, electrocardiogram (ECG) data). The server computer system 124 may associate the one or more users 102, partners 104, verifiers 108, and/or advertisement service providers 127 information data with their biometric template data (e.g., face template data, electrocardiogram (ECG) template data) and/or biometric information (e.g., face images data, electrocardiogram (ECG) data). In some embodiments, the server computer system 124 may generate the biometric template (e.g., face template, electrocardiogram (ECG) template) by extracting one or more biometric (e.g., face image, electrocardiogram (ECG)) features from the received biometric information (e.g., face image data, electrocardiogram (ECG) data) using one or more algorithms.

In some embodiments, the server computer system 124 may store in the storage component 402 and/or memory 404 of the server computer system 124, the associated users 102, partners 104, verifiers 108, and/or advertisement service providers 127 information data with their biometric template data (e.g., face template data, electrocardiogram (ECG) template data) and/or biometric information (e.g., face images data, electrocardiogram (ECG) data).

In some embodiments, the server computer system 124 may receive data or one or more data records comprising geographical location data (e.g., GPS/AGPS coordinates) of one or more user devices 110, partner devices 112, verifier devices 116, and/or advertisement service provider devices 127. The geographical location data (e.g., GPS/AGPS coordinates) may be acquired by their GPS/AGPS components during or after the registration. The server computer system 124 may associate the one or more user devices 110, partner devices 112, verifier devices 116, and/or advertisement service provider devices 127 information data with their geographical location data (e.g., GPS/AGPS coordinates). The server computer system 124 may store in the storage component 402 and/or memory 404 of the server computer system 124, the associated user devices 110, partner devices 112, verifier devices 116, and/or advertisement service provider devices 127 information data with their geographical location data (e.g., GPS/AGPS coordinates).

At step 202A, the method may further comprise implementing, a hybrid storage system for location-based restrictions. This implementation may comprise one or more steps from the following steps: a) Storing, by the processor 406 of the user device 110 one or more non-sensitive restrictions locally on the user device 110 for offline functionality, which may include but not limited to: i) Identifying, by the processor 406 of the user device 110 and categorizing restrictions based on sensitivity and update frequency; ii) Encrypting, by the processor 406 of the user device 110, the local storage using one or more encryption algorithms (e.g., AES-256); iii) Executing, by the processor 406 of the user device 110, authentication processes to prevent unauthorized modification of stored restrictions; b) Storing by the processor 406 of the one or more verifier devices 116 sensitive or frequently updated restrictions on one or more verifier devices 116, secure remote servers, and/or decentralized storage networks (e.g., IPFS); c) Executing, by the processor 406 of the user device 110, a synchronization protocol to ensure consistency between local and remote data when online connectivity is available.

At step 202B, the method may further comprise implementing a secure boot process. This implementation may comprise one or more steps from the following steps: a) Executing, by the processor 406 of the user device 110, a secure boot mechanism for the application or user device handling location-based restrictions, which may include but not limited to: i) Implementing a chain of trust from hardware to application level; ii) Utilizing, by the processor 406 of the user device 110, hardware security modules (HSM) or trusted platform modules (TPM) when available; iii) Utilizing, by the processor 406 of the user device 110, code signing to ensure the integrity of boot components; b) Validating, by the processor 406 of the user device 110, the integrity of the software and stored data before allowing operation, which may include: i) Performing, by the processor 406 of the user device 110, one or more cryptographic hash checks on software components and data; ii) Verifying, by the processor 406 of the user device 110, one or more digital signatures of software updates; iii) storing, by the processor 406 of the user device 110, one or more validation keys and certificates securely; c) Implementing, by the processor 406 of the user device 110, measures to prevent bypassing of the secure boot process, which may include but not limited to: i) Disabling, by the processor 406 of the user device 110, debug interfaces in the user device 110 when the user device 110 is operating in a production environment and or disabling, by the processor 406 of the user device 110, debug interfaces in the user device 110 after the software application is deployed for operational use; ii) Executing, by the processor 406 of the user device 110, anti-rollback protection for software versions; iii) Utilizing by the processor 406 of the user device 110, hardware-backed secure boot when available on the user device 110.

At step 202C, the method may further comprise executing, by the processor 406 of the user device 110, one or more decentralized storage operations for prohibited locations. These operations may comprise one or more steps from the following steps:
a) Establishing, by the processor 406 through the communications interface 408 of the user device 110, connections with one or more decentralized storage networks (e.g., IPFS) for storing prohibited location data; b) Executing, by the processor 406 of the user device 110, one or more protocols for storing, retrieving, and updating location data on the decentralized network, which may include but not limited to: i) Configuring, by the processor 406 of the user device 110, content-addressed storage for efficient data retrieval; ii) Executing, by the processor 406 of the user device 110, one or more naming processes for identification of location data sets; iii) Executing, by the processor 406 of the user device 110, one or more mechanisms for partial updates to minimize bandwidth usage; c) Performing, by the processor 406 of the user device 110, one or more data integrity checks and version control for stored location data, which may include: i) Utilizing, by the processor 406 of the user device 110, Merkle Directed Acyclic Graphs (DAGs) for integrity verification; ii) Configuring, by the processor 406 of the user device 110, a versioning system compatible with decentralized storage; iii) Executing, by the processor 406 of the user device 110, one or more conflict resolution strategies for simultaneous updates; d) Executing, by the processor 406 of the user device 110, one or more access control mechanisms to ensure only authorized entities can modify the stored data, which may include but not limited to: i) Executing, by the processor 406 of the user device 110, one or more decentralized identity (DID) processes for user and device authentication; ii) Executing, by the processor 406 of the user device 110, one or more smart contracts for granular access control management; iii) Performing, by the processor 406 of the user device 110, one or more key rotation mechanisms to enhance long-term security.

At Step 204, the processor 406 of the user device 110 may generate a temporary identifier (e.g., Ephemeral Identifier (EID)) for the current session. This generation may comprise one or more steps of the following steps:
a) The processor 406 may prepare input data by: i) Retrieving current temporal data (e.g., current date and time with nanosecond precision); ii) Obtaining a predefined time interval (e.g., 15-minute epoch); iii) Fetching the newly generated public key (PK) from the secure storage area (e.g., secure storage area established in Step 202); iv) Retrieving the biometric verification result from the successful authentication (e.g., successful authentication in Step 202).
b) The processor 406 may generate a Biometric Authentication Token (BAT) by: i) Creating a cryptographic hash of the biometric verification result using a secure hash function (e.g., SHA-3); ii) Generating a zero-knowledge proof of successful biometric authentication; iii) Combining the hash and the zero-knowledge proof to form the BAT.
c) The processor 406 may compute a verifiable random output by: i) Constructing an input string by concatenating the current temporal data, predefined time interval, public key (PK), and Biometric Authentication Token (BAT); ii) Using a Verifiable Random Function (VRF) based on elliptic curves (e.g., ECVRF-EDWARDS25519-SHA512-ELL2) with the user's secret key to compute a verifiable random output and a proof of correctness.
d) The processor 406 may derive the Ephemeral Identifier (EID) by: i) Using a Key Derivation Function KDF (e.g., HKDF-SHA256) with the verifiable random output as the key material, the public key (PK) as salt, and the Biometric Authentication Token (BAT) as info; ii) The output of the Key Derivation Function KDF may be the Ephemeral Identifier (EID).
e) The processor 406 may bind the Ephemeral Identifier (EID) to the authentication and key generation by: i) Creating a binding structure containing the Ephemeral Identifier (EID), a hash of the public key (PK), the Biometric Authentication Token (BAT), and a timestamp of Ephemeral Identifier (EID) generation; ii) Signing the binding structure using the user's secret key (e.g., user's secret key generated in Step 202); iii) Storing the signed binding structure in the secure storage area (e.g., TEE or Secure Enclave) of the user device 110.
f) The processor 406 may generate a proof of correct Ephemeral Identifier generation by: i) Creating a zero-knowledge proof that demonstrates the Ephemeral Identifier was generated using the correct public key (PK), is bound to a valid biometric authentication session, and was generated using the Verifiable Random Function and a Key Derivation Function as specified; ii) Ensuring the proof does not reveal the actual public key, biometric data, or the user's secret key.
g) The processor 406 may prepare an Ephemeral Identifier package for use by: i) Assembling an Ephemeral Identifier package containing the Ephemeral Identifier (EID), the Verifiable Random Function proof of correctness, the zero-knowledge proof of correct Ephemeral Identifier generation, and the signed binding structure (excluding sensitive components); ii) Encrypting the Ephemeral Identifier package using attribute-based encryption, with attributes derived from the current session context.

As used herein, the term “Ephemeral Identifier (EID)” may refer to a temporary identifier generated by the processor 406 of the user device 110 for each session.

As used herein, the term “Verifiable Random Function (VRF)” may refer to a cryptographic function used by the processor 406 to compute a verifiable random output and proof.

At step 206, the processor 406 of the user device 110 may construct one or more beacons/beacon messages. This construction may comprise one or more steps from the following steps:
a) Generating a timestamp of a predetermined bit length (e.g., 64-bit Unix timestamp);
b) Generating a nonce using one or more cryptographically secure random number generation methods (e.g., Cryptographically Secure Pseudo-Random Number Generator (CSPRNG));
c) Creating a location commitment using one or more cryptographic hash functions (e.g., HMAC-SHA256) based on geographical location data (e.g., GPS/AGPS coordinates) that may be acquired by the GPS and/or AGPS components of the input component 414 of the user device 110, and/or obtained from the Wi-Fi interface of the communications interface 408 of the user device 110;
d) Generating an environmental signature by collecting sensor data from one or more sensors (e.g., accelerometer, gyroscope, magnetometer) of the user device 110 and computing a cryptographic hash (e.g., SHA3-256);
e) Generating a biometric verification token, which may comprise: i) Creating a cryptographic hash of the biometric verification result using a secure hash function (e.g., SHA-3); ii) Incorporating a timestamp of the most recent successful biometric authentication; iii) Adding a reference to the type of biometric data used (e.g., fingerprint, facial recognition, voice recognition);
f) Creating a reference to the distributed key generation process, which may comprise: i) Generating a cryptographic hash of the public key (PK) (e.g., the public key created in step 202); ii) Including a timestamp of the key generation process; iii) Adding a unique identifier for the distributed key generation session;
g) Generating zero-knowledge proofs, which may comprise: i) Creating a zero-knowledge proof of successful biometric authentication that demonstrates the validity of the biometric verification without revealing the actual biometric data; ii) Generating a zero-knowledge proof of correct key generation that proves the public key (PK) was generated correctly through the distributed key generation process without revealing the key itself or any sensitive information about the process;
h) Assembling the beacon message, which may comprise: i) Combining the temporary identifier (e.g., the temporary identifier generated in step 204), timestamp, nonce, location commitment, and environmental signature; ii) Incorporating the biometric verification token and the reference to the distributed key generation process; iii) Including the generated zero-knowledge proofs for biometric authentication and correct key generation;
i) Applying one or more data compression techniques to the assembled beacon message to optimize its size for transmission;
j) Generating a digital signature for the entire beacon message using the user's secret key (SK_user) (e.g., the user's secret key created in step 202);
k) Appending the digital signature to the beacon message to ensure its integrity and authenticity. The processor 406 may store the constructed beacon message in the secure storage component 402 and/or memory 404 of the user device 110 for subsequent encryption and transmission.

As used herein, the term “beacon” or “beacon message” may refer to data package that may be generated and broadcast by a device (e.g., user device 110).

As used herein, the term “location commitment” may refer to a cryptographic commitment to the user's location, created by the processor 406 of the user device 110 using cryptographic hash functions (e.g., HMAC-SHA256), based on location data obtained from the one or more sensors and devices of the user device 110.

In an embodiment, the method may further comprise implementing, by the processor 406 of the user device 110, multi-source location determination. This implementation may comprise one or more steps from the following steps: a) Obtaining location data through one or more sources, comprising: i) Acquiring, by the processor 406, GPS coordinates from one or more GPS and/or AGPS components of the input component 414 of the user device 110; ii) Obtaining, by the processor 406, Wi-Fi positioning data from the Wi-Fi interface of the communications interface 408 of the user device 110 for indoor locations; iii) Receiving, by the processor 406 through the communications interface 408, cellular network positioning data as a fallback; b) Implementing, by the processor 406, network-based location determination, comprising: i) Transmitting, by the processor 406 through the communications interface 408 of the user device 110, signals to one or more user devices 110 and/or verifier devices 116; ii) Receiving, by the processor 406 through the communications interface 408, signal strength measurements and time of arrival data from each device (user device 110 and verifier device 116); iii) Executing, by the processor 406, triangulation algorithms on the received measurements to determine the user device's location; iv) Applying, by the processor 406, one or more algorithms (e.g., Kalman filtering algorithms) to the determined location for improved accuracy; c) Executing, by the processor 406, location verification, comprising: i) Implementing, by the processor 406, data structures (e.g., R-tree data structures) in the memory 404 for efficient spatial indexing and quick lookups; ii) Processing, by the processor 406, location comparisons using GPU acceleration for parallel computation; iii) Executing, by the processor 406, probabilistic models to account for location uncertainty; d) Monitoring, by the processor 406, proximity breaches, comprising: i) Executing, by the processor 406, one or more algorithms (e.g., geofencing algorithms) with configurable buffer zones that may be stored in the memory 404; ii) Applying, by the processor 406, one or more algorithms (predictive algorithms) to anticipate potential breaches; iii) Executing, by the processor 406, machine learning models that may be stored in the memory 404 to improve breach detection accuracy over time.

At step 208, the processor 406 of the user device 110 may encrypt the beacon message using one or more attribute-based encryption schemes. This encryption may comprise one or more steps from the following steps:
a) Retrieving the beacon message (e.g., the beacon message constructed in step 706) from the secure storage component 402 and/or memory 404 of the user device 110;
b) Extracting the biometric verification token from the beacon message for separate encryption;
c) Retrieving the public key (PK) and master secret key (MSK) (e.g., public key and master secret key generated in step 202) from the secure storage component 402 and/or memory 404, secure element, Trusted Execution Environment (TEE) and/or Secure Enclave of the user device 110;
d) Defining an attribute set for the main beacon message encryption, which may comprise: i) Temporal attributes (e.g., current date, time of day, day of week); ii) Spatial attributes (e.g., geographic region, proximity to known landmarks); iii) Device-specific attributes (e.g., device type, operating system version); iv) User-specific attributes (e.g., user role, clearance level); v) Biometric verification status attributes (e.g., verification successful, type of biometric used); vi) Key generation attributes (e.g., key freshness, key generation method);
e) Generating one or more attribute-based encryption keys for the main beacon message using the distributed cryptographic setup, which may comprise: i) Utilizing the public key (PK) and master secret key (MSK) in the key generation process; ii) Incorporating one or more attributes of the defined attribute set into the key generation algorithm; iii) Applying one or more key derivation functions (e.g., HKDF-SHA256) to produce the final encryption keys;
f) Encrypting the main beacon message using one or more policy-based encryption methods (e.g., Ciphertext-Policy Attribute-Based Encryption (CP-ABE)), which may comprise: i) Defining an access policy based on the attribute set and required security level; ii) Applying one or more algorithms (e.g., the CP-ABE encryption algorithm) using the generated attribute-based encryption keys and the defined access policy; iii) Producing the encrypted main beacon message ciphertext;
g) Defining one or more restrictive attribute set for the biometric verification token encryption, which may comprise: i) High-level security clearance attributes; ii) Specific verifier role attributes; iii) Temporal attributes with shorter validity periods; iv) Attributes indicating the need for biometric data access;
h) Generating one or more attribute-based encryption keys for the biometric verification token using the distributed cryptographic setup, which may comprise: i) Utilizing the public key (PK) and master secret key (MSK) in the key generation process; ii) Incorporating the one or more restrictive attribute set into the key generation algorithm; iii) Applying one or more key derivation functions (e.g., HKDF-SHA256) to produce the final encryption keys;
i) Encrypting the biometric verification token using one or more policy-based encryption methods with a restrictive access policy, which may comprise: i) Defining a stricter access policy based on the more restrictive attribute set; ii) Applying one or more algorithms (the CP-ABE encryption algorithm) using the generated attribute-based encryption keys and the stricter access policy; iii) Producing the encrypted biometric verification token ciphertext;
j) Combining the encrypted main beacon message and the separately encrypted biometric verification token into a final encrypted beacon package;
k) Generating a cryptographic hash of the final encrypted beacon package using one or more hash functions (e.g., a secure hash function (e.g., SHA3-256));
l) Creating a digital signature of the cryptographic hash using the user's secret key (SK_user) (e.g., user's secret key generated in step 202);
m) Appending the digital signature to the final encrypted beacon package to ensure its integrity and authenticity;
n) Storing the final encrypted beacon package, along with its hash and digital signature, in the secure storage component 402 and/or memory 404 of the user device 110 for subsequent transmission. The processor 406 may also generate and store metadata about the encryption process, including the one or more attribute sets and access policies used, for future reference and auditing purposes.

As used herein, the term “Attribute-Based Encryption (ABE)” may refer to an encryption scheme implemented by the processor 406 to encrypt beacons and proof packages, allowing fine-grained access control based on predefined policies.

At step 210, the processor 406 may record a hash of the one or more encrypted beacon messages and associated metadata in one or more transactions on the blockchain network.

In an embodiment, the method may further comprise recording data on the blockchain network. This recording may comprise one or more steps from the following steps: a) Recording, by the processor 406 of the user device 110, one or more blockchain transactions comprising: i) Generating, by the processor 406, a cryptographic hash of the beacon message using a secure hash function (e.g., SHA-3); ii) Creating, by the processor 406, a blockchain transaction in the memory 404 containing the generated hash and relevant metadata; iii) Transmitting, by the processor 406 through the communications interface 408 of the user device 110, the blockchain transaction to the blockchain network for inclusion in a block; b) Encrypting, by the processor 406, proximity detection data comprising: i) Defining, by the processor 406, encryption attributes based on the nature and sensitivity of the proximity data stored in the memory 404; ii) Generating, by the processor 406, encryption keys using the attribute-based encryption scheme; iii) Encrypting, by the processor 406, the proximity data with the generated encryption keys; c) Transmitting, by the processor 406 through the communications interface 408 of the user device 110, the encrypted proximity detection data to the blockchain network; d) Updating, by the processor 406, both scores comprising: i) Receiving, by the processor 406 through the communications interface 408, the current trust score of the user device 110 and the current reputation score of the user 102 from the blockchain network; ii) Calculating, by the processor 406, an updated trust score of the user device 110 based on the proximity detection and beacon verification data stored in the memory 404; iii) Calculating, by the processor 406, an updated reputation score of the user 102 based on the location compliance data derived from the proximity events; iv) Creating, by the processor 406, new blockchain transactions containing both the calculated trust score of the user device 110 and the reputation score of the user 102; v) Transmitting, by the processor 406 through the communications interface 408, the new blockchain transactions to the blockchain network.

At step 212, the processor 406 of the user device 110 may execute instructions to: Generate, using one or more spread spectrum modulation techniques comprising Chirp Spread Spectrum (CSS), a modulated beacon message from the encrypted beacon message; and transmit, through the communications interface 408 of the user device 110, the modulated beacon message over one or more wireless channels (e.g., over one or more Bluetooth Low Energy (BLE) channels).

At step 214, the processor 406 of the user device 110 may execute instructions to process confirmation of successful beacon broadcast received from one or more verifier devices 116, comprising:
a) Monitoring, through the communications interface 408, for incoming confirmation messages from the one or more verifier devices 116; b) Upon receiving a confirmation message through the communications interface 408: i) Verifying, by the processor 406, the digital signature of the confirmation message using the public key of the sending verifier device 116; ii) Decrypting, by the processor 406, the confirmation message using the attribute-based decryption key stored in the memory 404 and/or the storage component 402; c) Extracting, by the processor 406, from the decrypted confirmation message: i) An acknowledgment of successful beacon broadcast receipt; ii) A verification status of the zero-knowledge proof for key generation; iii) A verification status of the zero-knowledge proof for biometric authentication;
d) Validating, by the processor 406, the extracted information by: i) Comparing the acknowledgment with the most recently broadcast beacon data stored in the memory 404 and/or the storage component 402; ii) Verifying the validation status of both zero-knowledge proofs;
e) Upon successful validation, the processor 406 may execute instructions to: i) Generate a confirmation receipt comprising a timestamp of the received confirmation, the identifiers of the confirming verifier devices 116, and the verification statuses of both zero-knowledge proofs; ii) Sign the confirmation receipt using the user's secret key (SK_user) that may be stored in the memory 404 and/or secure storage component 402; and iii) Store the signed confirmation receipt in the memory 404 and/or the storage component 402;
f) Upon validation failure, the processor 406 may execute instructions to: i) Store the failure details in the memory 404 and/or the secure storage component 402; ii) Generate a re-verification request comprising the original beacon message from the memory 404 and/or the storage component 402, Newly generated zero-knowledge proofs and biometric authentication; iii) Encrypt the re-verification request using the attribute-based encryption scheme; iv) Transmit, through the communications interface 408, the encrypted re-verification request to the verifier devices 116;
g) Updating, by the processor 406 of the user device 110, the local log stored in the memory 404 and/or the storage component 402 of the user device 110 by: i) Storing the verification status of the zero-knowledge proof for key generation; ii) Storing the verification status of the zero-knowledge proof for biometric authentication; iii) Storing the identifiers of the confirming verifier devices 116; h) Upon receiving confirmations from one or more verifier devices 116 through the communications interface 408 of the user device 110, the processor 406 may execute instructions to: i) Aggregate, in the memory 404 and/or the storage component 402 of the user device 110, the confirmation data received from one or more verifier devices 116; ii) Execute a consensus verification algorithm to validate consistency across the received confirmations; iii) Generate and store in the memory 404 and/or the storage component 402 of the user device 110 a summary report of the aggregated confirmations; i) The processor 406 of the user device 110 may execute instructions to: i) Generate, through the communications interface 408 of the user device 110, a smart contract transaction for the blockchain network; ii) Include in the transaction, the successful beacon broadcast verification data, the verified zero-knowledge proofs, and/or the updated trust score calculations of the user device 110;
j) The processor 406 may execute instructions to: i) Generate a notification message comprising the beacon broadcast status, and the verification status of the zero-knowledge proofs; ii) Display the generated notification message through a display component of the user device 110;
k) The processor 406 may execute instructions to prepare for the next broadcast cycle by: i) Resetting timer values and counters that may be stored in the memory 404 and/or the storage component 402; ii) Clearing temporary data from memory 404 and/or the storage component 402; iii) Executing, when required based on predetermined criteria stored in memory 404 and/or the storage component 402, one or more algorithms to generate new zero-knowledge proofs.

At step 216, the processor 406 of the user device 110 may update a local log stored in the secure storage component 402 and/or memory 404, wherein the local log may comprise broadcasted beacons and their corresponding blockchain transaction identifiers.

At step 216A, the processor 406 may implement a secure logging system comprising one or more of the following steps: a) Executing, by the processor 406, a tamper-evident logging mechanism, comprising: i) Generating, by the processor 406, one or more cryptographic hash chains for log entries stored in the secure storage component 402 and/or memory 404; ii) Creating, by the processor 406, digital signatures for each log entry using one or more cryptographic keys stored in the secure storage component 402 and/or memory 404; iii) Executing, by the processor 406, one or more detection and prevention algorithms against log injection attacks; b) Storing log data securely, comprising: i) Storing, by the processor 406, recent log entries to a secure storage area in the secure storage component 402 and/or memory 404; ii) Transmitting, by the processor 406 through the communications interface 408, log hash values to a blockchain network at predetermined intervals; iii) Executing, by the processor 406, secure log rotation and archiving operations on the stored logs; c) Performing integrity verification, comprising: i) Executing, by the processor 406, periodic validation operations on the one or more log hash chains stored in the storage component 402 and/or memory 404; ii) Generating, by the processor 406, secure timestamps for new log entries; iii) Executing, by the processor 406, one or more monitoring algorithms to detect integrity violations and generating alerts through the communications interface 408 when violations are detected.

At step 218, the processor 406 of the user device 110 may execute a local log processing operation in communication with one or more verifier devices 116 through the communications interface 408. The local log processing operation may comprise one or more of the following steps: a) The processor 406 of the user device 110 may initialize one or more authenticated data structures for privacy-preserving log maintenance by: i) Generating a unique log identifier for the current session and storing it in the storage component 402 and/or memory 404; ii) Creating an empty root for one or more cryptographic trees, selected from one or more Merkle trees and Patricia tries, and storing said empty root in at least one of the secure storage component 402, the memory 404, a secure element, a Trusted Execution Environment (TEE), or a Secure Enclave of the user device 110; iii) Executing steps comprising receiving, through the communications interface 408, parameters from one or more verifier devices 116, initializing, based on said received parameters, one or more probabilistic data structures selected from one or more filters (e.g., Bloom filters and Cuckoo filters); iv) Generating cryptographic commitments using one or more schemes (e.g., a Pedersen commitment scheme), wherein said commitments may be generated for the public key (PK) (e.g., the public key (PK) created in step 202), and the master secret key (MSK) (e.g., the master secret key created in step 202); v) Creating a biometric metadata structure in the memory 404 and/or storage component 402 for storing anonymized information about biometric verifications; vi) Transmitting, through the communications interface 408, the initial state of the authenticated data structure to the blockchain network, wherein said initial state may comprise the public key/master secret key commitments, and the biometric metadata structure;
b) Processing received beacons and updating the authenticated data structure, wherein the processor 406 of the user device 110 may execute the one or more of the following steps: i) Receiving, by the processor 406 through the communications interface 408 of the user device 110, one or more encrypted beacons from nearby user devices 110 and/or verifier devices 116; ii) Decrypting, by the processor 406, the received encrypted beacons, wherein the decryption may be done in the Trusted Execution Environment (TEE) using the attribute-based encryption keys (e.g., the attribute-based encryption keys previously generated in step 208); iii) Verifying, by the processor 406, the integrity and authenticity of the decrypted beacons by validating their cryptographic signatures; iv) Storing, by the processor 406, log entries for each verified beacon in the secure storage component 402 and/or memory 404 of the user device 110, wherein each log entry may comprise beacon data, reception timestamp, signal strength indicator (RSSI), frequency, cryptographic proof of inclusion, public key/master secret key commitment references, and/or anonymized biometric verification metadata; v) Updating, by the processor 406, the cryptographic trees that may be stored in the secure storage component 402 and/or memory 404 by incorporating the new log entries, public key/master secret key commitments, and/or biometric metadata; vi) Updating, by the processor 406, the probabilistic data structures that may be stored in the secure storage component 402 and/or memory 404 with identifiers derived from the new log entries, derived public key/master secret key commitments, and/or derived biometric metadata; vii) Computing, by the processor 406, a new root value for the authenticated data structure by combining the updated cryptographic tree roots, incorporating the serialized probabilistic data structures, and storing the computed root value in the secure storage component 402 and/or memory 404;
c) Executing, by the processor 406 of the user device 110, log integrity maintenance and storage management, comprising: i) Storing, by the processor 406, logs in a circular buffer of predetermined size (e.g., 2\hat{ }20 entries) in at least one of the secure storage component 402, the memory 404, the secure element, the Trusted Execution Environment (TEE), or the Secure Enclave of the user device 110; ii) Generating, by the processor 406, a cryptographic proof of deletion for log entries that are overwritten when the circular buffer reaches its size limitation; iii) Executing, by the processor 406, one or more updates to the authenticated data structure that may be stored in the memory 404 and/or storage component 402 to reflect log entry deletions while preserving the integrity of the public key/master secret key commitments and biometric metadata; iv) Transmitting, by the processor 406 through the communications interface 408, the updated root value of the authenticated data structure to the blockchain network at predetermined time intervals;
d) Implementing, by the processor 406 of the user device 110, privacy-preserving proof generation for log validation, comprising: i) Executing, by the processor 406, constraint definition operations comprising receiving, by the processor 406 through the communications interface 408, parameters from one or more verifier devices 116; Generating, by the processor 406, a set of constraints based on the received parameters for: data consistency validation, signal characteristics verification, cryptographic validity checks, biometric verification validity, and correct key usage verification; Storing, by the processor 406, the generated constraints in the memory 404 and/or storage component 402; ii) Generating, by the processor 406, one or more zero-knowledge proof circuits (e.g., zk-SNARK, zk-STARK) comprising executing, by the processor 406, optimization techniques including, but not limited to batching and amortization; Constructing, by the processor 406, zk-SNARK or zk-STARK circuits incorporating proofs of valid biometric authentication, proofs of correct key usage; Storing, by the processor 406, the generated circuits in the memory 404 and/or storage component 402; iii) Executing, by the processor 406, periodic proof generation comprising retrieving, by the processor 406, log data from the memory 404 and/or storage component 402; Generating, by the processor 406, zero-knowledge proofs at predetermined intervals (e.g., 15 minutes) to verify log integrity, log consistency, biometric authentication validity, and key usage correctness; Storing, by the processor 406, the generated proofs in the memory 404 and/or storage component 402; iv) Transmitting proof data comprising retrieving, by the processor 406, the generated zero-knowledge proofs from the memory 404 and/or storage component 402; transmitting, by the processor 406 through the communications interface 408, the retrieved proofs to one or more verifier devices 116 for verification.

e) Responding to audit requests from the blockchain network, wherein the processor 406 of the user device 110 may execute steps comprising: i) Receiving, by the processor 406 through the communications interface 408 of the user device 110, an audit request from one or more verifier devices 116, wherein the audit request may comprise a specific time range and a set of beacon identifiers; ii) Generating, by the processor 406, a proof of inclusion or proof of exclusion for the requested beacons by accessing the authenticated data structure stored in the secure storage component 402 and/or memory 404 of the user device 110; Executing one or more algorithms to generate the proof based on the authenticated data structure; iii) Creating, by the processor 406, a zero-knowledge proof comprising retrieving log data from the secure storage component 402 and/or memory 404; Generating cryptographic proofs demonstrating correct data retrieval without revealing the actual log contents; Incorporating proofs of valid biometric authentication and correct key usage for the relevant sessions; iv) Transmitting, by the processor 406 through the communications interface 408 of the user device 110, the generated proofs to the requesting one or more verifier devices 116.

f) Participating in collaborative log consistency checks, wherein the participation may comprise one or more steps from the following steps: i) Receiving, by the processor 406 through the communications interface 408 of the user device 110, one or more consistency check requests from one or more verifier devices 116 in the blockchain network; ii) Executing, by the processor 406 of the user device 110, one or more multi-party computation protocols through the communications interface 408 to verify cross-device log consistency with other user devices 110 and verifier devices 116, wherein the protocols may verify consistency of public key/master secret key commitments stored in the secure storage component 402 and/or memory 404 of the user device 110, and consistency of biometric verification metadata stored in the secure storage component 402 and/or memory 404 of the user device 110 while maintaining privacy of individual log contents; iii) Generating, by the processor 406 of the user device 110, a consistency proof comprising results from the multi-party computation, proofs of valid biometric authentication stored in the secure storage component 402 and/or memory 404, and proofs of correct key usage across devices stored in the secure storage component 402 and/or memory 404; iv) Transmitting, by the processor 406 through the communications interface 408 of the user device 110, the generated consistency proof to the one or more verifier devices 116 in the blockchain network; v) Storing, by the processor 406 of each verifier device 116, the verified consistency proof in their respective secure storage component 402 and/or memory 404, and subsequently recording a representation of the consistency proof in a new block on the blockchain after successful verification and consensus between the verifier devices 116.

As used herein, the term “secure element” may refer to a tamper-resistant platform within a device (e.g., user device 110) used for securely storing cryptographic keys and executing sensitive operations.

As used herein, the term “Merkle Tree” may refer to a cryptographic data structure used in the local log processing of the device (e.g., user device 110), allowing efficient and secure verification of log entries.

At step 220, the method may comprise generating, by the processor 406 of the user device 110, location proofs through communication with one or more verifier devices 116 in the blockchain network. The generation that may be executed by the processor 406 may comprise one or more of the following steps:

a) Initiating, by the processor 406, a location proof request, comprising: i) Detecting, by the processor 406, a trigger event, wherein the trigger event may comprise at least one of: a request received through the communications interface 408 from a user 102, partner 104, distributor 106, verifier 108, or advertisement service provider 126; an elapsed predefined time interval determined by the processor 406; or a geofence entry/exit event detected by the processor 406 based on location data received from the input component 414; ii) Acquiring current geographical location data by: obtaining GPS/AGPS coordinates from the GPS and/or AGPS components of the input component 414; receiving Wi-Fi positioning data from the Wi-Fi interface of the communications interface 408; and/or receiving cellular triangulation data through the communications interface 408; iii) Collecting sensor data by: receiving accelerometer data from the accelerometer of the input component 414; receiving gyroscope data from the gyroscope of the input component 414; and receiving barometer data from the barometer of the input component 414; iv) Generating and storing, in the memory 404, a unique location proof identifier; v) Transmitting, through the communications interface 408, a location proof request to one or more verifier devices 116, wherein the location proof request may comprise the unique proof identifier;
b) Implementing, by the processor 406 of the user device 110, one or more cryptographic protocols for Proof of Location. This implementation may comprise one or more steps from the following steps: i) Receiving, by the processor 406 through the communications interface 408 of the user device 110, data defining a geographical area of interest and associated validation parameters from one or more verifier devices 116; ii) Computing, by the processor 406, one or more cryptographic commitments to location data obtained from the GPS and/or AGPS components of the input component 414, wherein the processor 406 may execute one or more commitment schemes comprising at least one of: a Pedersen Commitment scheme, or a Hash-based commitment scheme; iii) Generating, by the processor 406, cryptographic proofs by executing one or more proof systems stored in the memory 404, wherein the proof systems may comprise at least one of: Sigma protocols, zk-SNARKs, or Bulletproofs; iv) Verifying, by the processor 406, the generated cryptographic proofs and the obtained location data against the received geographical area data by: executing one or more zero-knowledge proof techniques stored in the memory 404, comprising at least one of: range proofs, or set membership proofs, and storing the verification results in the memory 404;
c) Implementing, by the processor 406 of the user device 110, one or more cryptographic schemes for beacon data aggregation. This implementation may comprise one or more steps from the following steps: i) Retrieving, by the processor 406, relevant beacon data from the secure storage component 402 and/or memory 404 of the user device 110, wherein: the beacon data may comprise one or more encrypted location beacons and their associated metadata; the beacon data may be maintained in an authenticated data structure within the secure storage component 402 and/or memory 404; and the beacon data may include, but not limited to timestamps, location commitments, and cryptographic proofs; ii) Generating, by the processor 406, cryptographic signatures for each retrieved beacon, wherein the generation may comprise: Executing one or more signature scheme algorithms (e.g., BLS signatures, Schnorr signatures) that may be stored in the memory 404; Storing the generated signatures in the secure storage component 402 and/or memory 404; iii) Computing, by the processor 406, an aggregate representation of the signatures and associated data, wherein the computation may comprise: Applying homomorphic properties to the stored signatures; Storing the computed aggregate representation in the secure storage component 402 and/or memory 404; iv) Verifying, by the processor 406, the aggregate representation, wherein the verification may comprise: Executing one or more cryptographic pairing algorithms (e.g., Tate pairing, Weil pairing) that may be stored in the memory 404; Storing the verification results in the secure storage component 402 and/or memory 404; v) Generating, by the processor 406, a zero-knowledge proof for properties of the beacon set, wherein: The zero-knowledge proof enables verification of beacon properties without revealing individual beacons; The generated proof may be stored in the secure storage component 402 and/or memory 404;
d) Constructing, by the processor 406 of the user device 110, a location proof package, wherein the construction may comprise: i) Generating, by the processor 406, a combined data structure in the memory 404 comprising: the location commitment, the zero-knowledge proofs, the aggregated beacon data, and the additional contextual information; ii) Executing, by the processor 406, attribute-based encryption algorithms to encrypt sensitive components of the proof package according to one or more policies received from the one or more verifier devices 116 through the communications interface 408; iii) Computing, by the processor 406, a cryptographic hash of the entire proof package and storing the hash in the memory 404;
e) Submitting, by the processor 406 of the user device 110, the location proof to the blockchain network, wherein the submission may comprise: i) Transmitting, by the processor 406 through the communications interface 408 of the user device 110, the encrypted proof package to one or more verifier devices 116; ii) Generating, by the processor 406, a blockchain transaction containing the proof package hash and metadata; iii) Transmitting, by the processor 406 through the communications interface 408, the generated blockchain transaction to the blockchain network; iv) Monitoring, by the processor 406 through the communications interface 408, for confirmation of the transaction's inclusion in a block; v) Receiving, by the processor 406 through the communications interface 408, confirmation from one or more verifier devices 116 that the verified location proof has been recorded in a new block on the blockchain;
f) Executing, by the processor 406 of the user device 110, collaborative proof verification, comprising: i) Receiving, by the processor 406 through the communications interface 408 of the user device 110, one or more verification queries from one or more verifier devices 116; ii) Generating, by the processor 406, one or more zero-knowledge proofs in response to the verification protocol requirements; iii) Executing, by the processor 406 through the communications interface 408 of the user device 110, one or more multi-party computation protocols with one or more user devices 110 and verifier devices 116 to corroborate the location claim; g) Processing, by the processor 406 of the user device 110, verification results, comprising: i) Receiving, by the processor 406 through the communications interface 408 of the user device 110, verification results from one or more verifier devices 116; ii) Updating, by the processor 406, a local trust score of the user device 110 stored in the secure storage component 402 based on the verification results; iii) Storing, by the processor 406, a record of the verified location proof in at least one of: the secure storage component 402, the memory 404, the secure element, the Trusted Execution Environment (TEE), or the Secure Enclave of the user device 110; iv) Executing, by the processor 406 through the communications interface 408 of the user device 110, one or more smart contracts on the blockchain network based on the verified location proof.
g) Processing, by the processor 406 of the user device 110, verification results, comprising: i) Receiving, by the processor 406 through the communications interface 408 of the user device 110, verification results from one or more verifier devices 116; ii) Updating, by the processor 406, a local trust score of the user device 110 that may be stored in the memory 404 and/or secure storage component 402 based on the verification results; iii) Storing, by the processor 406, a record of the verified location proof in at least one of: the secure storage component 402, the memory 404, the secure element, the Trusted Execution Environment (TEE), or the Secure Enclave of the user device 110; iv) Executing, by the processor 406 through the communications interface 408 of the user device 110, one or more smart contracts on the blockchain network based on the verified location proof.

As used herein, the term “cryptographic commitment” may refer to a cryptographic primitive used to create the location commitment, typically implemented using a cryptographic function (e.g., HMAC-SHA256) based on location data. This function ensures the data's integrity and authenticity without revealing it until required.

As used herein, the term “proof of location” may refer to a cryptographic proof generated by the processor 406 of the user device 110, demonstrating the user's presence at a specific location without revealing exact coordinates.

In an embodiment, the method may further comprise implementing, by the processor 406 of the user device 110, one or more breach response actions. This implementation may comprise one or more steps from the following steps: a) Executing, by the processor 406, proximity breach response procedures, comprising: i) Transmitting, by the processor 406 through the communications interface 408 of the user device 110, encrypted alert messages to the user 102 and/or authority systems' API using secure communication protocols; ii) Recording, by the processor 406, the breach event data in the secure storage component 402 and/or memory 404 of the user device 110 according to the secure logging system (e.g., the secure logging system implemented in step 216A); iii) Computing, by the processor 406, an updated trust score of the user device 110 based on device verification parameters and an updated reputation score of the user 102 based on predetermined breach severity parameters stored in the memory 404; b) Implementing, by the processor 406, a breach prioritization system, comprising: i) Assigning, by the processor 406, numerical severity levels to restricted area types based on predetermined criteria stored in the memory 404; ii) Maintaining, by the processor 406 in the memory 404, a priority queue data structure for processing multiple breach events; iii) Executing, by the processor 406, parallel processing routines for concurrent breach response handling; c) Establishing, by the processor 406, secure communication protocols, comprising: i) Implementing, by the processor 406, end-to-end encryption algorithms for all notification messages transmitted through the communications interface 408; ii) Executing, by the processor 406, certificate pinning protocols stored in the memory 404 to prevent man-in-the-middle attacks; iii) Maintaining, by the processor 406 in the memory 404, a message queue for offline message storage and forwarding when network connectivity is restored through the communications interface 408.

At step 222, the processor 406 of the user device 110 may execute a challenge-response protocol through the communications interface 408 to establish communication with one or more verifier devices 116 in the blockchain network. The protocol may be executed by the processor 406 and may comprise one or more of the following steps: a) Preparing for challenge participation, comprising: i) Transmitting, by the processor 406 through the communications interface 408 of the user device 110, a registration message to one or more verifier devices 116 to indicate availability for challenges; ii) Receiving, by the processor 406 through the communications interface 408 of the user device 110, challenge participation parameters and cryptographic setup information from the one or more verifier devices 116; iii) Creating, by the processor 406, a challenge handling environment, wherein the challenge handling environment may be within the Trusted Execution Environment (TEE) and/or Secure Enclave of the user device 110;
b) Processing challenges, comprising: i) Monitoring, by the processor 406 through the communications interface 408 of the user device 110, for incoming encrypted challenges from the one or more verifier devices 116; ii) Receiving, by the processor 406 through the communications interface 408 of the user device 110, an encrypted challenge generated using one or more distributed cryptographic schemes; iii) Executing, by the processor 406, cryptographic signature verification algorithms to verify the authenticity and integrity of the received challenge; iv) Decrypting, by the processor 406, the received challenge using cryptographic keys stored in the Trusted Execution Environment (TEE) and/or Secure Enclave of the user device 110; v) Analyzing, by the processor 406, the decrypted challenge to identify its type from among: Traditional challenges requiring location proofs or environmental data; Biometric challenges requiring real-time biometric data capture through the input component 414; and Key-based challenges requiring proof of possession of cryptographic keys stored in the TEE and/or Secure Enclave;
c) Generating, by the processor 406 of the user device 110, one or more challenge responses. This generation may comprise one or more steps from the following steps:
i) Processing challenge parameters: Interpreting, by the processor 406, the challenge requirements and parameters received through the communications interface 408; ii) For traditional challenges: Collecting, by the processor 406, sensor data from one or more sensors and/or devices of the input component 414 of the user device 110; Retrieving, by the processor 406, log data from the secure storage component 402 and/or memory 404 of the user device 110; Generating, by the processor 406, a response message comprising: One or more cryptographic representations of the decrypted challenge, and Transmission parameters for the communications interface 408; iii) For biometric challenges: Displaying, through a display component of the user device 110, a prompt requesting biometric input from the user 102; Capturing, by one or more sensors and/or devices of the input component 414, real-time biometric data; Retrieving, by the processor 406, stored biometric templates from the secure storage component 402 and/or memory 404 within the TEE or Secure Enclave; Verifying, by the processor 406 within the TEE or Secure Enclave, the captured biometric data against the retrieved stored templates; Generating, by the processor 406, a cryptographic proof of real-time biometric verification; iv) For key-based challenges: Retrieving, by the processor 406, cryptographic keys from the secure storage component 402 and/or memory 404 within the TEE or Secure Enclave; Generating, by the processor 406, a cryptographic proof of correct key usage that excludes the actual key data; v) Computing cryptographic proofs: Generating, by the processor 406, one or more cryptographic proofs demonstrating correct interpretation of the challenge and valid response generation according to challenge parameters.
d) Implementing, by the processor 406 of the user device 110, one or more cryptographic proof systems for response verification, comprising: i) Executing, by the processor 406, a selection algorithm to identify an appropriate zero-knowledge proof system from memory 404 based on the challenge type, wherein the zero-knowledge proof system may be selected from zk-SNARKs, zk-STARKs, or Bulletproofs; ii) Generating, by the processor 406, a zero-knowledge proof that may demonstrate correct challenge solving without revealing sensitive information stored in the secure storage component 402; Successful real-time biometric verification based on data received from the input component 414 for biometric challenges; Correct usage of the cryptographic keys stored in the secure storage component 402 for key-based challenges; iii) Creating, by the processor 406, a verifiable response package by combining the response message and zero-knowledge proof in the memory 404;
e) Executing, by the processor 406 of the user device 110, challenge response transmission, comprising: i) Encrypting, by the processor 406, the verifiable response package using encryption keys derived from the challenge parameters stored in the memory 404; ii) Controlling, by the processor 406, the communications interface 408 to broadcast the encrypted response message according to specified transmission parameters stored in the memory 404, wherein the transmission parameters comprise frequency, time slot, and power level; iii) Transmitting, by the processor 406 through the communications interface 408 of the user device 110, the encrypted verifiable response package to one or more verifier devices 116 for verification;
f) Executing, by the processor 406 of the user device 110, response verification and feedback handling, comprising: i) Receiving, by the processor 406 through the communications interface 408 of the user device 110, verification results from the one or more verifier devices 116; ii) Executing, by the processor 406, one or more interactive verification protocols for additional verification rounds when required; iii) Computing, by the processor 406, an updated local trust score for the user device 110 based on the challenge-response outcome; iv) Storing, by the processor 406, a log of the challenge-response interaction in at least one of: the secure storage component 402 of the user device 110, the memory 404 of the user device 110, the Trusted Execution Environment (TEE) of the user device 110, or the Secure Enclave of the user device 110; g) Executing, by the processor 406 of the user device 110, network security operations, comprising: i) Transmitting, by the processor 406 through the communications interface 408 of the user device 110, collaborative challenge generation data to other blockchain network participants, wherein the blockchain network participants may comprise at least one of: one or more verifier devices 116, or one or more user devices 110; ii) Computing, by the processor 406, partial signatures and cryptographic shares for distributed challenge creation; iii) Executing, by the processor 406, threshold signature protocols through the communications interface 408 to collectively sign network-wide challenge-response records, and verify network-wide challenge-response records.
g) Contributing, by the processor 406 of the user device 110, to network security, said contributing comprising:
i) Generating, by the processor 406, collaborative challenges for blockchain network participants, comprising: Creating, by the processor 406, challenge parameters based on predefined security criteria stored in the memory 404; Transmitting, by the processor 406 through the communications interface 408, the generated challenges to one or more verifier devices 116 and/or user devices 110; Receiving, by the processor 406 through the communications interface 408, challenge confirmations from the network participants; ii) Managing cryptographic shares, comprising: Generating, by the processor 406, partial digital signatures using cryptographic keys stored in the secure storage component 402; Computing, by the processor 406, cryptographic shares for distributed challenge creation; Storing, by the processor 406, the generated shares in the secure storage component 402; Transmitting, by the processor 406 through the communications interface 408, the partial signatures and shares to authorized network participants; iii) Executing threshold signature operations, comprising: Receiving, by the processor 406 through the communications interface 408, signature shares from network participants; Verifying, by the processor 406, the received signature shares using cryptographic keys stored in the secure storage component 402; Computing, by the processor 406, collective signatures for challenge-response records; Storing, by the processor 406, the verified challenge-response records in the memory 404; Transmitting, by the processor 406 through the communications interface 408, the collective signatures to the blockchain network.

At step 224, the processor 406 of the user device 110 may execute a consensus and decision mechanism in cooperation with one or more verifier devices 116 and/or user devices 110 in the blockchain network. The execution of this mechanism by the processor 406 may comprise one or more of the following steps:
a) Initializing consensus participation, wherein the processor 406 may: i) Transmit, through the communications interface 408 of the user device 110, a registration request to participate as a consensus participant to the one or more verifier devices 116 and/or user devices 110 in the blockchain network; ii) Control the communications interface 408 to receive current consensus parameters from the one or more verifier devices 116, and cryptographic setup information from the one or more verifier devices 116; iii) Execute one or more cryptographic signature verification algorithms to verify the authenticity of the received consensus parameters; iv) Retrieves, from at least one of the secure storage component 402, memory 404, Trusted Execution Environment (TEE), and Secure Enclave of the user device 110: the key generation integrity proof (e.g., key generation integrity proof generated in step 202), the most recent biometric authentication data and its associated timestamp, and historical records of biometric verifications and key usage;
b) Executing one or more fault-tolerant consensus algorithms with privacy preservation, wherein the processor 406 may: i) Control the communications interface 408 to receive proposals for new blocks from one or more verifier devices 116 and state transitions from one or more verifier devices 116; ii) Verify the validity of received proposals by: executing one or more algorithms (e.g., integrity verification algorithms) on the key generation process of the proposing device, and analyzing the strength and recency of biometric authentication of the proposing device; iii) Execute a multi-phase consensus protocol by: generating one or more proposals that may incorporate: one or more proofs of key generation integrity, and one or more proofs of recent biometric authentication; validating received proposals by analyzing: one or more key integrity factors, and biometric factor; performing local aggregation of validations by: applying weights based on proposers' key credentials, and applying weights based on proposers' biometric credentials; executing one or more commitment reveal operations that may include but not limited to: one or more cryptographic proofs of proper key usage, and cryptographic proofs of biometric verification; iv) Implement privacy-preserving protocols by: executing one or more algorithms (e.g., view change algorithms); participating in secure multi-party computations with the one or more verifier devices 116; v) Control the communications interface 408 to transmit: encrypted votes for consensus decisions; encrypted shares for consensus decisions; and accompanying zero-knowledge proofs that demonstrate valid key usage and recent biometric authentication;
c) Implementing, by the processor 406 of the user device 110, one or more distributed machine learning approaches for continual system improvement. This implementation may comprise: i) Receiving model architecture data, comprising: Receiving, by the processor 406 through the communications interface 408 of the user device 110, a shared model architecture for anomaly detection from the one or more verifier devices 116; Storing, by the processor 406, the received model architecture in the memory 404 of the user device 110; ii) Executing local model computations, comprising: Retrieving, by the processor 406, device data from the memory 404, wherein the device data may comprise Key management data comprising key usage patterns, key generation timestamps, and key validation records; Biometric verification patterns comprising verification success rates, timing data, and quality metrics; Loading, by the processor 406, the shared model from the memory 404; Executing, by the processor 406, local computations using the shared model on the retrieved device data; Storing, by the processor 406, the computation results in the memory 404; iii) Implementing privacy protection, comprising: Retrieving, by the processor 406, the computation results from the memory 404; Applying, by the processor 406, one or more privacy techniques (e.g., differential privacy techniques) to the computation results, wherein the techniques may comprise: Adding calibrated noise to numerical features; Implementing anonymity (e.g., k-anonymity) for categorical data; Applying diversity principles (e.g., 1-diversity principles) to sensitive attributes; Storing, by the processor 406, the privacy-protected results in the secure storage component 402 of the user device 110; iv) Transmitting model updates, comprising: Retrieving, by the processor 406, the privacy-protected results from the secure storage component 402; Executing, by the processor 406, one or more secure aggregation protocols on the privacy-protected results; Transmitting, by the processor 406 through the communications interface 408 of the user device 110, the aggregated privacy-preserving model updates to the one or more verifier devices 116; v) Participating in federated learning, comprising: Receiving, by the processor 406 through the communications interface 408, model updates from the one or more verifier devices 116; Executing, by the processor 406, one or more algorithms (e.g., federated averaging algorithms) on the received updates; Updating, by the processor 406, the local model stored in the memory 404 based on the averaged results; Validating, by the processor 406, the updated model's performance using a validation dataset stored in the memory 404; Storing, by the processor 406, the validated updated model in the memory 404 for subsequent use.
d) Participating, by the processor 406 of the user device 110, in one or more cryptographic trust systems. This participation may comprise: i) Receiving evaluation criteria, comprising: Receiving, by the processor 406 through the communications interface 408 of the user device 110, a set of evaluation criteria from the one or more verifier devices 116; Storing, by the processor 406, the received criteria in the secure storage component 402 and/or memory 404 of the user device 110, wherein the criteria may include but not limited to: Metrics for measuring consistency and integrity of cryptographic key generation and usage patterns, Parameters for evaluating frequency and success rates of biometric verifications performed using the input component 414 of the user device 110 ii) Managing action history, comprising: Initializing, by the processor 406, one or more cryptographic data structures in the secure storage component 402 and/or memory 404, wherein the data structures may comprise Merkle trees and vector commitments; Accumulating, by the processor 406, in the initialized data structures: one or more records of cryptographic key generation events executed in the Trusted Execution Environment (TEE) of the user device 110, one or more Logs of subsequent key usage patterns, Documentation of biometric verification attempts captured through the input component 414, and Records of verification outcomes processed by the processor 406 iii) Generating trust proofs, comprising: Executing, by the processor 406, one or more zero-knowledge proof systems to generate cryptographic proofs of the user device's 110 trust score, wherein the proofs may demonstrate: Adherence to proper key management practices as defined by the stored evaluation criteria, and consistent patterns of successful biometric verifications; Storing, by the processor 406, the generated proofs in the secure storage component 402 and/or memory 404 iv) Transmitting verification data, comprising: Retrieving, by the processor 406, the generated cryptographic proofs from the secure storage component 402 and/or memory 404 Transmitting, by the processor 406 through the communications interface 408 of the user device 110, the retrieved proofs to the one or more verifier devices 116; v) Processing trust score updates, comprising: Receiving, by the processor 406 through the communications interface 408 of the user device 110: Updated trust score data from the one or more verifier devices 116; New consensus participation parameters after each consensus round; Storing, by the processor 406, the received data in the secure storage component 402 and/or memory 404; vi) Updating local trust score of the user device 110, comprising: Retrieving, by the processor 406, from the secure storage component 402 and/or memory 404: current trust score of the user device 110, key management performance metrics, and biometric verification statistics; Calculating, by the processor 406, an updated trust score of the user device 110 based on: the received trust score data, key management performance metrics, and biometric verification statistics, Storing, by the processor 406, the updated trust score of the user device 110 in the secure storage component 402 and/or memory 404; vii) Adjusting consensus participation, comprising: Retrieving, by the processor 406, from the secure storage component 402 and/or memory 404: current consensus parameters, and updated trust score of the user device 110; Calculating, by the processor 406, new consensus participation levels based on the received consensus parameters, and the updated trust score of the user device 110; Implementing, by the processor 406, the calculated participation levels for subsequent consensus rounds; Storing, by the processor 406, the new participation levels in the secure storage component 402 and/or memory 404.
e) Executing, by the processor 406 of the user device 110, network governance operations, comprising: i) Receiving, by the processor 406 through the communications interface 408 of the user device 110, proposals for protocol upgrades or parameter changes, wherein said proposals may comprise: modifications to key generation and management protocols stored in the memory 404; modifications to biometric verification requirements and processes stored in the memory 404; ii) Executing, by the processor 406, one or more cryptographic verification algorithms to verify the authenticity and integrity of the received proposals; iii) Executing, by the processor 406, one or more impact analysis algorithms that may be stored in the memory 404 to evaluate effects of proposed changes on: key security protocols that may be stored in the secure storage component 402; biometric verification processes that may be stored in the memory 404; iv) Generating, by the processor 406, cryptographically signed votes on proposals, wherein the processor 406 may apply weighting factors based on trust scores of the one or more user devices 110 stored in the memory 404; v) Executing, by the processor 406 through the communications interface 408, privacy-preserving voting protocols stored in the memory 404; vi) Executing, by the processor 406, threshold signature schemes stored in the memory 404 for collective decision-making, wherein the processor 406 may adjust participation thresholds based on key management and biometric factors stored in the memory 404.

At step 226, the processor 406 of the verifier device 116 may execute instructions to implement a decentralized validation system for transaction and location data verification, wherein said execution may comprise one or more of the following operations:
a) Executing, by the processor 406 of the verifier device 116, initialization operations for the decentralized validation system, comprising: i) Generating, by the processor 406, a unique cryptographic identifier using one or more cryptographic algorithms stored in the memory 404 of the verifier device 116; ii) Transmitting, by the processor 406 through the communications interface 408, registration data to one or more verifier devices 116 in the blockchain network to register as a validator; iii) Receiving, by the processor 406 through the communications interface 408, network parameters and validation rules from existing verifier devices 116, comprising: criteria for evaluating biometric authentication proofs stored in the memory 404; standards for verifying key generation and usage proofs stored in the memory 404; iv) Executing, by the processor 406, one or more cryptographic verification algorithms stored in the memory 404 to verify the authenticity of received parameters using cryptographic signatures.
b) Maintaining blockchain state and participating in consensus, wherein the processor 406 of the verifier device 116 may execute operations comprising: i) Receiving, by the processor 406 through the communications interface 408 of the verifier device 116, blockchain data from one or more other verifier devices 116; ii) Verifying, by the processor 406, the received blockchain data by: Validating cryptographic signatures in the received blockchain data; Verifying proof-of-work or proof-of-stake according to consensus rules stored in the memory 404; Confirming block header integrity; iii) Storing, by the processor 406, in the memory 404 of the verifier device 116: A local copy of the verified blockchain data; Associated state information; Block headers; Transaction indexes; iv) Validating, by the processor 406, new blockchain data by: Verifying biometric authentication proofs included in transactions against predetermined validation rules stored in the memory 404; Validating key generation proofs using cryptographic verification algorithms; Verifying state transition proofs according to smart contract rules stored in the memory 404; v) Transmitting, by the processor 406 through the communications interface 408 of the verifier device 116: Validated transactions to other verifier devices 116 in the blockchain network; Validated blocks with accompanying proof data; Updated state information;
b) Maintaining blockchain state and participating in consensus, comprising: i) Receiving, by the processor 406 through the communications interface 408 of the verifier device 116, blockchain state data; ii) Verifying, by the processor 406, the received blockchain state data; iii) Executing, by the processor 406, consensus mechanism operations according to one or more predetermined protocols (e.g., Proof-of-Stake protocols and Delegated Proof-of-Stake protocols; iv) Storing, in the memory 404 of the verifier device 116, a local copy of the blockchain and associated state data; v) Validating, by the processor 406, newly received transactions and blocks, wherein the validation may comprise: Verifying biometric authentication proofs included in the transactions; Validating key generation and usage proofs associated with state transitions; vi) Transmitting, by the processor 406 through the communications interface 408 of the verifier device 116, the validated transactions and blocks to one or more additional verifier devices 116 in the blockchain network;
c) Executing location-based consensus and validation operations, comprising: i) Retrieving, by the processor 406, cryptographic tokens from the secure storage component 402 or the Trusted Execution Environment (TEE) of the verifier device 116; ii) Allocating, by the processor 406, a predetermined amount of the retrieved cryptographic tokens as stake; iii) Receiving, by the processor 406 through the communications interface 408, validation task assignments based on the allocated token amount, and historical performance metrics stored in the memory 404; iv) Executing, by the processor 406, cryptographic verification of received location proofs, comprising verifying integrity and authenticity of biometric authentication proofs; validating correctness of key generation proofs; confirming successful biometric verification and proper key usage for high-stakes operations; v) Generating, by the processor 406, data structures containing validated location proofs; verified biometric authentication proofs; and validated key usage proofs; vi) Transmitting, by the processor 406 through the communications interface 408, the generated data structures to the blockchain network; vii) Receiving, by the processor 406 through the communications interface 408, proposed data structures from one or more additional verifier devices 116; viii) Verifying, by the processor 406, the received proposed data structures; ix) Participating, by the processor 406 through the communications interface 408, in a fault-tolerant voting mechanism for consensus determination; x) Retrieving, by the processor 406 from the memory 404, smart contract code triggered by verified location proofs; xi) Executing, by the processor 406, the retrieved smart contract code with additional validation checks for biometric and key usage validity.
d) Executing, by the processor 406 of the verifier device 116, token distribution and incentive mechanisms, comprising: i) Receiving, by the processor 406 through the communications interface 408 of the verifier device 116, token rewards from the blockchain network in response to successful validation of location proofs, biometric authentication proofs, and key generation proofs; ii) Computing, by the processor 406, reward amounts by executing one or more algorithms (e.g., reward calculation algorithms) stored in the memory 404, wherein the one or more algorithms may evaluate base reward values stored in the memory 404, quantity of allocated tokens, accuracy scores of validations, computational complexity of validation tasks, criticality ratings of biometric and key verifications; iii) Validating, by the processor 406, the received rewards by retrieving cryptographic proofs from the memory 404, and executing one or more cryptographic verification algorithms on the received rewards; iv) Managing token operations, comprising storing, by the processor 406, the token balance in the secure storage component 402, and executing, by the processor 406, token staking operations through the communications interface 408;
e) Executing, by the processor 406 of the verifier device 116, security and penalty enforcement operations, comprising: i) Analyzing, by the processor 406, network communications received through the communications interface 408 to detect malicious behavior patterns stored in the memory 404, unauthorized biometric authentication attempts, and cryptographic key misuse patterns; ii) Executing, by the processor 406, validation consistency checks by analyzing proposed data structures against validation rules stored in the memory 404, verifying biometric proof consistency, and validating key usage claims; iii) Transmitting, by the processor 406 through the communications interface 408, detected malicious behavior reports to other verifier devices 116 in the network; iv) Executing, by the processor 406, token adjustment operations comprising retrieving penalty rules from the memory 404, calculating penalty amounts based on verification failures, and updating token allocations in the secure storage component 402; v) Updating, by the processor 406, the validator status in the secure storage component 402 based on received status notifications; vi) Executing, by the processor 406, penalty protocols comprising retrieving protocol rules from the memory 404, transmitting penalty execution messages through the communications interface 408, and updating local records in the secure storage component 402.

At step 228, the processor 406 of the user device 110 may execute a user incentivization mechanism for encouraging and rewarding user participation in location data sharing, biometric data quality maintenance, and proper key management. The execution by the processor 406 may comprise one or more of the following steps: a) Executing, by the processor 406, a privacy-preserving data tracking system, comprising: i) Configuring, by the processor 406, data collection parameters in the memory 404 based on user preferences and network requirements; ii) Acquiring, by the processor 406, location data from one or more GPS and/or AGPS components of the input component 414, Wi-Fi positioning data from the Wi-Fi interface of the communications interface 408, and cellular triangulation data from the communications interface 408; iii) Acquiring, by the processor 406, contextual sensor data from one or more sensors of the input component 414; iv) Recording, by the processor 406 in the memory 404, metadata about biometric authentication events and key usage instances, wherein the processor 406 excludes storage of raw biometric data and actual keys; v) Processing, by the processor 406, the collected data to remove personally identifiable information; vi) Executing, by the processor 406, privacy-preserving algorithms comprising differential privacy and k-anonymity on the processed data, including biometric metadata and key usage data; vii) Generating, by the processor 406, cryptographic commitments for the anonymized data, biometric metadata, and key usage statistics; viii) Storing, by the processor 406 in the secure storage component 402 and/or memory 404, secure element, Trusted Execution Environment (TEE) and/or Secure Enclave of the user device 110, the anonymized data, biometric metadata, key usage statistics, and associated cryptographic commitments; b) Managing, by the processor 406, user privacy preferences, comprising: i) Displaying, by the processor 406 through a display component of the user device 110, a user-controlled privacy management interface; ii) Receiving, by the processor 406 through the input component 414 of the user device 110, user inputs specifying data sharing preferences, wherein the preferences comprise frequency, precision, and data types for location, biometric, and key usage data; iii) Executing, by the processor 406, time-based and location-based rules for automatic privacy adjustments based on:—Time data received from a timekeeping component of the user device 110—Location data acquired from the GPS and/or AGPS components of the input component 414—Wi-Fi positioning data from the Wi-Fi interface of the communications interface 408—Cellular triangulation data from the communications interface 408; iv) Generating, by the processor 406, cryptographic proofs demonstrating adherence to user-defined privacy policies for the collected data; v) Storing, by the processor 406 in the secure storage component 402 and/or memory 404, secure element, Trusted Execution Environment (TEE) and/or Secure Enclave of the user device 110, encrypted records of:—User privacy preferences-Policy adherence proofs

At step 228, the processor 406 of the user device 110 may execute a user incentivization mechanism for encouraging and rewarding user participation in location data sharing, biometric data quality maintenance, and proper key management. The execution by the processor 406 may comprise one or more of the following steps:
a) Executing, by the processor 406, a privacy-preserving data tracking system, comprising: i) Configuring, by the processor 406, data collection parameters in the memory 404 based on user preferences and network requirements; ii) Acquiring, by the processor 406, location data from one or more GPS and/or AGPS components of the input component 414, Wi-Fi positioning data from the Wi-Fi interface of the communications interface 408, and cellular triangulation data from the communications interface 408; iii) Acquiring, by the processor 406, contextual sensor data from one or more sensors of the input component 414; iv) Recording, by the processor 406 in the memory 404, metadata about biometric authentication events and key usage instances, wherein the processor 406 may exclude storage of raw biometric data and actual keys; v) Processing, by the processor 406, the collected data to remove personally identifiable information; vi) Executing, by the processor 406, one or more privacy-preserving algorithms that may include but not limited to differential privacy and k-anonymity on the processed data, including but not limited to biometric metadata and key usage data; vii) Generating, by the processor 406, cryptographic commitments for the anonymized data, biometric metadata, and key usage statistics; viii) Storing, by the processor 406 in the secure storage component 402 and/or memory 404, secure element, Trusted Execution Environment (TEE) and/or Secure Enclave of the user device 110, the anonymized data, biometric metadata, key usage statistics, and associated cryptographic commitments;
b) Managing, by the processor 406, user privacy preferences, comprising: i) Displaying, by the processor 406 through a display component of the user device 110, a user-controlled privacy management interface; ii) Receiving, by the processor 406 through the input component 414 of the user device 110, user inputs specifying data sharing preferences, wherein the preferences comprise frequency, precision, and data types for location, biometric, and key usage data; iii) Executing, by the processor 406, time-based and location-based rules for automatic privacy adjustments based on: Time data received from a timekeeping component of the user device 110; Location data acquired from the GPS and/or AGPS components of the input component 414; Wi-Fi positioning data from the Wi-Fi interface of the communications interface 408; Cellular triangulation data from the communications interface 408; iv) Generating, by the processor 406, cryptographic proofs demonstrating adherence to user-defined privacy policies for the collected data; v) Storing, by the processor 406 in the secure storage component 402 and/or memory 404, secure element, Trusted Execution Environment (TEE) and/or Secure Enclave of the user device 110, encrypted records of user privacy preferences, and policy adherence proofs.
c) Executing, by the processor 406 of the user device 110, participation in the incentive distribution system, comprising: i) Transmitting, by the processor 406 through the communications interface 408 of the user device 110, a registration request to one or more verifier devices 116 in the blockchain network for participation in the incentive program; ii) Receiving, by the processor 406 through the communications interface 408 of the user device 110, incentive parameters and validation rules from the one or more verifier devices 116, wherein the parameters and rules include criteria for biometric data quality and cryptographic key management; iii) Transmitting, by the processor 406 through the communications interface 408 of the user device 110, encrypted data packets to the one or more verifier devices 116, wherein the encrypted data packets may comprise: anonymized location data stored in the memory 404, one or more biometric quality metrics generated by the processor 406, one or more cryptographic key usage statistics stored in the secure storage component 402, and associated cryptographic proofs generated by the processor 406; iv) Generating, by the processor 406, zero-knowledge proofs within the Trusted Execution Environment (TEE) of the user device 110 to verify: data submission integrity, biometric data quality compliance, and cryptographic key management adherence; v) Validating, by the processor 406, received reward calculations using one or more cryptographic verification algorithms executed within the TEE;
d) Executing, by the processor 406 of the user device 110, reward management operations, comprising: i) Receiving, by the processor 406 through the communications interface 408, encrypted reward tokens from the one or more verifier devices 116; ii) Verifying, by the processor 406 within the TEE, the authenticity and integrity of the received reward tokens using one or more cryptographic validation algorithms; iii) Storing, by the processor 406, validated reward tokens in a secure digital wallet that may be implemented within the secure storage component 402 of the user device 110; iv) Executing, by the processor 406 through the communications interface 408, token lockup protocols with the blockchain network according to predefined vesting schedules stored in the memory 404; v) Processing, by the processor 406, smart contract transactions through the communications interface 408 for reward distribution based on contract parameters that may be stored in the memory 404; vi) Computing, by the processor 406, additional reward allocations based on: biometric data quality metrics that may be stored in the memory 404, and cryptographic key usage patterns monitored by the processor 406 and may be stored in the secure storage component 402;
e) Enhancing long-term engagement and data quality, comprising: i) Implementing, by the processor 406 of the user device 110, a local trust system in the secure storage component 402 and/or memory 404 that tracks: data sharing consistency metrics, biometric data quality metrics, and key management practice metrics; ii) Computing, by the processor 406, a user engagement score that may be stored in the secure storage component 402 and/or memory 404, based on: one or more data sharing frequency metrics, data quality measurements, privacy policy adherence metrics, biometric authentication success rates, and key usage pattern analytics; iii) Generating, by the processor 406, and storing in the secure storage component 402 and/or memory 404: one or more periodic network contribution reports, reward calculation reports, and improvement recommendation reports; iv) Displaying, by the processor 406 through a display component of the user device 110: data quality improvement suggestions, biometric authentication enhancement recommendations, and key management best practices; v) Executing, by the processor 406, a gamification system stored in the secure storage component 402 and/or memory 404, comprising: achievement tracking mechanisms, milestone progress monitoring, and participation metrics analysis;
f) Executing secure data monetization operations, comprising: i) Receiving, by the processor 406 through the communications interface 408 of the user device 110, data purchase requests from one or more authorized third parties via the blockchain network; ii) Displaying, by the processor 406 through a display component of the user device 110: anonymized purchase request summaries, biometric metadata usage proposals, and key usage statistics summaries; iii) Capturing, by the processor 406 through the input component 414 of the user device 110, user consent inputs for data sharing transactions; iv) Generating and storing, by the processor 406 in the secure storage component 402 and/or memory 404: access control policies for approved sharing, enhanced controls for biometric data, and policies for key-related data (e.g., stricter policies); v) Encrypting, by the processor 406, the approved data using one or more algorithms (e.g., attribute-based encryption schemes) executed within the secure storage component 402 and/or memory 404; vi) Transmitting, by the processor 406 through the communications interface 408: the encrypted data packages, and associated access control policies to one or more verifier devices 116 for secure distribution to authorized purchasers; vii) Verifying, by the processor 406: smart contract execution status, and reward distribution completeness through data received via the communications interface 408.
g) Implementing, by the processor 406 of the user device 110, cross-platform reward interoperability, comprising: i) Establishing, by the processor 406 through the communications interface 408, connections with multiple blockchain networks and reward systems; ii) Executing, by the processor 406, cross-chain transactions stored in the secure storage component 402 and/or memory 404 to convert or transfer rewards between different platforms; iii) Computing, by the processor 406, zero-knowledge proofs of reward ownership and transfer authorization using one or more cryptographic algorithms stored in the secure storage component 402 and/or memory 404; iv) Executing, by the processor 406 through the communications interface 408, one or more protocols (e.g., atomic swap protocols) for trustless reward exchange with other blockchain networks; v) Storing and updating, by the processor 406 in the secure storage component 402 and/or memory 404, a unified reward balance across multiple platforms;
h) Contributing, by the processor 406 of the user device 110, to collective data insights, comprising: i) Executing, by the processor 406 through the communications interface 408, one or more computation protocols (e.g., secure multi-party computation protocols) with other devices to generate aggregate statistics on: location data obtained from the input component 414, biometric authentication performance data stored in the secure storage component 402 and/or memory 404, and key usage patterns stored in the secure storage component 402 and/or memory 404; ii) Processing, by the processor 406, local data using one or more algorithms (e.g., one or more privacy-preserving machine learning algorithms) that may be stored in the secure storage component 402 and/or memory 404 to contribute to global security and user experience models; iii) Computing, by the processor 406, differential privacy guarantees for contributed insights using one or more algorithms that may be stored in the secure storage component 402 and/or memory 404; iv) Executing, by the processor 406, one or more zero-knowledge proof algorithms that may be stored in the secure storage component 402 and/or memory 404 to verify the integrity and fairness of collective data usage; v) Receiving, by the processor 406 through the communications interface 408, anonymized insights derived from collective data; vi) Displaying, by the processor 406 through a display component of the user device 110, the received anonymized insights including benchmarks for biometric data quality and key management practices.

In an embodiment, a method for implementing an improved location verification system is provided, the method comprising:
a) Implementing, by a processor 406 of the user device 110, a local data storage system, comprising: i) Initializing, by the processor 406, a circular buffer in the secure storage component 402 and/or memory 404 of the user device 110 for storing location data comprising: GPS coordinates (e.g., latitude, longitude, altitude) with timestamp obtained from the GPS and/or AGPS components of the input component 414; Accuracy estimates computed by the processor 406 for each coordinate; Location data source identifiers indicating whether data was obtained from the GPS component, Wi-Fi interface, or cellular triangulation; Device orientation data (e.g., pitch, roll, yaw) obtained from the accelerometer and gyroscope components of the input component 414; Velocity and heading information computed by the processor 406; ii) Creating, by the processor 406 in the memory 404, one or more data structures (e.g., a Bloom filter data structure) configured with: A predetermined false positive rate (e.g., false positive rate of 0.1%); Storage capacity for one or more location elements (e.g., 10,000 location elements); iii) Implementing, by the processor 406, a tiered storage system by: Storing in the secure storage component 402 and/or memory 404, location data (e.g., recent location data) for a first predetermined time period (e.g., the past 24 hours) at predetermined intervals (e.g., 1-minute intervals); Generating and storing in the secure storage component 402 and/or memory 404, aggregated location data (e.g., older location data) for a second predetermined time (e.g., the past 30 days) at predetermined intervals (e.g., hourly); Preparing location data older than the second predetermined time period for external storage (e.g., off-device storage);
b) Implementing, by the processor 406, distributed storage operations comprising: i) Generating, by the processor 406, data packets (e.g., aggregated spatiotemporal data packets from the full historical location data), wherein each may comprise: A start and end timestamp (e.g., a start and end timestamp for the aggregation period); A list of location points, each comprising location coordinates, accuracy metrics and source identifiers; A cryptographic hash of the previous packet computed by the processor 406; ii) Encrypting, by the processor 406, the data packets using one or more encryption algorithms (e.g., AES-256-GCM encryption) with a device-specific key (e.g., a key derived from the user's device-specific secret); iii) Transmitting, by the processor 406 through the communications interface 408 of the user device 110, the encrypted data packets to a distributed file system network (e.g., an IPFS network); iv) Receiving, by the processor 406 through the communications interface 408, content identifiers (e.g., IPFS content identifiers (IPFS CIDs)) for the uploaded data; v) Transmitting, by the processor 406 through the communications interface 408, the received content identifiers to a blockchain network; vi) Maintaining, by the processor 406 in the secure storage component 402 and/or memory 404, a local cache of frequently accessed distributed file system data, with a predetermined cache size limit (e.g., 100 MB) using a predefined policy (e.g., least-recently-used (LRU) eviction policy);
c) Implementing, by the processor 406 of the user device 110, a real-time location verification mechanism, said implementation comprising: i) Executing, by the processor 406, a continuous background process that may comprise: Acquiring current GPS coordinates from the GPS and/or AGPS components of the input component 414; Encrypting the acquired GPS coordinates using a session key that may be stored in the memory 404 and/or storage component 402; Generating a timestamp and nonce; Retrieving the previous beacon's hash from the memory 404; Combining the encrypted coordinates, timestamp, nonce, and hash into a location beacon; Broadcasting the location beacon through one or more wireless transceivers (e.g., Bluetooth transceiver that may be operating in Bluetooth Low Energy mode, NFC transceiver, RF interface, infrared interface) of the communications interface 408, wherein the wireless transceivers may comprise at least one of: a Bluetooth transceiver that may be operating in Bluetooth Low Energy mode, a Wi-Fi transceiver that may be operating in Wi-Fi Direct mode, a Near Field Communication (NFC) transceiver, or an Ultra-Wideband (UWB) transceiver, at predetermined intervals (e.g., 1-minute intervals); ii) Receiving, by the processor 406 through one or more wireless transceivers of the communications interface 408, encrypted location beacons from nearby devices (e.g., user devices 110); iii) Verifying, by the processor 406, the received location beacons by: Processing data from one or more of on-device sensors (e.g., the accelerometer, gyroscope, and magnetometer) of the input component 414; Analyzing signal strength characteristics received through the one or more wireless transceivers; Correlating sensor data with beacon data to validate authenticity; iv) Computing, by the processor 406, zero-knowledge proofs for frequent locations (e.g., home, work) by: Retrieving location history from the memory 404; Generating zero-knowledge proofs (e.g., zk-SNARKs proofs) for commonly visited locations (e.g., home, work); Storing the pre-computed zero-knowledge proofs in the memory 404; Updating the stored zero-knowledge proofs at predetermined intervals (e.g., daily); v) Executing, by the processor 406, a verification process that may: Retrieve pre-computed proofs from the memory 404 for common locations; Validate location claims using the retrieved proofs. This may help achieve verification time reduction (e.g., up to 80%) for frequent locations;
d) Implementing, by the processor 406, an efficient proof generation and update mechanism, comprising: i) Generating, by the processor 406, initial zero-knowledge proofs of the device's location history by: Retrieving location history from the memory 404; Executing a zero-knowledge proof system (e.g., zk-SNARKs proof system); Storing the generated proofs in the memory 404; ii) Updating stored proofs by: Receiving new location data points from the GPS and/or AGPS components of the input component 414, Wi-Fi positioning system through the Wi-Fi transceiver of the communications interface 408, Cellular network positioning through the cellular network interface of the communications interface 408, and Network-based positioning using signal strength and time of arrival data from one or more device (e.g., user devices 110 and/or verifier devices 116) that may be received through the communications interface 408; Executing one or more proof composition algorithms at predetermined intervals (e.g., 5-minute intervals); Storing updated proofs in the memory 404; iii) Managing proof data by: Constructing a data structure (e.g., a Merkle tree data structure) in the memory 404; Configuring the data structure (e.g., Merkle tree) with specified parameters (e.g., branching factor of 16, depth of 5). This may allow for efficient updates and proofs of recent activity; Maintaining the data structure for efficient updates and proof generation; iv) Generating compact proofs by: Retrieving the data structure (e.g., Merkle tree data structure) from the memory 404; Computing location consistency proofs; Ensuring proof size remains below predetermined threshold (e.g., under 1 KB); Storing generated proofs in the memory 404;
e) Implementing, by the processor 406 of the user device 110, an adaptive consensus participation mechanism, said implementation comprising: i) Monitoring, by the processor 406, current device (e.g., user device 110) resources by: obtaining battery level data from a power management component of the user device 110; measuring CPU usage of the processor 406; determining available memory in the memory 404; receiving network condition data including but not limited to bandwidth and latency measurements through the communications interface 408; ii) Executing, by the processor 406, one or more algorithms (e.g., weighted scoring algorithm) that may be stored in the memory 404 to: calculate a participation score based on the monitored resources; determine an appropriate consensus participation level based on the calculated score; iii) Executing, by the processor 406, role adjustment operations comprising: storing the current consensus role in the memory 404; updating the stored role based on the determined participation level; selecting between one or more configurations (e.g., full node, light node, or passive node configurations) that may be stored in the memory 404; iv) Implementing, by the processor 406, resource-constrained operations by: comparing the battery level against a first threshold stored in the memory 404; comparing the CPU usage against a second threshold stored in the memory 404; activating reduced consensus mode when thresholds are exceeded; establishing connections through the communications interface 408 with at least three nearby full nodes (e.g., user devices 110) for verification;
f) Implementing, by the processor 406 of the user device 110, an optimized data transmission protocol, said implementation comprising: i) Executing, by the processor 406, one or more encoding operations (e.g., delta-encoding operations) comprising: retrieving previous location data from the memory 404; calculating location data changes; comparing changes against a predetermined threshold (e.g., 10 meters); generating encoded updates only for changes exceeding the threshold; ii) Determining transmission parameters by: calculating, by the processor 406, current movement speed using location data from the input component 414; retrieving, by the processor 406, speed thresholds from the memory 404; obtaining current bandwidth measurements through the communications interface 408; computing an adaptive transmission rate based on the speed and bandwidth measurements; iii) Executing the transmission by: encoding, by the processor 406, the location updates according to the determined rate; transmitting, by the processor 406 through the communications interface 408, the encoded updates at the computed adaptive rate.
g) Implementing, by the processor 406 of the user device 110, an enhanced privacy mechanism with selective disclosure, said implementation comprising: i) Displaying, through the output component 412 of the user device 110, a user interface for configuring location precision settings; ii) Receiving, through the input component 414 of the user device 110, user selections defining location zones with varying levels of precision, wherein said precision levels may comprise: high precision comprising location data obtained from: GPS and/or AGPS components of the input component 414, Wi-Fi positioning system through the Wi-Fi transceiver of the communications interface 408, Cellular network positioning through the cellular network interface of the communications interface 408, and Network-based positioning using signal strength and time of arrival data from one or more devices (e.g., user devices 110, and/or verifier devices 116) received through the communications interface 408; medium precision comprising a predetermined radius around coordinates derived from one or more of the above location data sources; and low precision comprising city-level location data derived from one or more of the above location data sources; iii) Generating, by the processor 406, encrypted location data (e.g., homomorphically encrypted location data), wherein the processor 406: may execute one or more algorithms (e.g., a Paillier cryptosystem algorithm with a 2048-bit key), and store the encrypted data in the secure storage component 402; iv) Computing, by the processor 406, zero-knowledge proofs of presence within defined zones using the encrypted location data, wherein the processor 406 may perform computations without decrypting the location data;
h) Implementing, by the processor 406 of the user device 110, a blockchain interaction mechanism, said implementation comprising: i) Initializing, by the processor 406, a lightweight client (e.g., software application or software instructions) in the memory 404, wherein the processor 406 may: configure the client as a Simple Payment Verification (SPV) node, store block headers in the memory 404, and store Merkle proofs in the memory 404. As used herein, the term “Merkle proof” may refer to a cryptographic verification mechanism that may enable the validation of whether a specific transaction or data element is part of a Merkle tree structure, without requiring the retrieval or storage of the entire dataset; ii) Processing blockchain updates, wherein the processor 406 may: aggregate multiple transactions at predetermined intervals (e.g., 10-minute intervals), and generate batched updates to reduce network overhead, and transmit the batched updates through the communications interface 408; iii) Verifying blockchain data, wherein the processor 406 may: receive blockchain data through the communications interface 408, execute the lightweight client protocol to verify received proofs, and validate the proofs against block headers that may be stored in the memory 404;
i) Implementing, by the processor 406 of the user device 110, a real-time attack mitigation system, said implementation comprising: i) Executing, by the processor 406, a machine learning model that may be stored in the memory 404, wherein the machine learning model may comprise a neural network with a predetermined number of layers and neurons configured for detecting attack patterns in real-time; ii) Updating, by the processor 406, the machine learning model through the communications interface 408 using one or more distributed learning techniques (e.g., one or more federated learning techniques), wherein the processor 406 may: receive model updates from one or more devices through the communications interface 408; Aggregate the received updates without accessing raw data; and Store the updated model in the memory 404; iii) Computing, by the processor 406, real-time risk scores for nearby devices (e.g., user devices 110, and/or verifier devices 116) based on their behavior patterns, wherein the processor 406 may: Receive behavior pattern data through the communications interface 408; Generate risk scores within a predetermined range (e.g., 0-100 range); Update the scores at predetermined intervals (e.g., every one minute); Store the computed scores in the memory 404; iv) Controlling, by the processor 406, device interactions with nearby devices based on the computed risk scores, wherein the processor 406 may: Retrieve the risk scores from the memory 404; Compare each score against predetermined thresholds; Instruct the communications interface 408 to ignore beacon transmissions from devices (e.g., user devices 110, and/or verifier devices 116) with scores exceeding the predetermined threshold;
j) Implementing, by the processor 406 of the user device 110, an optimized battery usage mechanism for location services. The implementation may comprise: i) Managing, by the processor 406, adaptive GPS polling rates, wherein the processor 406 may: Obtain movement data from the input component 414, Monitor current battery level, Set a first polling rate when detected speed exceeds a first threshold, Set a second polling rate when movement is not detected, and reduce the polling rate by a predetermined factor when battery level falls below a second threshold; ii) Executing, by the processor 406, a geofencing system, wherein the processor 406 may: Maintain predetermined radius values in the memory 404, Retrieve predefined trusted locations from the memory 404, Reduce active tracking frequency when the user device 110 is within the predetermined radius of one or more locations (e.g., trusted locations); iii) Controlling, by the processor 406, location proof generation frequency, wherein the processor 406 may: Monitor device context and battery status, Generate location proofs at a first interval when battery level exceeds a first threshold, Generate location proofs at a second interval when battery level is between a second and third threshold, Generate location proofs at a third interval when battery level falls below a fourth threshold, and Transmit the generated location proofs through the communications interface 408;
k) Implementing, by the processor 406 of the user device 110, a scalable verification system for dense areas. The implementation may comprise: i) Executing, by the processor 406, a hierarchical verification process comprising: Performing, by the processor 406 through the communications interface 408, immediate local verification with one or more user devices 110 within a first predetermined range stored in the memory 404; Initiating, by the processor 406 through the communications interface 408, nearby node consensus with user devices 110 within a second predetermined range stored in the memory 404 when the local verification fails; Escalating, by the processor 406 through the communications interface 408, to user devices 110 within a third predetermined range stored in the memory 404 when the number of verification failures exceeds a predetermined threshold stored in the memory 404; ii) Managing consensus groups, comprising: Participating, by the processor 406 through the communications interface 408, in location-based sharding; Calculating, by the processor 406, shard sizes based on device density data stored in the memory 404; Adjusting, by the processor 406, the calculated shard sizes between a first predetermined number for urban areas and a second predetermined number for rural areas, wherein said predetermined numbers are stored in the memory 404; iii) Managing verification roles, comprising: Monitoring, by the processor 406, local device density through the communications interface 408; Measuring, by the processor 406, network conditions through the communications interface 408; Adjusting, by the processor 406, the user device's 110 verification responsibilities based on the monitored density and measured conditions when the number of nearby capable devices falls below a predetermined threshold stored in the memory 404;
l) Implementing, by the processor 406 of the user device 110, an non-transferable proof system, the implementation may comprise: i) Managing tokens, comprising: Retrieving, by the processor 406, the user device's 110 unique identifier from the secure storage component 402; Accessing, by the processor 406, recent location history from the memory 404; Generating, by the processor 406, time-bound tokens cryptographically linked to the retrieved identifier and accessed location history; Setting, by the processor 406, a validity period of the generated tokens to a predetermined time period stored in the memory 404; ii) Securing tokens, comprising: Retrieving, by the processor 406, the device's identifier from the secure storage component 402; Obtaining, by the processor 406, current time from a timing component; Determining, by the processor 406, the current location zone; Encrypting, by the processor 406, the generated tokens using attribute-based encryption schemes based on the retrieved identifier, obtained time, and determined location zone; iii) Verifying tokens, comprising: Receiving, by the processor 406 through the communications interface 408, tokens from other user devices 110; Decrypting, by the processor 406, the received tokens using attribute-based decryption; Verifying, by the processor 406, the decrypted tokens by: Comparing token attributes against current time from the timing component, Validating claimed location zones against sender's location history, and Confirming attribute consistency with current system state.

FIG. 3 shows a simplified flowchart illustrating an alternative or extended method for decentralized location verification and reputation management in accordance with one or more embodiments.

At step 302, a software application may be launched on a first user's device (user device 110), initializing an anonymous decentralized identifier (DID) through a cryptographic identity management system (e.g., a wallet SDK). The initialization process may involve one or more sub-steps from the steps below:

Step 302a: When the software application is launched, it may initiate a call to the first user's (user 102) secure identity management application (e.g., self-custodial crypto wallet app) to generate a one-time anonymous decentralized identifier. The secure identity management application is a software application that provides the user 102 with full control over their cryptographic keys and digital assets, ensuring a high level of security and privacy.

Step 302b: The identity management application (e.g., wallet app) may implement standardized decentralized identifier generation methods that adhere to industry-recognized interoperability standards. These standards (e.g., W3C Decentralized Identifiers (DIDs) specification) may provide a framework for creating and managing decentralized, cryptographically verifiable identifiers that enable secure and privacy-preserving interactions across different platforms and systems.

Step 302c: The first user's device 110 may generate a secure asymmetric key pair (e.g., 2048-bit RSA) and a unique random seed value (e.g., 256-bit). The key pair generation process may utilize the user device's secure hardware components, including but not limited to Trusted Execution Environment (TEE) and/or Secure Enclave, to ensure the highest level of cryptographic security and resistance against potential attacks.

Step 302d: The generated public/private key pair may be used to register identity ownership on a distributed ledger system [e.g., Sovrin] through the identity management application's transactional capabilities (e.g., wallet app's transactional capabilities). The distributed ledger system may be a decentralized network that utilizes a permissioned or public data structure [e.g., blockchain] to enable secure, private, and verifiable identity management. The identity management application (e.g., wallet app) may interact with the distributed ledger network (e.g., Sovrin network) using its built-in transactional features to register the user's identity and establish their control over the associated cryptographic keys.

Step 302e: A one-time disposable DID with a verification method linking to the new public key may be constructed using the unique random seed value (e.g., 256-bit entropy output extending the seed number) generated in step 302c. The DID construction process may follow standardized specifications (e.g., W3C DID specification), ensuring interoperability and compatibility with other DID-based systems. The verification method, which may be linked to the public key, may allow other entities to cryptographically verify the authenticity and ownership of the DID.

Step 302f: The newly registered DID along with the matching private key may be securely stored within the hardware-isolated secure storage of the user device's trusted execution environment, separated from the main operating system. The trusted execution environment is a secure area of the user device's processor that ensures the confidentiality and integrity of sensitive data and code execution. By storing the DID and private key within the trusted execution environment, the system may guarantee that this critical information is protected from unauthorized access, tampering, or disclosure, even if the user device's operating system is compromised.

Step 302g: A reference handle to the securely stored private key may be returned by the trusted execution environment to the calling identity management application (e.g., wallet application) for signing cryptographic requests initiated by the software application. This reference handle acts as a secure pointer to the private key stored within the trusted execution environment, allowing the identity management application (e.g., wallet application) to perform cryptographic operations, such as signing transactions or attestations, without directly accessing or exposing the private key itself. This architectural design may enhance the overall security and privacy of the system by minimizing the attack surface and preventing potential key leakage.

At step 304, an ephemeral key pair may be automatically generated on the device using cryptographic software libraries (e.g., SDK crypto libraries). This process may involve one or more sub-steps from the steps below:

Step 304a: The software application may initialize a secure random number generator (e.g., a 256-bit random number generator) using operating system-provided entropy sources (e.g., /dev/random in Linux/UNIX). Entropy sources are critical for generating high-quality random numbers that are essential for secure cryptographic operations. The operating system's entropy pool may provide a high-entropy source of random data derived from various system events and noise sources, ensuring a sufficient level of randomness and unpredictability.

Step 304b: The software application may feed the randomly generated seed value into a key agreement algorithm (e.g., Elliptic Curve Diffie-Hellman (ECDH)) to derive a cryptographically secure asymmetric key pair. The key agreement algorithm may allow two parties (e.g., two users 102) to establish a shared secret over an insecure channel.

Step 304c: Standardized elliptic curve parameters (e.g., Curve25519) may be supplied to the key generation routine provided by the cryptographic software libraries (e.g., SDK crypto libraries).

Step 304d: Using a proprietary identity management software development kit (SDK) (e.g., proprietary libIdentity native SDK), a secure private key (e.g., a 256-bit key) may be generated based on hashing the random seed through a cryptographic hash function (e.g., Blake3 algorithm). The identity management SDK (e.g., libIdentity SDK) is a specialized software development kit that may provide a set of cryptographic primitives and protocols optimized for decentralized identity and privacy-preserving applications. The cryptographic hash function (e.g., Blake3 algorithm) may generate a fixed-size output from an arbitrary input, ensuring that the resulting private key is deterministic, collision-resistant, and computationally infeasible to reverse.

Step 304e: A corresponding public key (e.g., 88-bit key) may be derived from the private key using principles of Public Key Cryptography by applying the generated random number as the secret factor. Public Key Cryptography, also known as asymmetric cryptography, is a cryptographic system that uses a pair of keys-a public key and a private key—for secure communication and digital signatures. The public key is derived from the private key using a mathematical function that ensures the computational infeasibility of reversing the process, thus protecting the private key's secrecy.

Step 304f: Additional entropy is added to the private key by appending the one-time DID suffix to it, converting it into an ephemeral key pair. This step may further enhance the security and privacy of the key pair by introducing additional randomness and uniqueness. The DID suffix, which is a part of the decentralized identifier generated earlier, may be appended to the private key, creating an Ephemeral ID key pair that is specific to the current session and user interaction.

Step 304g: The ephemeral public and expanded private keys may be discardable one-time use credentials valid only for the active user session. This property may ensure that the key pair is used only for a limited time and purpose, minimizing the potential impact of key compromise or unauthorized access. After the active user session ends, the ephemeral key pair may be securely discarded, preventing its reuse and potential misuse.

In some embodiments, the software application may establish a secure communication channel with nearby edge devices (e.g., machinery, vehicles, or infrastructure components) using a lightweight cryptographic protocol (e.g., Noise Protocol Framework). This channel may enable the exchange of ephemeral identifiers and sensor data between the user's device 110 and the edge devices, facilitating the verification of proximity and interaction events. The edge devices may be equipped with secure elements or trusted execution environments to protect the cryptographic keys and sensitive data during the communication process.

At step 306, the first user (a user from users 102) may opt into location and wireless network scanning permissions, and the software application may retrieve prohibited geospatial locations (e.g., prohibited geographical location coordinates) from a decentralized storage network (e.g., IPFS distributed storage). This process may involve several sub-steps from the steps below:

Step 306a: The software application may prompt the first user 102 to grant location and wireless network scanning permissions required for geofencing and ambient signals analysis. These permissions are essential for enabling the app to access the device's location services and wireless scanning capabilities, which may be used to detect the user's proximity to prohibited geospatial locations and gather relevant environmental data for attestation purposes.

Step 306b: Once the first user 102 approves the permissions via a system dialog, the user device's (user device 110) location services API (e.g., Android location services manager) may be invoked to trigger high accuracy mode, leveraging multiple positioning technologies (e.g., GPS, cell towers, and Wi-Fi) for precise geocoordinates. The location services API may provide a comprehensive set of tools and interfaces for accessing and managing location data on the user device 110. By leveraging multiple positioning technologies, the application may obtain highly accurate and reliable location information.

Step 306c: The software application may import a decentralized storage client library (e.g., IPFS client library) and initialize a distributed hash table (DHT) connectivity by establishing network connections (e.g., TCP sockets) with public decentralized storage gateways to interface with the decentralized storage network (e.g., InterPlanetary File System (IPFS)). The decentralized storage client library (e.g., room.js library) may provide an implementation of the decentralized storage protocol (e.g., a JavaScript implementation of the IPFS protocol), allowing the application to interact with the decentralized storage network seamlessly.

Step 306d: The software application may construct a file read request message with a content identifier hash (CID) containing prohibited geospatial locations' metadata that may be retrieved earlier from a decentralized application (DApp) and cached locally on the user device's storage. The CID may be a unique, cryptographic hash that identifies the content stored on the decentralized storage network. By using the CID, the software application can efficiently retrieve the prohibited geospatial locations' metadata from the decentralized storage without relying on centralized servers or databases.

Step 306e: A decentralized storage clustering search request (e.g., IPFS clustering search request) may be executed using the decentralized storage client library's pinning endpoint with the defined CID to locate storage nodes that have persistently stored the requested data. Decentralized storage clustering (e.g., IPFS clustering) is a mechanism that enables the distribution of content across multiple storage nodes, ensuring high availability and redundancy. By leveraging the pinning endpoint, the software application can discover the storage nodes (e.g., IPFS nodes) that have pinned (i.e., persistently stored) the prohibited geospatial locations' metadata, allowing for efficient retrieval and verification.

Step 306f: The retrieved data may contain geospatial attributes of prohibited geospatial locations, including names, addresses, latitudes, and longitudes. The data may be encoded in a self-describing format (e.g., multihash) that encodes the cryptographic hash digest along with metadata about the hash function used. This format may ensure the integrity and authenticity of the retrieved data, enabling the software application to securely access and process the geospatial attributes of the prohibited geospatial locations.

Step 306g: The retrieved content may be stored in a local database (e.g., SQLite) on the user device's storage, with geofencing triggers configured using the user device's geofencing API (e.g., Android Geofencing API) based on the breach of store coordinates' proximity radius. The local database may provide efficient access and querying of the data without relying on network connectivity. The geofencing API may allow the application to define virtual boundaries (geofences) around the prohibited geospatial locations and receive notifications when the user (user from users 102) enters or exits these boundaries. This enables the software application to trigger specific actions, such as initiating the attestation process, when the user breaches the proximity radius of a prohibited geospatial location.

In some embodiments, the software application may periodically broadcast encrypted beacon messages containing the user's ephemeral identifier and a timestamp using a short-range wireless protocol (e.g., Bluetooth Low Energy). These beacon messages may enable nearby devices to detect the user's presence without revealing their actual location. The encryption of the beacon messages may be performed using the ephemeral key pair generated in step 304, ensuring the confidentiality and integrity of the transmitted data. The broadcast process may be executed by the user device's (user device 110) wireless communication hardware, which may interact with the application through system APIs.

At step 308, the application may detect a location proximity breach and scans surrounding wireless network signals using accelerated mode. This process may involve one or more sub-steps from the steps below:

Step 308a: The previously set geofence triggers may be activated when the first user (a user from the users 102) breaches the specified radius of the prohibited geospatial location's geographical fence perimeter based on the detected device latitude and longitude (user device 110's latitude and longitude) reported by the device's location services API (device 110's location services API) such as Android location services manager. This step may ensure that the application is alerted in real-time when the user enters the proximity of a prohibited geospatial location, enabling the initiation of the wireless network scanning and attestation process.

Step 308b: Upon receiving the geofence transition event, the software application may toggle the wireless network scanner (e.g., WiFi scanner) into accelerated scanning mode by setting the scan interval to sub-second using the user device's wireless network management API (e.g., WifiManager in Android). The wireless network management API may provide a set of methods for managing and controlling the user device's wireless network functionality, including scanning for available wireless networks. By setting the scan interval to a sub-second value, the software application may enable rapid and continuous scanning of the surrounding wireless network signals, allowing for fine-grained data collection and analysis.

Step 308c: The software application may register a wireless network scan listener implementing event callbacks (e.g., onLost( ) and onResults( )) to continually monitor changed scan findings in near real-time. The wireless network scan listener is a mechanism that may be provided by the user device's wireless network framework that may allow applications to receive notifications whenever the wireless network scan results change. By implementing the event callbacks, the software application can dynamically react to the changes in the surrounding wireless network environment and update its internal state accordingly.

Step 308d: The onResults ( ) callback may be invoked multiple times per second, allowing rapid capture of all wireless network basic service set identification (BSSID) media access control (MAC) addresses detected from proximate wireless access points. The BSSID is a unique identifier assigned to each wireless access point, representing its MAC address. By capturing the BSSIDs of the surrounding wireless access points at a high frequency, the software application can create a detailed and time-sensitive map of the user device's location and environment.

Step 308e: The software application may record fluctuating wireless network signals along with their received signal strength indicator (RSSI) metrics mapped to BSSID device identifiers as the first user 102 with its associated user device 110 moves through the store premises for a fixed duration. RSSI is a measurement of the power level received by the user device 110 from a wireless access point, indicating the strength and quality of the wireless signal. By recording the RSSI values associated with each detected BSSID over a fixed duration, the application can create a unique and time-varying fingerprint of the user device's location within the store premises. This fingerprint may be used to verify the user's presence and movements during the attestation process.

Step 308f: The accelerated scan window may expire once the elapsed threshold duration is reached since the initial geofence breach event. This step may ensure that the application collects sufficient wireless network signal data for attestation purposes while minimizing the impact on the user device's battery life and performance. Once the scan window expires, the application may stop the accelerated wireless network scanning and proceeds to the next stage of the attestation process.

Step 308g: The enriched multi-dimensional BSSID dataset that may be collected during the window may serve as location fingerprints for subsequent consistency analysis and corroboration. This dataset represents a unique and verifiable record of the user device's presence within the prohibited geospatial location, capturing the spatial and temporal characteristics of their movements. The collected data may be used in the subsequent steps to validate the user's attestation claims and ensure the integrity and authenticity of the reported violation.

At step 310, the access point data may be encrypted via the ephemeral public key, and a signed payload may be created embedding a secure state channel receipt. This process may involve one or more sub-steps from the steps below:

Step 310a: The software application may aggregate all captured BSSID access point data (e.g., BSSID router hashes) combined with additional spatial indicators like elapsed dwell time into a digital attestation payload (e.g., skeleton payload). This step may consolidate the collected wireless network signal data and contextual information into a structured format that can be efficiently processed and verified by the attestation protocol. The inclusion of spatial indicators, such as the elapsed dwell time, enhances the richness and granularity of the attestation data, providing additional proof of the user's presence and actions within the prohibited geospatial location.

Step 310b: A cryptographic hash digest (e.g., 256-bit Blake3 hash digest) may be computed on the attestation payload contents to create a tamper-evident condensed dataset identifier in place of the actual exposed plaintext. The cryptographic hashing algorithm (e.g., Blake3) may generate a fixed-size digest from an arbitrary input. By hashing the attestation payload, the application may create a compact and tamper-evident identifier that uniquely represents the contents of the payload without revealing the sensitive data itself. This step may ensure the integrity and confidentiality of the attestation data during transmission and storage.

Step 310c: The previously generated one-time use ephemeral session public key (e.g., ECDH ephemeral session public key) for the active lifespan may be retrieved from the secure storage. This public key, which was generated as part of the ephemeral key pair in step 304, may be used to encrypt the attestation payload, ensuring that only the intended recipients can decrypt and access the contained data. The secure storage (e.g., secure enclave) may provide a hardware-backed storage environment for cryptographic keys, ensuring their protection against unauthorized access or tampering.

Step 310d: The hashed attestation digest payload may be encrypted using a hybrid encryption scheme (e.g., Elliptic Curve Integrated Encryption Scheme (ECIES)) with the ephemeral public key. The hybrid encryption scheme may combine the security of elliptic curve cryptography with the efficiency of symmetric encryption. By using the ephemeral public key, the application may ensure that only the holder of the corresponding private key can decrypt the payload, providing end-to-end confidentiality and integrity protection.

Step 310e: The encryption process may generate a ciphertext output (e.g., a 512-bit ciphertext output), which may be temporarily persisted within the secure storage. The secure storage may provide a hardware-isolated environment for storing sensitive data, ensuring that the encrypted attestation payload is protected from unauthorized access or tampering. By persisting the ciphertext output within the secure storage, the application may guarantee the confidentiality and integrity of the attestation data until it is ready to be transmitted to the relevant parties.

Step 310f: A secure state channel smart contract on a distributed ledger platform (e.g., Polygon) may be invoked to register a proof receipt with metadata pointers to the encrypted payload on the decentralized storage network (e.g., IPFS network). The secure state channel smart contract may be a decentralized application that facilitates the secure and verifiable exchange of attestation data between parties. By invoking the smart contract, the software application may create an immutable record of the attestation event on the distributed ledger, including metadata pointers to the encrypted payload stored on the decentralized storage network. This step may ensure the integrity and non-repudiation of the attestation process, as the smart contract transactions are cryptographically signed and verified by the distributed ledger network.

Step 310g: A zero-knowledge proof may also be supplied to the proof receipt using the ephemeral private key resident inside the secure storage to digitally sign the register transaction. In this context, the software application may generate a zero-knowledge proof using the ephemeral private key to sign the register transaction, demonstrating the authenticity and integrity of the attestation event without exposing the private key itself. This step enhances the privacy and security of the attestation process, as the private key remains protected within the secure storage.

Step 310h: The generated receipt ticket may be embedded into the payload and hashed header, appended with ciphertext before final persistence. This step may combine the attestation payload, the proof receipt ticket, and the encrypted ciphertext into a single, cohesive data structure. The inclusion of the receipt ticket within the payload may provide a tamper-evident link between the attestation event and its corresponding distributed ledger record. The hashed header may ensure the integrity of the combined data, allowing for easy verification and validation by the relevant parties.

In some embodiments, the software application may perform a secure multi-party computation protocol (e.g., private set intersection) with nearby devices to determine the common set of ephemeral identifiers observed by the participating devices. This process may allow the devices to establish a shared context of proximity without disclosing their individual location histories. The secure multi-party computation may be executed by the user devices' secure enclaves or trusted execution environments, ensuring the privacy and integrity of the computation. The results of the computation may then be included in the attestation payload, providing a tamper-proof record of the shared context.

Step 310i: The application may integrate the Time-Based Adaptive Key Generation method described herein in the flowchart 600 to generate dynamic encryption keys for securing the attestation payload. The dynamic key generation process may take into account time-related parameters, such as the current timestamp and a predefined seed value, along with other relevant factors, including the user's session identifier and the payload size. These parameters may be combined using a cryptographic hash function [e.g., SHA-256] to generate a unique and time-specific encryption key.

Step 310j: The hardware components that may be involved in the dynamic key generation process may include a secure cryptographic module, such as a Hardware Security Module (HSM) or a Trusted Platform Module (TPM). These modules may provide a tamper-resistant environment for performing cryptographic operations and storing sensitive key material. The secure cryptographic module may interact with the application software to generate the dynamic encryption keys based on the provided time-related parameters and other inputs.

Step 310k: The generated dynamic encryption key may be securely stored within the secure cryptographic module, ensuring its protection against unauthorized access or tampering. The secure storage mechanism may utilize hardware-based encryption and access control policies to maintain the confidentiality and integrity of the key material. The software application may interact with the secure cryptographic module through well-defined APIs (e.g., PKCS #11) to retrieve the dynamic encryption key when needed for encrypting the attestation payload.

Step 310l: The software application may use the retrieved dynamic encryption key to encrypt the attestation payload using a symmetric encryption algorithm (e.g., AES-256). The encryption process may take place within the secure execution environment provided by the hardware components, such as the HSM or TPM, to prevent any potential leakage of sensitive information. The encrypted attestation payload may then be securely stored or transmitted to the intended recipients, such as the verifier devices 116 (it may also be called validator nodes).

At step 312, the nearby verifier devices 116 may be discovered by spatial search across a geohashed registry indexing active verifiers 108. This process may involve one or more sub-steps from the steps below:

Step 312a: The software application may import a geohashing library (e.g., js-geohash) for efficient geo-spatial clustering at scale. Geohashing is a technique that converts geographic coordinates into short, alphanumeric strings called geohashes. The geohashing library may provide an implementation (e.g., JavaScript implementation) of the geohashing algorithm, enabling the application to perform fast and efficient spatial indexing and searching operations.

Step 312b: The current user device 110 coordinates, that may be reported by the device's location services API (e.g., Android location services manager API), may be passed through a geohashing function with a precision level (e.g., geohash length 5), providing a desired spatial accuracy (e.g., ˜1.2 km). By encoding the user device's latitude and longitude into a geohash of a specific length, the software application may create a compact and hierarchical representation of the user device's location. This geohash may serve as a spatial key for indexing and querying the validator registry, allowing for efficient discovery of nearby verifier devices 116 (validator nodes).

Step 312c: A distributed ledger contract call (on-chain contract call) may be initiated to the validator registry smart contract on a distributed ledger network (e.g., Polygon). The validator registry smart contract may maintain a decentralized registry of active validator nodes (active verifier devices 116), storing their geolocation data and metadata. By invoking the smart contract, the software application can query the registry and retrieve the list of verifier devices 116 that are relevant to the user device's current location (user device 110 current location).

Step 312d: The geocoded geohash prefix may be supplied as an indexed search parameter to retrieve all verifiers 108 (validators) having signaled situational availability within that geographic perimeter. The geohash prefix may act as a spatial filter, enabling the software application to efficiently narrow down the list of potential verifier devices 116 (validator nodes) based on their proximity to the user device's 110 location. This step may ensure that only the most relevant and situationally available validators (verifiers 108) are considered for the attestation process, reducing latency and improving the overall user 102 experience.

Step 312e: The registry contract may emit event logs revealing verifier 108 (validator) identifiers (e.g., Ethereum addresses) along with associated decentralized identifier handles. The validator registry smart contract may maintain a mapping between validator identifiers and their corresponding decentralized identifiers (DIDs). When the software application queries the registry, the smart contract may emit event logs containing the identifiers and DID handles of the candidate verifiers 108 (validators) that match the specified geohash prefix. These event logs may provide a verifiable and tamper-proof record of the verifier 108 (validator) discovery process, ensuring transparency and accountability.

Step 312f: These DID handles may resolve to network endpoint references of returned verifiers 108 (validators) hosting secure communication services for verifying incidents. Decentralized identifiers (DIDs) are unique, cryptographically-verifiable identifiers that may be resolved to metadata documents called DID documents. In this context, the DID handles associated with the candidate verifiers 108 (validators) may be resolved to obtain the network endpoint references of the secure communication services hosted by each verifier 108 (validator). These endpoints may enable the software application to establish secure communication channels with the verifiers 108 (validators) for submitting the attestation data and receiving verification results.

Step 312g: Network connection strings (e.g., multiaddr) may be passed into a peer-to-peer communication protocol handler (e.g., IPFS PubSub) to initialize secure transports towards shortlisted verifiers 108 (validators). Multiaddr is a compact encoding format for representing network addresses and protocols. The application may use the multiaddr strings to establish secure communication channels with the selected verifiers 108 (validators) using a peer-to-peer communication protocol (e.g., IPFS PubSub). The communication protocol may enable efficient and decentralized communication between nodes. By initializing secure transports using multiaddr and the peer-to-peer communication protocol, the application may ensure that the attestation data is transmitted securely and reliably to the validator nodes (verifier devices 116).

Step 312h: The encrypted payload may be transmitted over established channels towards verifiers 108 (validators) who signaled situational availability within the proximity of the reported incident geohash. This step may involve securely transmitting the encrypted attestation payload to the selected verifier devices 116 (validator nodes) using the established peer-to-peer communication channels. By leveraging the geohash-based proximity filtering and situational availability signaling, the software application may ensure that only the most relevant and responsive verifiers 108 (validators) receive the attestation data, minimizing latency and improving the chances of successful verification.

Step 312i: The software application may utilize the Time-Based Adaptive Key Generation method described herein in the flowchart 500 to establish a secure key exchange mechanism with the nearby verifier devices 116 (validator nodes). The key exchange process may involve generating ephemeral key pairs based on time-related parameters and other factors, similar to the dynamic encryption key generation process described in step 310i. The ephemeral key pairs may be generated using a post-quantum cryptographic algorithm (e.g., New Hope) to ensure resistance against potential quantum computing threats.

Step 312j: The post-quantum key exchange mechanism may be implemented using specialized cryptographic libraries (e.g., liboqs) that provide optimized implementations of post-quantum algorithms. These libraries may be integrated into the software application software and utilize the hardware-based secure execution environment, such as the HSM or TPM, to perform the key generation and exchange operations. The hardware components may ensure the secure storage and processing of the post-quantum key material.

Step 312k: The application software and the verifier devices 116 (validator nodes) may engage in a secure key exchange protocol (e.g., New Hope key exchange) to establish a shared secret. The shared secret may be derived from the exchanged ephemeral public keys and the time-related parameters used in the key generation process. The key exchange protocol may ensure that only the intended parties can compute the shared secret, preventing unauthorized access or eavesdropping.

Step 312l: The established shared secret may be used to derive a symmetric encryption key (e.g., using the HKDF algorithm) for securing the communication channel between the application and the verifier devices 116 (validator nodes). The derived symmetric key may be securely stored within the hardware-based secure storage, such as the HSM or TPM, to protect it from unauthorized access. The application software and the verifier devices 116 (validator nodes) may use the symmetric key to encrypt and decrypt the data transmitted over the established communication channel, ensuring the confidentiality and integrity of the transmitted attestation payload and related information.

At step 314, the encrypted payload may be transmitted to a specific verifier devices 116 (validator node) via a content-addressed data structure lookup (e.g., InterPlanetary Linked Data (IPLD) graph address lookup). This process may involve one or more sub-steps from the steps below:

Step 314a: The peer-to-peer communication protocol message payloads may contain the content-addressed data structure (e.g., InterPlanetary Linked Data (IPLD)) content identifier (CID) root graph link addresses of verifiers 108 (validators) who responded to initial discovery broadcasts. The content-addressed data structure described herein may be a data model and format for representing and linking structured data across different protocols and storage systems. In this context, the peer-to-peer communication protocol message payloads include the CID root graph link addresses of the responsive verifiers 108 (validators), enabling the application to retrieve their detailed information and establish direct communication channels.

Step 314b: The application may retrieve the public key associated with the verifier devices 116 (validator node) from a decentralized identity registry by resolving the DID endpoint path returned earlier. The decentralized identity registry as described herein may be a distributed system that enables the resolution and verification of DIDs across different networks and platforms. By resolving the DID endpoint path associated with the verifier devices 116 (validator node), the software application may obtain the validator node's public key, which is necessary for secure communication and data encryption.

Step 314c: the verifier devices 116 (validator node's) content-addressed data structure graph node network address (e.g., /ip4/xx.xx.xx.xx/tcp/4040) may be looked up from the CID hash embedded in the peer-to-peer communication protocol response. The peer-to-peer communication protocol response from the verifier devices 116 (validator node) may include the CID hash that points to the validator node's graph node information. By performing a content-addressed data structure graph traversal using this CID hash, the software application may retrieve the validator node's network address, which specifies the IP address and port number for direct communication.

Step 314d: The encrypted violation report payload generated previously may be segmented into smaller packets using a symmetric encryption scheme (e.g., NaCl secretbox) with a unique nonce for each packet. The symmetric encryption scheme provides a simple, efficient, and secure method for encrypting data using a shared secret key and a unique nonce (number used once). By segmenting the encrypted payload into smaller packets and applying symmetric encryption with a unique nonce for each packet, the application may ensure the confidentiality and integrity of the transmitted data, even if some packets are lost or corrupted during transmission.

Step 314e: These encrypted payload packets may be passed onto a peer-to-peer data exchange protocol (e.g., IPFS Bitswap) for transport initiation. The peer-to-peer data exchange protocol may be used for requesting and sending data blocks between nodes in a decentralized network. By passing the encrypted payload packets to the data exchange protocol, the software application may initiate the secure transport of the attestation data to the verifier devices 116 (validator node). The data exchange protocol (e.g., IPFS network) may ensure that the data is efficiently distributed and retrieved across the decentralized network (e.g., IPFS network), taking advantage of its content-addressing and peer-to-peer architecture.

Step 314f: Leveraging a peer-to-peer identity exchange approach (e.g., libp2p identify push approach), initial introductory messages may be sent to the verifier devices 116 (validator node) over the established network connection (e.g., TCP multiaddr connection string), establishing secure communication. The peer-to-peer identity exchange approach allows for the exchange of node identity information and capabilities during the initial connection establishment. By sending introductory messages to the verifier devices 116 (validator node) over the established network connection, the software application may establish a secure and authenticated communication channel, ensuring that the subsequent data exchange is protected from eavesdropping and tampering.

Step 314g: Once identity exchange completes, the payload packets may be transmitted reliably to the verifier devices 116 (validator node) via data push requests honored using the peer-to-peer data exchange protocol's content-addressed data structure-based block exchange sessions. After the successful completion of the identity exchange, the software application may proceed to transmit the encrypted payload packets to the verifier devices 116 (validator node) using the data exchange protocol's data push requests. These requests may be honored by validator node, which may initiate a content-addressed data structure-based block exchange session. By leveraging the peer-to-peer data exchange protocol and the content-addressed data structure, the software application may ensure that the payload packets are reliably transmitted to the verifier devices 116 (validator node), with built-in data integrity checks and deduplication.

Step 314h: Parallel delivery receipt notifications may be relayed back from the verifier devices 116 (validator node) on packet arrival, to be recorded immutably by the sending device for transmission accountability. As the validator node may receive the encrypted payload packets, it may send delivery receipt notifications back to the software application. These notifications confirm the successful arrival and verification of each packet, providing a tamper-proof record of the data transmission. The software application may record these delivery receipts immutably on the sending device, establishing a verifiable audit trail for transmission accountability. This step ensures that the software application can prove the successful delivery of the attestation data to the validator, preventing disputes and enabling trust between the parties.

At step 316, the verifier devices 116 (validator node) may decrypt the payload via the published ephemeral public key to verify the hash and receipt contents. This process may involve one or more sub-steps from the steps below:

Step 316a: The validator node's verification software may import the necessary cryptographic libraries (e.g., Elliptic Curve Integrated Encryption Scheme (ECIES) libraries) for asymmetric key operations. By importing these libraries, the validator node's verification software may gain the capability to perform the required asymmetric key operations, such as decrypting the encrypted payload using the corresponding ephemeral private key.

Step 316b: The previously transmitted encrypted payload packets may be reassembled into a consolidated ciphertext based on the sequential ordering of the unique nonces associated with each packet. Upon receiving the encrypted payload packets, the validator node's verification software may reassemble them into a consolidated ciphertext. This process may involve ordering the packets based on their associated unique nonces, which may be generated during the symmetric encryption process in step 314d. By reassembling the packets in the correct order, the validator node's software may reconstruct the complete encrypted payload, ready for decryption.

Step 316c: The validator node's verification software (verifier devices 116 verification software) may retrieve the one-time-use ephemeral public key published by the software application, leveraging the DID document stored on the decentralized identity registry. To decrypt the consolidated ciphertext, the validator node's verification software may need access to the ephemeral public key used by the software application for encryption. This public key may be retrieved from the DID document associated with the software application, which may be stored on the decentralized identity registry. By retrieving the public key from the DID document, the validator node's verification software may ensure that it is using the authentic and authorized key for decryption, preventing potential man-in-the-middle attacks or key substitution vulnerabilities.

Step 316d: The payload ciphertext may be decrypted using the corresponding ephemeral private key held by the verifier device 116 (validator node), which may be derived during the initial key exchange process using asymmetric cryptographic algorithms. With the ephemeral public key retrieved from the DID document, the validator node's verification software may now decrypt the consolidated ciphertext. This decryption process may involve using the corresponding ephemeral private key, which may be derived by the verifier devices 116 (validator node) during the initial key exchange process using asymmetric cryptographic algorithms (e.g., Elliptic Curve Diffie-Hellman (ECDH)). By using the ephemeral private key, validator node's software may ensure that only the intended recipient can decrypt and access the attestation data, maintaining the confidentiality and privacy of the transmitted information.

Step 316e: After decryption, the plaintext hash digest may be extracted from the decrypted payload and passed into a cryptographic hash verification function (e.g., Blake3 verification function). Upon successfully decrypting the ciphertext, the validator node's verification software may extract the plaintext hash digest that was originally computed by the software application in step 310b. This hash digest may serve as a tamper-evident identifier of the attestation payload contents. The extracted hash digest may then be passed into a cryptographic hash verification function, which may be a part of the chosen cryptographic hash algorithm [e.g., Blake3]. The hash verification function may take the plaintext hash digest as input and prepares it for the subsequent integrity check.

Step 316f: The verification function may invoke a cryptographic key derivation tool (e.g., Blake3 key derivation tool) to reconstruct the original hashed input using the provided public parameters. To verify the integrity of the decrypted attestation payload, the validator node's verification software may invoke a cryptographic key derivation tool. This tool uses the plaintext hash digest and a set of public parameters to reconstruct the original hashed input. The public parameters may include information such as the hash function version, the output length, and any additional context-specific data. By reconstructing the original hashed input using these public parameters, the validator node's software can compare it with the decrypted payload contents to ensure that no tampering or modification occurred during transmission.

Step 316g: A successful hash comparison may confirm the payload integrity, and the embedded proof receipt token may provide pointers to the distributed ledger transaction trails. The validator node's verification software may compare the reconstructed hashed input with the decrypted payload contents. If the two values match, it confirms that the payload has not been tampered with or modified during transmission, establishing its integrity. Additionally, the decrypted payload may include an embedded proof receipt token, which may be generated by the software application in step 310f. This receipt token may contain pointers to the distributed ledger-based transaction trails, providing a verifiable and tamper-proof record of the attestation event and its associated metadata. By validating the receipt token, the validator node's software can trace the attestation history and verify its authenticity.

Step 316h: Metadata from the receipt token may reveal geospatial and temporal attributes of the violation incident for corroboration. The proof receipt token embedded in the decrypted payload may contain metadata that provides additional context about the reported violation incident. This metadata may include geospatial attributes, such as the location coordinates or geohash of the incident, and temporal attributes, such as the timestamp or time range of the violation. By extracting and analyzing this metadata, the validator node's verification software can corroborate the details of the reported incident, cross-referencing it with other available information sources, such as geofence databases or historical records. This corroboration process may help establish the validity and reliability of the attestation data.

Step 316i: The receipt veracity may be further asserted by verifying the integrity of the zero-knowledge proof signed using the application's ephemeral private key, which is cryptographically linked to its decentralized identifier (DID). In addition to the metadata corroboration, the validator node's verification software may further assert the veracity of the proof receipt token by verifying the integrity of the zero-knowledge proof included in the token. As mentioned in step 310g, the application may generate a zero-knowledge proof using its ephemeral private key, which may then be signed and included in the receipt token. The validator node's software may verify the signature on the zero-knowledge proof using the application's ephemeral public key, which is cryptographically linked to its DID. This verification process may ensure that the receipt token was indeed generated by the application and has not been tampered with, providing an additional layer of security and trust in the attestation process.

At step 318, validating the violation incident by comparing the decrypted payload's location fingerprints with the known geofence signatures may be performed. This process consists of one or more sub-steps from the steps below:

Step 318a: The decrypted payload's embedded location fingerprints, comprising wireless access point data (e.g., WiFi Basic Service Set Identifier (BSSID) hashes, and Received Signal Strength Indicator (RSSI) data) and geocoordinates, may be extracted by the validator node's verification software. The location fingerprints may include the wireless access point (e.g., Wi-Fi) data, such as BSSIDs and RSSIs, which uniquely identify the wireless access points in the vicinity of the reported incident, and the corresponding geocoordinates, such as latitude and longitude values. These location fingerprints may provide a detailed and specific representation of the incident's spatial context.

Step 318b: The verification software may invoke the local database handler (e.g., on-device SQLite database handler), querying the prohibited geospatial location metadata that may be synced earlier from the decentralized geospatial registry (e.g., a GeoWeb decentralized application (DApp)). To validate the extracted location fingerprints, the validator node's verification software needs access to the prohibited geospatial location metadata. This metadata, which may include the geofence signatures and other relevant information, that may be previously synced from the decentralized geospatial registry and stored in a local database (e.g., in an on-device SQLite database). The software may invoke the local database handler to query and retrieve the prohibited geospatial location metadata for comparison.

Step 318c: A computational similarity analysis may be performed between the decrypted and retrieved geospatial data using a chosen similarity metric (e.g., cosine similarity). The validator node's verification software may perform a similarity analysis between the decrypted location fingerprints and the retrieved geospatial data from the prohibited geospatial location metadata. This analysis may be done using a chosen similarity metric, such as cosine similarity, which may measure the cosine of the angle between two vectors in a high-dimensional space. By calculating the similarity between the decrypted and retrieved geospatial data, the software can determine the degree of correspondence between the reported incident's location and the known prohibited geospatial location geofences.

Step 318d: The similarity analysis may yield a similarity score that quantifies the correspondence between the compared geospatial data. If the similarity score falls below a predefined threshold, it may indicate a mismatch between the reported incident's location and the known prohibited geospatial location geofences. This mismatch may suggest that the incident occurred in a different environment than the expected prohibited geospatial locations.

Step 318e: The mismatch that may be detected in the previous step may serve as confirmation that the reported incident may not be a repeated or recycled historical violation but rather a new and distinct occurrence. This distinction may be crucial for establishing the freshness and validity of the violation evidence, ensuring that only genuine and recent incidents are considered for further action.

Step 318f: To create a tamper-evident and concise representation of the validation results, the validator node's verification software may take the validation result data, which may include the similarity score, the mismatch finding, and the incident timestamp, and hashes them using a cryptographic hash function (e.g., Blake3). The cryptographic hash function may ensure that the hashed validation results are computationally infeasible to reverse, providing a secure and integrity-preserving summary of the validation outcome.

Step 318g: To establish the authenticity and non-repudiation of the validation results, the validator node's verification software may retrieve its private key from a secure hardware-based key storage system. This secure key storage system may provide a protected environment for storing and using cryptographic keys, ensuring their confidentiality and integrity. Using digital signature algorithms (e.g., Elliptic Curve Digital Signature Algorithm (ECDSA)), the software may create a definitive digital signature on the hashed validation results. This signature may serve as a tamper-proof and verifiable attestation of validator node's validation findings.

Step 318h: The validator node's verification software may construct a signed attestation payload that may combine the similarity score, the mismatch finding, the temporal attributes (such as the incident timestamp), and the geocoordinates derived from the geospatial data. This signed attestation payload may serve as a comprehensive and irrefutable evidence package, establishing the occurrence of the prohibited geospatial location visit or presence with high confidence. By including multiple corroborating factors, such as the similarity score, mismatch finding, temporal data, and geocoordinates, the signed attestation payload may provide a strong and verifiable basis for enforcing the area or geographical location restriction policies.

Step 318i: In addition to the validator node's signature, the attestation payload may further be enhanced with counter-signatures from other participating verifiers 108 (validators) who independently verified the incident. These counter-signatures may attest to the independent verification contributions, adding an extra layer of credibility and consensus to the validation process. By bundling the counter-signatures with the attestation payload, the system may establish a robust and decentralized verification mechanism, reducing the reliance on a single verifier 108 (validator) and mitigating the risk of collusion or bias.

In some embodiments, the validator node's verification software may analyze the consistency of the encrypted beacon messages received from multiple devices to determine the relative positioning and trajectory of the users 102. This analysis may involve comparing the timestamps and signal strengths of the beacon messages to establish a spatio-temporal relationship between the users 102. The consistency analysis may be performed using advanced algorithms (e.g., trilateration, Kalman filtering) and may be executed within the secure enclave or trusted execution environment of the validator node's hardware. The results of the consistency analysis may be included in the signed attestation payload, providing a tamper-proof record of the relative positioning and trajectory of the users 102.

At step 320, the signed attestation may be recorded on a decentralized state channel, and the application user's reputation score may be updated across the community. This process may involve one or more sub-steps from the steps below:

Step 320a: The validator's node verification software may encode the signed attestation payload on a decentralized storage network (e.g., IPFS) using the content creation methods (e.g., create( ) method) provided by the decentralized storage network's API (e.g., js-ipfs API). To ensure the persistence and availability of the signed attestation payload, the validator's node verification software may utilize a decentralized storage network. Using the content creation methods from the decentralized storage network's API, the software may encode the signed payload and may store it on the network.

Step 320b: This process may persist tamper-evident attestation bundles with embedded verification signatures immutably in the decentralized storage network. By storing the signed attestation payload on the decentralized storage network, the system may create a tamper-evident and immutable record of the attestation bundles, which include the embedded verification signatures from the validator node and other validators. The content-addressing and cryptographic properties of the decentralized storage network ensure that the stored data cannot be altered or deleted without detection, providing a high level of data integrity and permanence.

Step 320c: The decentralized storage network may return a unique content identifier (CID) hash that may serve as a tamper-proof and deduplicated pointer to the stored attestation evidence. Upon successfully storing the signed attestation payload on the decentralized storage network, the network may return a unique CID hash. This CID hash may act as a tamper-proof and deduplicated pointer to the stored attestation evidence. By using the CID hash, any participant in the system can efficiently retrieve and verify the stored attestation payload from the decentralized storage network (e.g., IPFS network), without the need for centralized servers or intermediaries.

Step 320d: The validator node (verifier devices 116) may initiate a transaction to a reputation score management smart contract deployed on a distributed ledger network (e.g., Polkadot). The reputation score management smart contract is a decentralized application that manages the reputation scores of users 102 based on their verified actions and behavior. To update the application user's reputation score based on the validated violation evidence, the validator node may interact with the reputation score management smart contract using the distributed ledger network's API (e.g., Polkadot.js). The reputation score management smart contract may be implemented as a modular and upgradable runtime component, ensuring flexibility and adaptability to evolving reputation scoring mechanisms.

Step 320e: As part of the transaction to the reputation score management smart contract, the validator node (verifier device 116) may provide the attestation CID hash as a parameter to the reputation score reduction function. This function may be a core component of the reputation score management smart contract, responsible for adjusting the user's reputation score based on the validated violation evidence. By supplying the CID hash, the validator node may establish a verifiable link between the stored attestation payload and the reputation score update, ensuring transparency and accountability.

Step 320f: To maintain the application user's anonymity while enabling reputation score updates, the reputation score management smart contract may use a privacy-preserving identifier associated with the user's decentralized identifier (DID). The validator node (verifier devices 116) may retrieve this privacy-preserving identifier by invoking a dedicated function provided by the reputation score management smart contract. This function may take the user's DID as input and returns the corresponding privacy-preserving identifier, which may serve as a pseudonymous representation of the user's identity within the reputation score system. The use of privacy-preserving identifiers may ensure that the user's sensitive personal information is not exposed, while still allowing for reputation tracking and management.

Step 320g: With the attestation CID hash and the application user's privacy-preserving identifier, the validator node (verifier device 116) may execute the reputation score reduction function using the distributed ledger network's transaction processing capabilities. This function may apply the predefined penalty points to the user's reputation score based on the severity and impact of the validated violation. The transaction processing system may ensure the integrity and security of the reputation score update process by leveraging cryptographic techniques, such as digital signatures and consensus mechanisms, to validate and confirm the state changes proposed by the reputation score reduction function.

Step 320h: After the validator node (verifier device 116) executes the reputation score reduction function, the proposed reputation score update may be broadcasted to the network of validators for ratification. The validators may independently verify the authenticity and validity of the state change proposal, ensuring that it aligns with the agreed-upon rules and policies of the reputation score management system. Through a decentralized consensus mechanism (e.g., majority voting or threshold signature schemes), the validators may collectively ratify the state change proposal. Once ratified, the application user's reputation score may be permanently updated in the community-wide reputation registry maintained by the reputation score management smart contract. The use of a decentralized consensus mechanism may ensure the integrity and immutability of the reputation registry, preventing unauthorized modifications and ensuring a tamper-proof record of user reputation scores.

At step 322, updating the community-wide reputation ledger and propagating the reputation score changes to other systems and stakeholders may be performed. This step may ensure that the application user's reputation is consistently reflected across the ecosystem, enabling informed decision-making and trust-based interactions.

At step 324, the signed attestation payload may be further propagated to additional decentralized storage networks (e.g., Arweave, Sia, Storj) to enhance the long-term availability and tamper-resistance of the attestation evidence. This redundant storage approach may utilize the unique properties and incentive mechanisms of each storage network, ensuring the preservation and accessibility of the attestation data even in the face of network disruptions or attacks. The use of multiple decentralized storage networks may provide an infrastructure for storing critical evidence, reducing the reliance on any single point of failure.

At step 326, indexing the attestation data into the underlying data structure of a next-generation distributed ledger network (e.g., Ethereum 2.0 beacon chain) using advanced data partitioning and scalability techniques (e.g., sharding) may be performed. This sharding mechanism may distribute the attestation data across multiple partitions or shards of the distributed ledger network, enabling parallel processing and enhancing the overall throughput and scalability of the system. By leveraging the security, consensus, and data availability guarantees of the distributed ledger network, the system may ensure the permanent storage and tamper-resistance of the attestation evidence. The integration of sharding techniques may address the scalability challenges associated with storing large volumes of attestation data on the distributed ledger, ensuring efficient and cost-effective operation.

At step 328, the reduction in the application user's reputation score may be mapped to standardized and interoperable reputation data structures (e.g., verifiable credentials) using industry-recognized specifications (e.g., W3C standards). This mapping may enable the seamless integration and portability of the reputation score changes across different ecosystems and platforms. By expressing the reputation updates as verifiable credentials, the system may allow for the reliable exchange and verification of reputation data between disparate systems, fostering a broader network of reputation and accountability. The use of standardized data structures and protocols may ensure the compatibility and interoperability of the reputation system with existing and future decentralized applications and services.

At step 330, decentralized governance mechanisms, such as community-driven arbitration bodies, to handle disputes and appeals related to reputation score updates may be established. These arbitration bodies may be elected through transparent and secure token-based voting processes, leveraging the distributed ledger network's native asset (e.g., community tokens). The elected arbitrators may have the authority to review contested reputation score updates and make binding decisions based on the evidence submitted by the parties involved. The arbitration process may be facilitated by secure communication channels and encrypted data sharing protocols, ensuring the confidentiality and integrity of the evidence throughout the dispute resolution lifecycle. The integration of decentralized governance and arbitration mechanisms may provide a fair, transparent, and community-driven approach to resolving conflicts and maintaining the integrity of the reputation system.

FIG. 5 shows a flowchart 500 illustrating a method for secure data encryption and decryption using a time-based adaptive key generation technique in accordance with one or more embodiments.

In the Time-Based Adaptive Key Generation method, the current time may be captured at various points throughout the encryption process and is used in combination with the seed time to generate dynamic keys. This step is crucial for ensuring the security and uniqueness of the encryption keys for each chunk of the file being encrypted. The encryption process may begin by dividing the file into multiple chunks of a specific size. The size of each chunk may be determined based on various factors, such as the total file size, available memory, or desired encryption granularity. For example, a file of 100 MB is being encrypted, and the chosen chunk size is 1 MB. In this case, the file would be divided into 100 chunks, each of size 1 MB. Once the file is divided into chunks, the encryption process may proceed to encrypt each chunk separately. For each chunk, the current time may be captured using a reliable time source, such as the system clock or a network time protocol (NTP) server. The captured current time may then be used in combination with the seed time, which is a predefined initial time value shared among the authorized parties involved in the encryption and decryption processes. The dynamic key generation process may take the captured current time, seed time, and other relevant factors, such as the chunk index and file size, as inputs. These inputs may be passed through a mathematical function, such as a cryptographic hash function (e.g., SHA-256), to generate a unique and time-dependent encryption key specific to that chunk. For instance, the encryption of the first chunk of the file. The current time is captured, as “2023 Jun. 1 12:00:00”, and the seed time is predefined as “2023 Jun. 1 00:00:00”. The chunk index would be 0, and the file size would be 100 MB. These inputs may be combined and passed through the mathematical function, resulting in a dynamic encryption key specific to the first chunk. The generated dynamic key may then be used to encrypt the first chunk of the file using a symmetric encryption algorithm, such as AES (Advanced Encryption Standard). The encrypted chunk may be stored along with its corresponding dynamic key, which will be required for decryption. The process may be repeated for each subsequent chunk of the file, capturing the current time at each iteration and generating a unique dynamic key for each chunk. This means that even if an attacker manages to obtain the encryption key for one chunk, it will not be valid for the other chunks since the keys are dynamically generated based on the current time and seed time.

By capturing the current time at various points and using it in combination with the seed time, the method may generate unique and time-dependent keys for each chunk of the file. This adds an extra layer of security to the encrypted data, making it more resistant to cryptographic attacks. If an attacker tries to decrypt the data using a key obtained at a different time, the decryption will fail because the key is no longer valid. The dynamic key generation process based on the current time and seed time is a critical step. It ensures that the encryption keys are unique, time-dependent, and more resistant to unauthorized access attempts

At step 502, the method may begin by generating a dynamic encryption key, which may be a unique and time-dependent cryptographic key used to encrypt and decrypt data. The dynamic encryption key may be generated based on a combination of time-related parameters, a phi value, and other relevant factors, ensuring that the key is specific to the current encryption session, time, and data being encrypted. The time-related parameters may include a current time, which may represent the present moment at which the encryption process is initiated, and a seed time, which may be a predefined initial time value that may be shared among the authorized parties involved in the encryption and decryption processes. The current time may be captured at various points throughout the encryption process and may be used in combination with the seed time to generate dynamic keys. The seed time may serve as a reference point for calculating time differences and generating consistent dynamic keys across multiple sessions.

The phi value may be another crucial factor in the dynamic key generation process. It may be calculated based on the time difference between the current time and the seed time using a mathematical function, such as trigonometric functions (e.g., sine and cosine). The inclusion of phi in the dynamic key generation process may introduce additional variability and uniqueness to the encryption keys, ensuring that the generated keys are not only time-dependent but also vary based on the specific time difference. The phi value may be calculated using a formula such as phi=sin (current_time-seed_time)+cos (current_time-seed_time), resulting in a unique number that varies based on the time difference.

Other relevant factors that may be considered in the dynamic key generation process may include the file size and the chunk index. The file size represents the total size of the data being encrypted, while the chunk index keeps track of the current chunk of data being processed. These factors may introduce additional variability and uniqueness to the generated dynamic key, ensuring that each chunk of the file is encrypted with a distinct key. The dynamic key generation process may involve applying a mathematical function, such as a cryptographic hash function (e.g., SHA-256), to the combination of the time-related parameters, phi value, file size, and chunk index. The hash function may take these input parameters and generate a fixed-size output that represents the dynamic encryption key. Furthermore, the dynamic key generation process may involve a post-quantum key exchange mechanism to enhance the security of the encryption keys against potential quantum computing threats. The method may utilize a post-quantum cryptographic algorithm, to generate a shared secret between the sender and the recipient. This shared secret may be combined with the dynamic key generated based on the time-related parameters, phi value, and other factors, using a secure key derivation function (e.g., HKDF). The resulting post-quantum enhanced dynamic key may provide an additional layer of security, ensuring the confidentiality of the encrypted data even in the presence of quantum computers.

The hardware components that may be involved in the dynamic key generation process may include a processor 406 or a cryptographic coprocessor, which may execute the mathematical functions and perform the necessary computations to generate the dynamic key. The processor 406 may interact with a storage component 402 and/or memory 404 to store and retrieve the time-related parameters, phi value, file size, chunk index, and other relevant factors during the key generation process. Additionally, the hardware components may include a time-keeping module, such as a real-time clock (RTC) or a network time protocol (NTP) client, which may provide accurate and synchronized time information to the processor for calculating the phi value and generating the dynamic key.

The interaction between the hardware components and the software elements of the method may be crucial for generating reliable and secure dynamic encryption keys. The software elements, such as the phi calculation function, dynamic key generation function, and post-quantum key exchange algorithm, may be executed by the processor 406 and may utilize the time-related parameters, phi value, file size, chunk index, and shared secret stored in the storage component 402 and/or memory 404. The processor 406 may perform the necessary computations and transformations to generate the final dynamic encryption key, which may be used to encrypt each chunk of the file.

At step 504, once the dynamic encryption key is generated, the method may proceed to encrypt the data using the generated key. The encryption process may utilize symmetric encryption algorithms (e.g., AES) to perform the actual encryption of the data. The data may be divided into fixed-size chunks, and each chunk may be encrypted independently using a separate dynamic key. The encryption function (e.g., encrypt_data( )) may take the data chunk and the dynamic key as inputs and applies the chosen encryption algorithm to produce the encrypted data. The function may also generate an initialization vector (IV) for each chunk to ensure the uniqueness and randomness of the encryption process. The IVs may be stored along with the encrypted data for later use during decryption. The hardware components that may be involved in this step include the processor 406 for executing the encryption function and the storage component 402 and/or memory 404 for storing the plain text data, encrypted data, and IVs. The processor 406 may interact with the storage component 402 and/or memory 404 to read the plain text data chunks and the dynamic key, perform the encryption computations, and write the encrypted data and IVs back to storage component 402 and/or memory 404.

At step 506, after encrypting the data, the method may store the encrypted data along with the associated metadata required for decryption. The metadata may include information such as the seed time, data size, number of chunks, list of IVs, and any other relevant parameters used during the encryption process. The metadata may be encrypted using a separate encryption key derived from a combination of a user-provided password and a randomly generated salt. The password-based key derivation function (e.g., PBKDF2) may be used to generate a secure encryption key from the password and salt. The metadata encryption process may ensure the confidentiality and integrity of the metadata, preventing unauthorized access or tampering. The encrypted data and metadata may then be stored in a storage medium (e.g., file system, database) for later retrieval. The storage operation may involve writing the encrypted data and metadata to disk or transmitting them over a network to a remote storage location. The hardware components that may be involved in this step include the processor 406 for executing the metadata encryption and storage operations, the storage component 402 and/or memory 404 for temporarily holding the metadata during encryption, and the storage component 402 for persistently storing the encrypted data and metadata. The processor 406 may interact with the storage component 402 and/or memory 404 to read the encrypted data and metadata, perform the necessary I/O operations, and ensure their secure storage.

At step 508, to further enhance the security of the encrypted data, the method may introduce a time-based key rotation mechanism. The key rotation process may involve periodically generating new encryption keys based on the passage of time and updating the encrypted data to use the new keys. This step may add an extra layer of protection by limiting the window of vulnerability in case a key is compromised. The key rotation function (e.g., rotate_key( )) may be executed at predefined time intervals (e.g., every 10 minutes) to generate a new dynamic encryption key. The function may take the seed time, session identifier, and a shared secret as inputs and generate a new key using the dynamic key generation process described in Step 502. The shared secret may be securely stored and known only to the authorized parties involved in the encryption and decryption process. The hardware components that may be involved in this step may include a timer or clock module for triggering the key rotation function at the specified intervals, the processor 406 for executing the key rotation function and updating the encrypted data, and the storage component 402 and/or memory 404 for storing the shared secret and the newly generated keys. The processor 406 may interact with the timer module to receive the key rotation triggers and with the storage component 402 and/or memory 404 to read the necessary inputs and store the updated keys.

At step 510, when authorized access to the encrypted data is required, the method may perform the decryption process using time-synchronized keys. The decryption process may retrieve the encrypted data and metadata from the storage medium and reconstruct the dynamic encryption key used during the encryption process. The decryption function (e.g., decrypt_data( )) may take the encrypted data, metadata, and the reconstructed dynamic key as inputs. It may reverse the encryption process by applying the symmetric decryption algorithm (e.g., AES) to the encrypted data chunks using the corresponding IVs and the dynamic key. The decrypted data chunks may then be combined to reconstruct the original plain text data. To ensure the accuracy of the decryption process, the method may incorporate time synchronization mechanisms. The decryption function retrieves the current time from a reliable time source (e.g., NTP server) and compare it with the seed time stored in the metadata. If the time difference exceeds a predefined threshold, the decryption process may be aborted to prevent unauthorized access attempts. The hardware components that may be involved in this step may include the processor 406 for executing the decryption function, the storage component 402 and/or memory 404 for storing the encrypted data, metadata, and decrypted data during the process, and a network interface (e.g., Ethernet, Wi-Fi) for communicating with the time server. The processor 406 may interact with the storage component 402 and/or memory 404 to read the encrypted data and metadata, perform the decryption computations, and write the decrypted data back to storage component 402 and/or memory 404. The network interface may enable the retrieval of accurate time information from the time server.

At step 512, as quantum computing advances pose potential threats to traditional encryption methods, the method may incorporate post-quantum security measures to ensure the long-term confidentiality of the encrypted data. The post-quantum security module (e.g., post_quantum_module( )) may be integrated into the key generation and exchange processes to provide resistance against quantum computing attacks. The post-quantum security module may utilize quantum-resistant cryptographic algorithms (e.g., lattice-based cryptography) to generate and exchange keys securely. These algorithms may be designed to withstand the potential computing power of quantum computers and provide a higher level of security compared to classical cryptographic methods. The hardware components that may be involved in this step may include specialized post-quantum cryptographic accelerators or coprocessors that assist in the computationally intensive operations required by the quantum-resistant algorithms. These hardware components may work in conjunction with the processor 406 and storage component 402 and/or memory 404 to execute the post-quantum security functions efficiently.

At, step 514, the method may include a time-based access control feature that allows the encryption and decryption processes to be restricted based on predefined time constraints. This feature may enable the secure sharing of encrypted data with specific release dates or expiration times. The time-based access control module (e.g., time_access_control( )) may be integrated into the encryption and decryption functions. During encryption, the module may allow the specification of an unlock date or expiration time for the encrypted data. This information may be securely stored within the metadata associated with the encrypted data. During decryption, the time-based access control module may compare the current time with the unlock date or expiration time stored in the metadata. If the current time is before the unlock date or after the expiration time, the decryption process may be prevented, ensuring that access to the encrypted data is restricted based on the predefined time constraints. The hardware components that may be involved in this step may include the processor 406 for executing the time-based access control functions, the storage component 402 and/or memory 404 for storing the unlock date or expiration time, and a real-time clock (RTC) module for providing accurate time information. The processor 406 may interact with the storage component 402 and/or memory 404 to read the stored time constraints and with the RTC module to obtain the current time for comparison.

At step 516, to protect data during transmission, the method may incorporate secure communication protocols (e.g., TLS, SSL) that utilize the Time-Based Adaptive Key Generation technique. The secure transmission module (e.g., secure_transmission( )) may integrate the dynamic key generation process into the establishment of secure communication channels. During the initiation of a secure communication session, the secure transmission module may generate a unique session key using the dynamic key generation process described in Step 502. This session key may be used to encrypt and authenticate the data transmitted between the communicating parties. The session key may be periodically rotated using the time-based key rotation mechanism (Step 508) to maintain the security of the communication channel. The hardware components that may be involved in this step may include network interface cards (NICs) for establishing the communication channels, the processor 406 for executing the secure transmission functions and encrypting/decrypting the transmitted data, and the storage component 402 and/or memory 404 for storing the session keys and encrypted data during transmission. The processor 406 may interact with the NICs to send and receive data securely and with the storage component 402 and/or memory 404 to access the necessary keys and data.

At step 518, the method may extend its applicability to secure data storage in cloud environments. The secure cloud storage module (e.g., secure_cloud_storage( )) may integrate the Time-Based Adaptive Key Generation technique with the encryption and decryption processes performed by cloud storage providers. When data may be uploaded to the cloud, the secure cloud storage module may encrypt the data using the dynamic key generation process (Step 502) before transmitting it to the cloud storage provider. The encryption key may be securely stored locally and is not shared with the cloud provider. The encrypted data may then be transmitted to the cloud storage provider using secure communication protocols (Step 516). When retrieving data from the cloud, the secure cloud storage module may request the encrypted data from the cloud storage provider. Upon receiving the encrypted data, the module may decrypt it using the locally stored encryption key and the time-synchronized decryption process (Step 510). This ensures that the data remains secure and accessible only to authorized parties, even when stored in a cloud environment. The hardware components that may be involved in this step may include the processor 406 for executing the secure cloud storage functions, the storage component 402 and/or memory 404 for storing the encryption keys and encrypted data locally, and the network interface for communicating with the cloud storage provider. The processor 406 may interact with the storage component 402 and/or memory 404 to access the keys and data and with the network interface to securely transmit and retrieve data from the cloud.

At step 520, the method may incorporate integration modules (e.g., distributed_system_integration( )) that may enable the use of the Time-Based Adaptive Key Generation technique in distributed systems and blockchain networks. These integration modules may allow the method to be applied to secure data exchange and storage within decentralized environments. In a distributed system, the integration module may ensure that the dynamic key generation and rotation processes are synchronized across all participating nodes. Each node may generate its own dynamic keys based on the shared seed time and session identifier, ensuring consistent encryption and decryption across the system. The post-quantum security measures (Step 512) may be employed to protect the distributed system against potential quantum computing attacks. In a blockchain network, the integration module may incorporate the Time-Based Adaptive Key Generation technique into the consensus mechanism and smart contract execution. The dynamic keys may be used to encrypt and decrypt data stored on the blockchain, ensuring the confidentiality of sensitive information. The time-based access control feature (Step 514) can be utilized to enable time-locked transactions and smart contracts. The hardware components that may be involved in this step may include the processor 406 for executing the integration functions, the storage component 402 and/or memory 404 for storing the encryption keys and data locally, and the network interface for communicating with other nodes in the distributed system or blockchain network. The processor 406 may interact with the storage component 402 and/or memory 404 to access the keys and data and with the network interface to participate in the distributed consensus and data exchange processes.

At step 522, to ensure the complete and irreversible destruction of encrypted data when required, the method may include a secure data erasure module (e.g., secure_data_erasure( )). This module may employ techniques such as data overwriting, cryptographic erasure, and hardware-based erasure to permanently delete the encrypted data and associated keys. When a request for data erasure is received, the secure data erasure module may first overwrite the encrypted data with random or pseudo-random patterns multiple times to make the original data unrecoverable. The module may then perform cryptographic erasure by securely deleting the encryption keys associated with the data, rendering the encrypted data inaccessible and effectively erased. In cases where the encrypted data may be stored on hardware devices (e.g., solid-state drives), the secure data erasure module may interact with the device's firmware to trigger hardware-based erasure mechanisms, such as block erasure or secure erase commands, to ensure the complete and irreversible destruction of the data. The hardware components that may be involved in this step may include the processor 406 for executing the secure data erasure functions, the storage component 402 and/or memory 404 for storing the encrypted data and keys, and the storage component 402 that hold the encrypted data. The processor 406 may interact with the storage component 402 and/or memory 404 to perform the necessary erasure operations and ensure the secure deletion of the data.

The server computer system 124 may comprise a physical machine or multiple physical machines, or virtual machines running on a physical machine or multiple physical machines. In addition, the server computer system 124 may comprise a cluster of computers or multiple distributed computers that are connected by the network 120 or the Internet.

In addition, methods and functions described herein are not limited to any particular sequence, and the acts or blocks relating thereto may be performed in other sequences that are appropriate. For example, described acts or blocks may be performed in an order other than that specifically disclosed, or multiple acts or blocks may be combined in a single act or block.

While the invention has been described in connection with what is presently considered to be the most practical and various embodiments, it is to be understood that the invention is not to be limited to the disclosed embodiments, but on the contrary, is intended to cover various modifications and equivalent arrangements.

1. A method for secure location verification in a distributed network, comprising:
initializing, by a processor of a user device, a biometric authentication system comprising multiple biometric input types;
generating, by the processor, cryptographic keys using a distributed key generation protocol in cooperation with one or more verifier devices;
binding the cryptographic keys to biometric templates using a fuzzy vault scheme;
constructing and broadcasting encrypted location beacons;
generating zero-knowledge proofs of location claims;
participating in a decentralized validation system with the one or more verifier devices; and
maintaining a dual-scoring mechanism comprising a device trust score and a user reputation score.

2. A system for secure location verification, comprising:
one or more user devices, each comprising:
a processor;
a communications interface;
one or more biometric sensors;
a secure storage component; and
a memory storing instructions that, when executed by the processor, cause the system to perform operations comprising:
implementing a multi-modal biometric authentication system;
executing a distributed key generation protocol;
broadcasting encrypted location beacons; and
participating in a decentralized validation system; and
one or more verifier devices configured to validate location claims and maintain consensus in a blockchain network.

3. A user device for secure location verification, comprising:
a processor;
a communications interface;
one or more biometric sensors;
a secure storage component; and
a memory storing instructions that, when executed by the processor, cause the user device to:
capture multiple types of biometric data;
generate and manage cryptographic keys;
broadcast encrypted location beacons; and
participate in a decentralized validation system.

4. The method according to claim 1, wherein initializing the biometric authentication system comprises:
capturing multiple types of biometric data including at least two of: electrocardiogram (ECG) data, photoplethysmography (PPG) data, fingerprint data, facial recognition data, voice recognition data, bioimpedance data, skin temperature data, galvanic skin response (GSR) data, iris scan data, and vein pattern recognition (VPR) data;
generating biometric templates for each type of captured biometric data; and
implementing real-time liveness detection for each biometric input type.

5. The method according to claim 1, wherein generating cryptographic keys comprises:
initiating a t-out-of-n threshold key generation protocol;
establishing secure communication channels with the one or more verifier devices;
participating in a distributed random beacon protocol to generate a shared random value; and
combining threshold key shares to derive a final public key and master secret key.

6. The method according to claim 1, wherein binding the cryptographic keys comprises:
encoding a cryptographic key as coefficients of a polynomial;
generating genuine points from the polynomial using biometric features;
adding chaff points to obscure genuine points; and
applying error-correcting codes for handling biometric variations.

7. The method according to claim 1, wherein constructing and broadcasting encrypted location beacons comprises:
generating a temporary identifier for each session;
creating a location commitment using cryptographic hash functions;
implementing attribute-based encryption of beacon messages; and
broadcasting the encrypted beacons over one or more wireless channels.

8. The method according to claim 1, wherein generating zero-knowledge proofs comprises:
creating proofs of location presence without revealing exact coordinates;
implementing range proofs for geographic boundaries;
generating proofs of successful biometric authentication; and
providing proofs of proper key usage.

9. The method according to claim 1, further comprising:
implementing an adaptive data collection mechanism based on current context;
adjusting data sampling rates dynamically based on user activity and proximity to restricted areas; and
synchronizing energy-saving measures across multiple associated devices.

10. The system according to claim 2, wherein the multi-modal biometric authentication system comprises:
pre-capture verification procedures for each biometric modality;
continuous post-capture verification; and
real-time anomaly detection using supervised and unsupervised learning models.

11. The system according to claim 2, wherein broadcasting encrypted location beacons comprises:
generating attribute-based encryption keys;
defining access policies based on temporal and spatial attributes;
encrypting biometric verification tokens separately from main beacon messages; and
implementing spread spectrum modulation techniques.

12. The system according to claim 2, wherein participating in the decentralized validation system comprises:
executing fault-tolerant consensus algorithms with privacy preservation;
implementing distributed machine learning approaches;
participating in cryptographic trust systems; and
executing network governance operations.

13. The user device according to claim 3, further comprising:
implementing a secure logging system with tamper-evident mechanisms;
executing authenticated data structure operations; and
participating in collaborative log consistency checks.

14. The user device according to claim 3, wherein the memory stores further instructions to:
implement multi-source location determination;
execute location verification protocols;
generate and maintain location proofs; and
participate in challenge-response protocols.

15. The method according to claim 4, further comprising:
implementing cross-modal verification between different biometric modalities;
generating confidence scores for each biometric input;
executing fusion algorithms with adaptive weighting; and
maintaining historical performance metrics for each modality.

16. The method according to claim 5, wherein participating in the distributed random beacon protocol comprises:
contributing entropy from hardware random number generators;
combining entropy using verifiable delay functions;
preventing last-actor bias; and
seeding subsequent key generation steps.

17. The method according to claim 7, further comprising:
implementing a hybrid storage system for location-based restrictions;
executing a secure boot process; and
maintaining decentralized storage operations for prohibited locations.

18. The system according to claim 10, wherein the real-time anomaly detection comprises:
combining supervised learning models trained on known attack patterns;
implementing unsupervised learning for novel attack detection;
executing online learning algorithms for continuous adaptation; and
maintaining historical behavioral patterns.

19. The system according to claim 11, wherein the attribute-based encryption comprises:
temporal attributes including current date and time periods;
spatial attributes including geographic regions and proximity data;
device-specific attributes including device type and operating system; and
user-specific attributes including role and clearance level.

20. The user device according to claim 14, wherein generating and maintaining location proofs comprises:
implementing privacy-preserving proof generation;
executing collaborative proof verification;
maintaining proof data structures; and
participating in blockchain-based verification systems.
